(19) United States
(12) Patent Application Publication
(10) Pub. No.: US 2015/0161702 A1
(43) Pub. Date: Jun. 11, 2015

(54) METHODS AND SYSTEMS FOR IN SILICO EXPERIMENTAL DESIGN AND FOR PROVIDING A BIOTECHNOLOGY PRODUCT TO A CUSTOMER

(71) Applicant: LIFE TECHNOLOGIES CORPORATION, Carlsbad, CA (US)

(72) Inventors: Shao-Min YUAN, Shangai (CN); Michael Beltsov, Frederick, MD (US); Thomas Chappell, San Marcos, CA (US); Kevin Clancy, Carlsbad, CA (US); Peter McGarvey, Takoma Park, MD (US); Sam Zaremba, Rockville, MD (US); James Caffrey, Carlsbad, CA (US); Konstantin Belov, Oak Park, CA (US); Anatoliy Mnev, N. Potomac, MD (US); Siamak Baharloo, Carlsbad, CA (US); Aruna Myneni, San Diego, CA (US); James Gilmore, Carlsbad, CA (US)

(73) Assignee: LIFE TECHNOLOGIES CORPORATION, Carlsbad, CA (US)

(21) Appl. No.: 14/265,990

(22) Filed: Apr. 30, 2014

Related U.S. Application Data
(63) Continuation of application No. 12/791,820, filed on Jun. 1, 2010, now abandoned.
Application No. 12/791,820 is a continuation of application No. 11/182,574, filed on Jul. 14, 2005, now abandoned.
(60) Provisional application No. 60/608,293, filed on Sep. 8, 2004.
(60) Provisional application No. 60/587,941, filed on Jul. 14, 2004.

(51) Int. Cl. G06Q 30/06

(52) U.S. Cl. CPC G06Q 30/0623

(57) ABSTRACT

Provided herein is a method and computer program product for designing and/or simulating a biotechnology experiment in silico; and for providing and generating revenue from a customized list of one or more biotechnology products and/or services related to the in silico designed or simulated biotechnology experiment or the product of that experiment. In illustrative examples, the products and or services are indirectly related to a biomolecule designed by the in silico designed biotechnology experiment. In addition, provided herein is a method and computer system for generating revenue, that includes providing a customer with a first computer program product for designing or performing a biotechnology experiment in silico; and providing the customer with access to a purchase function for purchasing a second computer program product for designing or performing a biotechnology experiment in silico. Typically, functionality of the first computer product is less then and/or different than the functionality of the second computer product.

### CROSS REFERENCE TO RELATED APPLICATIONS

This application is a continuation of U.S. application Ser. No. 12/791,820 filed Jun. 1, 2010, which is a continuation of U.S. application Ser. No. 11/182,574 filed Jul. 14, 2005 (now abandoned), and claims priority to U.S. application No. 60/608,293 filed Sep. 8, 2004, and U.S. application No. 60/587,941 filed Jul. 14, 2004, which disclosures are herein incorporated by reference in their entirety.

### SEQUENCE LISTING

This application contains nucleotide sequence and/or amino acid sequence disclosure in computer readable form and a written sequence listing, the entire contents of both of which are expressly incorporated by reference in their entirety as though fully set forth herein.

### BACKGROUND OF THE INVENTION

1. Field of the Invention

The present invention is directed to bioinformatics, especially systems and methods for providing research products and services for bioinformatic, genomic and proteomic research and for in silico experimental design.

2. Background Information

Biotechnology research that is important for improving agricultural products, discovering new treatments for diseases, and for identifying and developing new diagnostic methods, relies on complex technologies, methods and experimental design. This research would be greatly facilitated by computer assisted experimental design programs as well as by identifying in an automated or semi-automated manner, the products and/or services that are necessary for performing the biotechnology research.

### SUMMARY OF THE INVENTION

The invention relates, in part, to methods for providing information about products or services to customers. In particular embodiments, these methods comprise (a) designing a web page that allows for access to the products or services information, and (b) allowing customers to access the web page. In some instances, the web page can contain at least one title and two or more primary subtitles. In particular instances, the primary subtitles may be selected to display information related to the subject matter of the selected primary subtitles. In additional particular instances, at least one of the primary subtitles may be selected to display one or more secondary subtitles. The invention further relates to compositions that may be used in performing such methods (e.g., web pages stored on a server, etc.), as well as additional methods for performing related functions (e.g., manufacturing of products, performance of services, shipping of products or data derived from services to customers, billing customers for products provided or services performed, etc.).

Products or services information that describes products or services may relate to any number of fields but will often relate to biotechnology. As used herein, the term “biotechnology” refers to the use of biological materials in research, genetic engineering, and for the development and manufacture of biopharmaceuticals. Thus, as an example, genetic engineering of plants to be resistant to herbicides employs biotechnology. However, as another example, the growing of wild-type corn strains for use as feed to farm animals typically does not employ biotechnology.

When methods and compositions of the invention relate to biotechnology products or services, these services may be in any number of fields or subfields (e.g., genomics, proteomics, RNA interference, drug discovery, etc.).

Information may be presented to customers in such a manner that allows for the selection of a subtitle, which results in customers being presented with information for designing and/or purchasing products or services.

As noted above, the products or services may be in the field of RNA interference. In such instances, one or more of the products may be a double-stranded nucleic acid molecule (e.g., double stranded DNA or RNA molecules). Further, the double-stranded nucleic acid molecules may have any number of characteristics. For example, these molecules may be from about 20 to about 30 nucleotides, from about 18 to about 30 nucleotides, from about 22 to about 30 nucleotides, from about 22 to about 38 nucleotides, or from about 23 to about 37 nucleotides in length. Typically, length will be measured in terms of total length. In other words, when a double-stranded nucleic acid molecule is composed of two separate strands and has two nucleotide overhangs on each end and the region of sequence complementarity is 18 nucleotides, then the double stranded molecules will be 20 nucleotides in length.

Services of the invention include those which relate to the screening of double-stranded nucleic acid molecules to identify molecules which knock down gene expression by RNA inference (e.g., identification of transfection conditions which may be used to introduce double standed RNA molecules into cells, etc.) and the production of antibodies having binding specificity for particular antigens.

The present invention is based in part on the discovery that access to an online store containing biological products can be presented to a customer based on an in silico designed experiment. Typically, the products are indirectly related to the in silico designed experiment. For example, the product can be an antibiotic, wherein an in silico-designed vector includes an antibiotic resistance gene. Furthermore, the present invention is based on the discovery of a method by which a provider generates revenue by providing free to customers, a computer program for designing and/or performing an experiment in silico, while providing links that allow the customer to purchase related products from the provider. The method provides much less time and effort for a potential customer, to order products to carry out an experiment.

The present invention is additionally based in part on a model wherein revenue is generated by providing free to customers, a first computer program for designing and/or performing an experiment in silico, while providing for purchase by the customer, a second, more full-featured, or differently featured computer program for designing and/or performing an experiment in silico. Thus; in one embodiment, the invention includes a computer program product for use in conjunction with a computer system. The computer program product may comprise a computer readable storage medium and a computer program mechanism embedded therein, the computer program mechanism comprising computer-readable instructions for designing or simulating a biotechnology experiment in silico; and computer-readable instructions for providing a customized list of one or more biotechnology products and/or services related to the in silico designed biotechnology experiment or the product of that experiment.

In these embodiments, the second computer program product possesses increased functionality compared to the first computer program product, or different functionality that the first computer program product. That is, the second computer program product is capable of performing a greater number of, and/or different functions compared to the first computer program product. In other words, the first computer program has reduced or different functionality compared to the second computer program product.

### BRIEF DESCRIPTION OF THE FIGURES

FIGS. 1A-H illustrate various exemplary molecule features and associated products.

FIG. 2A shows textual and graphical information which may be on a web page and presented to one viewing that web page. The numbered textual information is set up in a format which allows it to be selected by the viewer to provide information related to the text (see FIG. 2B). The boxes next to the numbers indicate that additional textual information may be obtained by selection of the box by the user. Thus, when the boxes are selected, information is provided which is different than the information provided when the text itself is selected. In this figure, “RNAi Application Advisor” is referred to as a “title” and the text to the right of the numbers are referred to as “subtitles”.

FIG. 2B shows, in part, subtitles which are presented when each of the boxes shown in FIG. 2A is selected. The text set out on the left side of the slide is labeled as “Title” and various levels of “Subtitle”. Typically, these labels would not be present to the viewer as part of the web page. On the right side of the slide is a text box which sets out information about “CHEMICAL SYNTHESIS” or RNA oligonucleotides. In particular, information related to advantages and disadvantages of using chemically synthesized oligonucleotides for RNAi is presented. Information related to the subject matter of the title or various subtitles may be viewed by selecting the text of a particular title or subtitle.

FIG. 3 provides a schematic representation of a system for producing and providing a product to a customer/purchaser.

FIG. 4 illustrates a general architecture schematic according to an embodiment of the invention.

FIG. 5 shows a comparison of functionality between a first computer program product for designing or performing a biotechnology experiment in silico, VectorDesigner™, and a second computer program product for designing a biotechnology experiment in silico, Vector NTI Advance™

Additional figures and figure explanations are provided within the illustrative examples provided herein.

### DETAILED DESCRIPTION OF THE INVENTION

In the description that follows, a number of terms used in recombinant nucleic acid technology are utilized extensively. In order to provide a clear and more consistent understanding of the specification and claims, including the scope to be given such terms, the following definitions are provided.

Genomic Products and Services: As used herein, the term genomic products and services refers to products and services that may be used to conduct research involving nucleic acids, including RNA interference (RNAi).

Proteomic Products and Services: As used herein, the term proteomic products and services refers to products and services that may be used to conduct research involving polypeptides.

Clone Collection: As used herein, “clone collection” refers to two or more nucleic acid molecules, each of which comprises one or more nucleic acid sequences of interest.

Customer: As used herein, the term customer refers to any individual, institution, corporation, university, or organization seeking to obtain genomic and proteomic products and services.

Provider: As used herein, the term provider refers to any individual, institution, corporation, university, or organization seeking to provide genomic and proteomic products and services.

Subscriber: As used herein, the term subscriber refers to any customer having an agreement with a provider to obtain public and private genomic and proteomic products and services at subscriber rates.

Non-subscriber: As used herein, the term non-subscriber refers to any customer who does not have an agreement with a provider to obtain public and private genomic and proteomic products and services at subscriber rates.

Host: As used herein, the term “host” refers to any prokaryotic or eukaryotic (e.g., mammalian, insect, yeast, plant, avian, animal, etc.) cell and/or organism that is a recipient of a replicable expression vector, cloning-vector or any nucleic acid molecule. The nucleic acid molecule may contain, but is not limited to, a sequence of interest, a transcriptional regulatory sequence (such as a promoter, enhancer, repressor, and the like) and/or an origin of replication. As used herein, the terms “host,” “host cell,” “recombinant host” and “recombinant host cell” may be used interchangeably. For examples of such hosts, see Sambrook, et al., Molecular Cloning: A Laboratory Manual, Cold Spring Harbor Laboratory, Cold Spring Harbor, N.Y.

Transcriptional Regulatory Sequence: As used herein, the phrase “transcriptional regulatory sequence” refers to a functional stretch of nucleotides contained on a nucleic acid molecule, in any configuration or geometry, that act to regulate the transcription of (1) one or more nucleic acid sequences that may comprise ORFs, (e.g., two, three, four, five, seven, ten, etc.) into messenger RNA or (2) one or more nucleic acid sequences into untranslated RNA. Examples of transcriptional regulatory sequences include, but are not limited to, promoters, enhancers, repressors, operators (e.g., the tet operator), and the like.

Promoter: As used herein, a promoter is an example of a transcriptional regulatory sequence, and is specifically a nucleic acid generally described as the 5′-region of a gene located proximal to the start codon or nucleic acid that encodes untranslated RNA. The transcription of an adjacent nucleic acid segment is initiated at or near the promoter. A repressible promoter's rate of transcription decreases in response to a repressing agent. An inducible promoter's rate of transcription increases in response to an inducing agent. A constitutive promoter's rate of transcription is not specifically regulated, though it can vary under the influence of general metabolic conditions.

Insert: As used herein, the term “insert” refers to a desired nucleic acid segment that is a part of a larger nucleic acid molecule. In many instances, the insert will be introduced into the larger nucleic acid molecule using techniques known to those of skill in the art, e.g., recombinational cloning, topoisomerase cloning or joining, ligation, etc.

Target Nucleic Acid Molecule: As used herein, the phrase “target nucleic acid molecule” refers to a nucleic acid molecule comprising at least one nucleic acid sequence of interest, preferably a nucleic acid molecule that is to be acted upon using the compounds and methods of the present invention. Such target nucleic acid molecules may contain one or more (e.g., two, three, four, five, seven, ten, twelve, fifteen, twenty, thirty, fifty, etc.) sequences of interest.

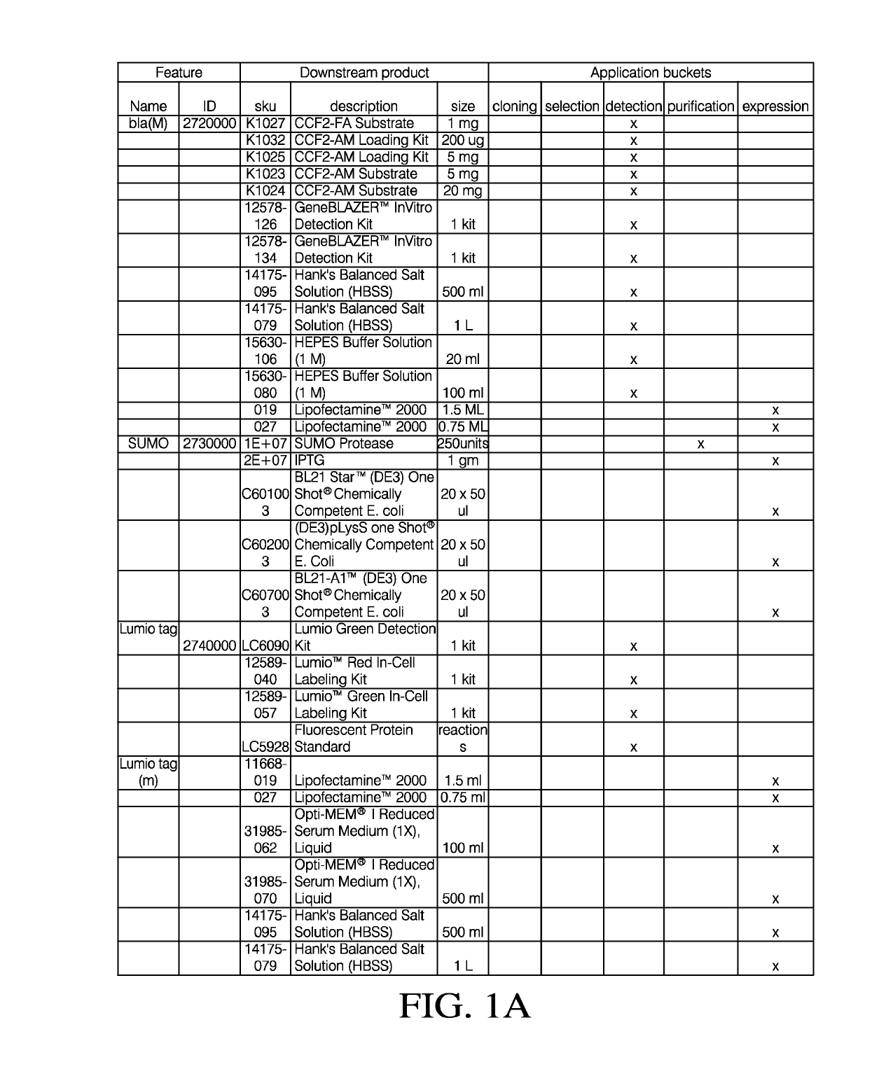

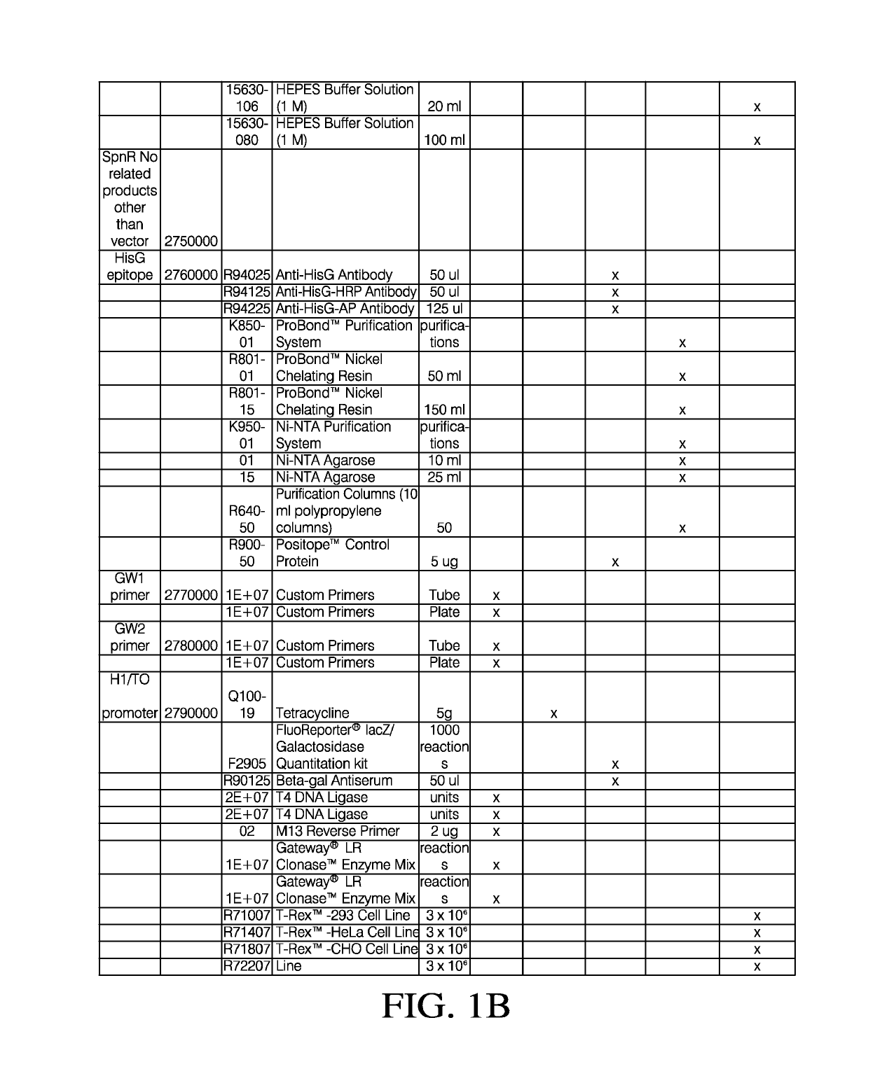

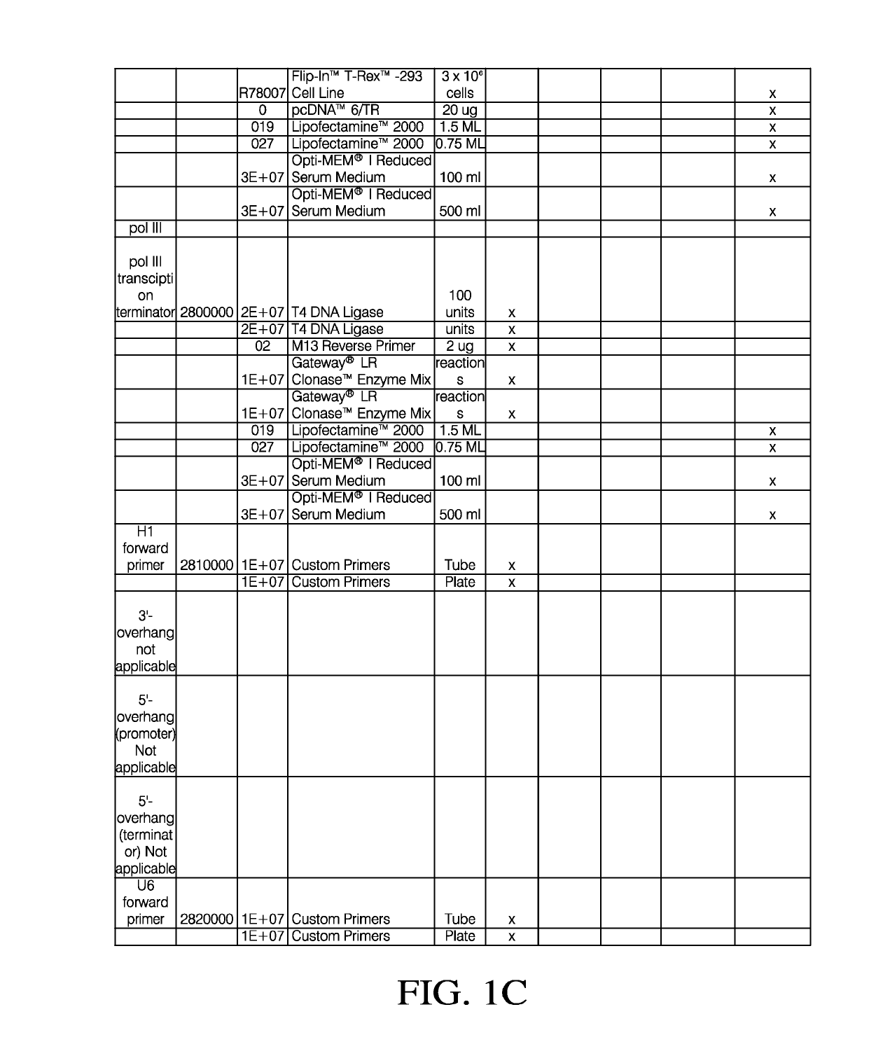

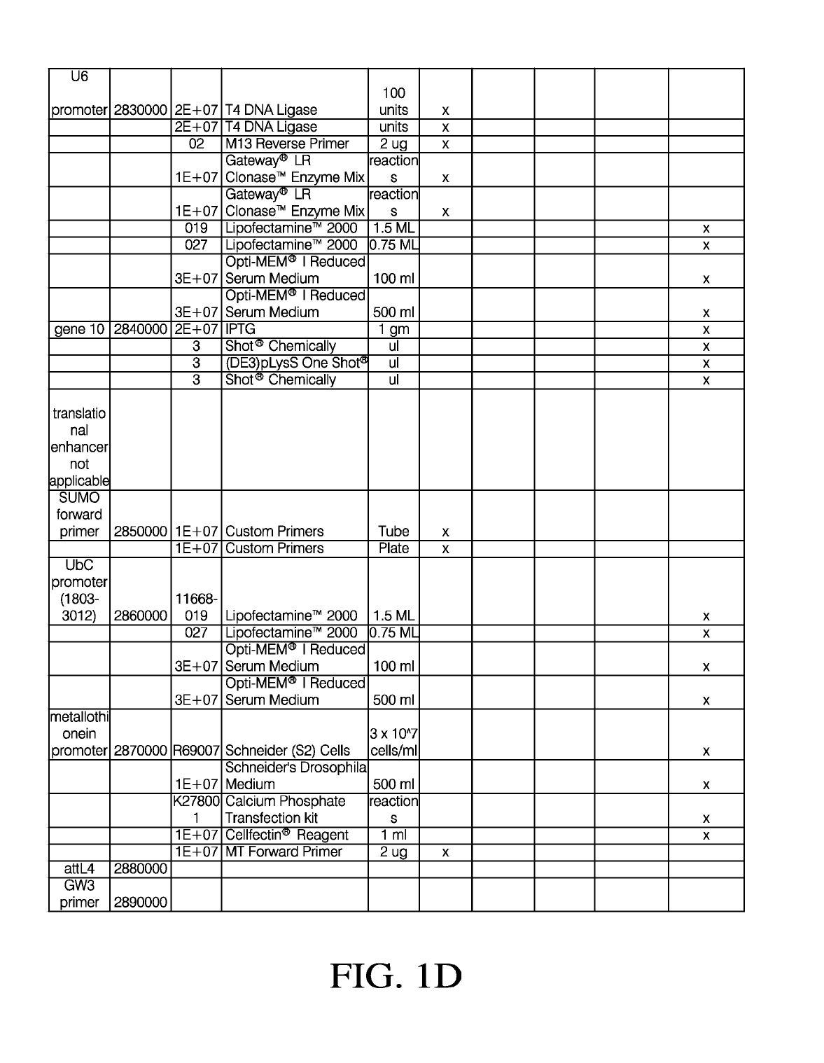

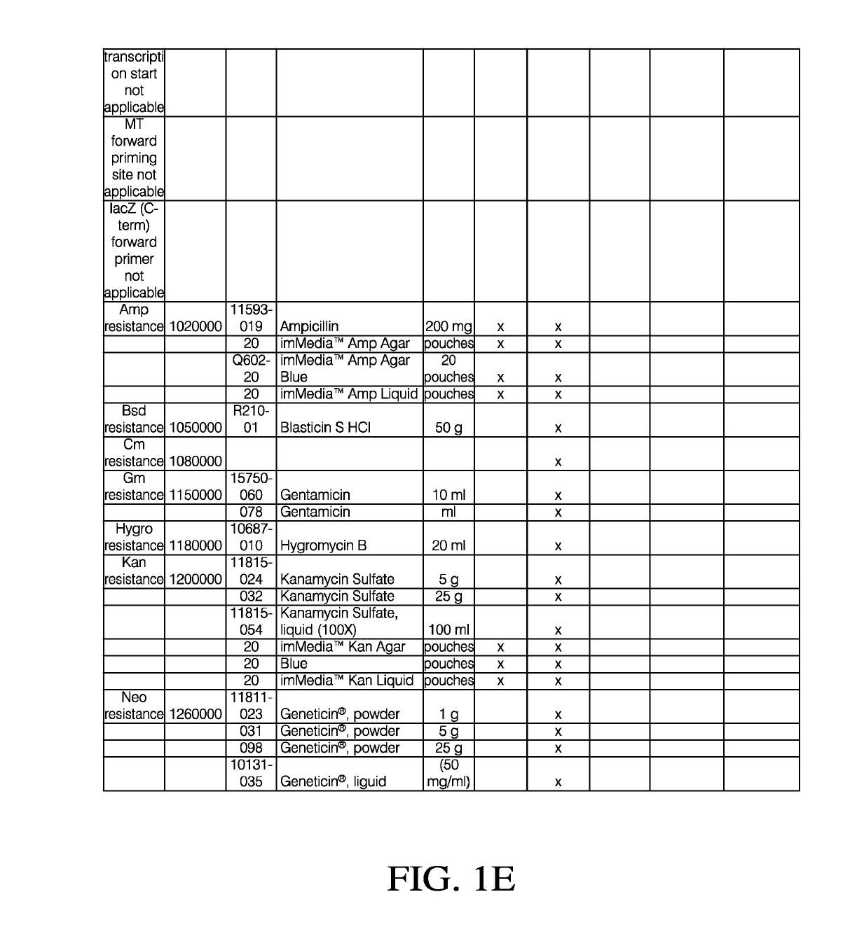

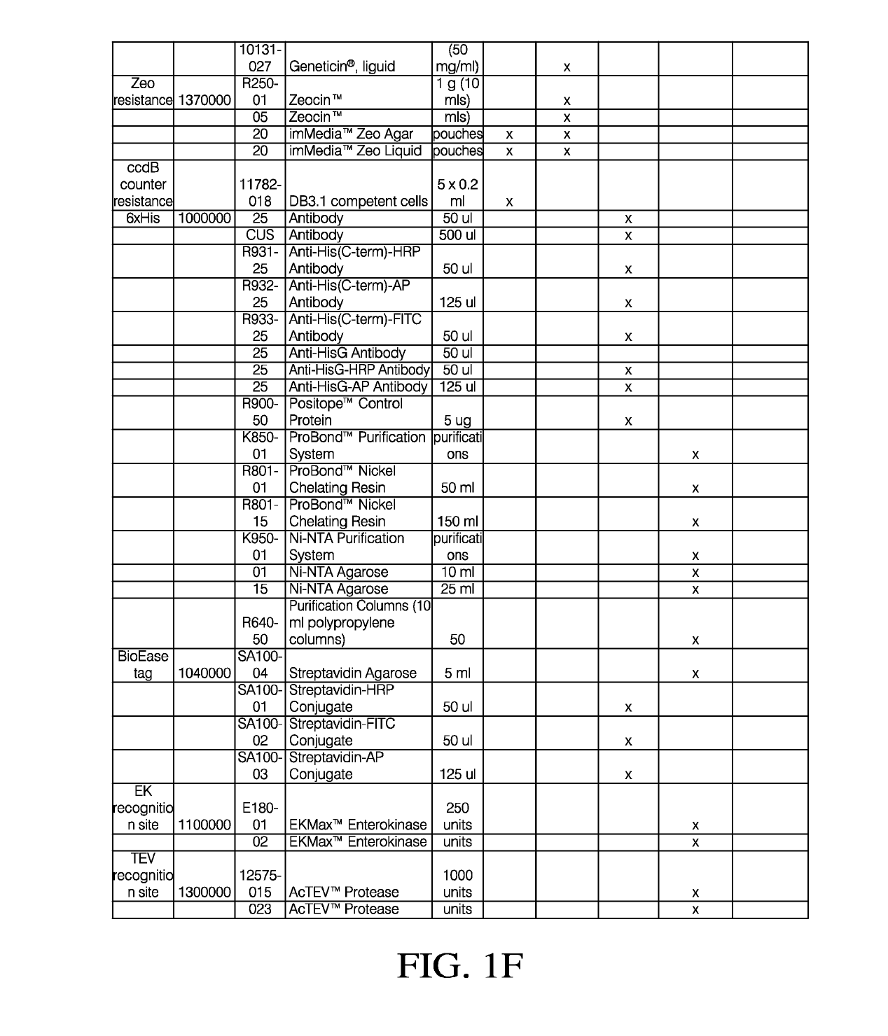

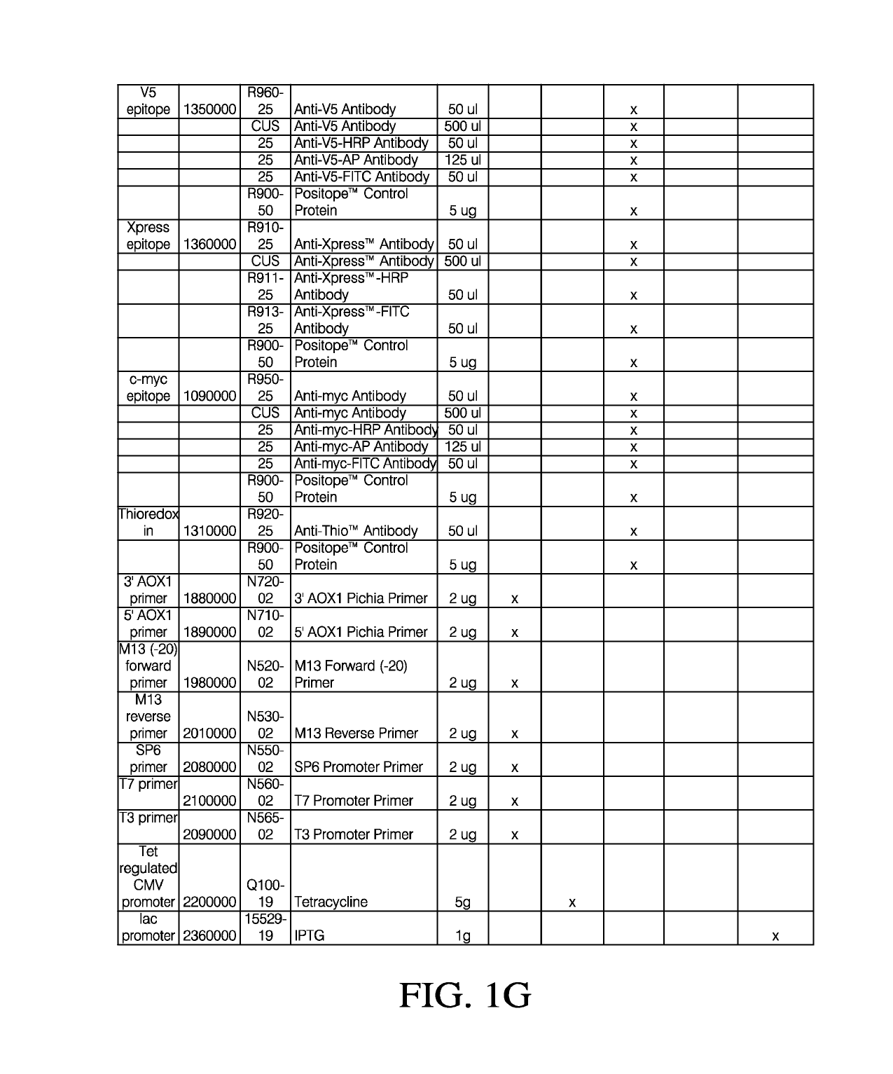

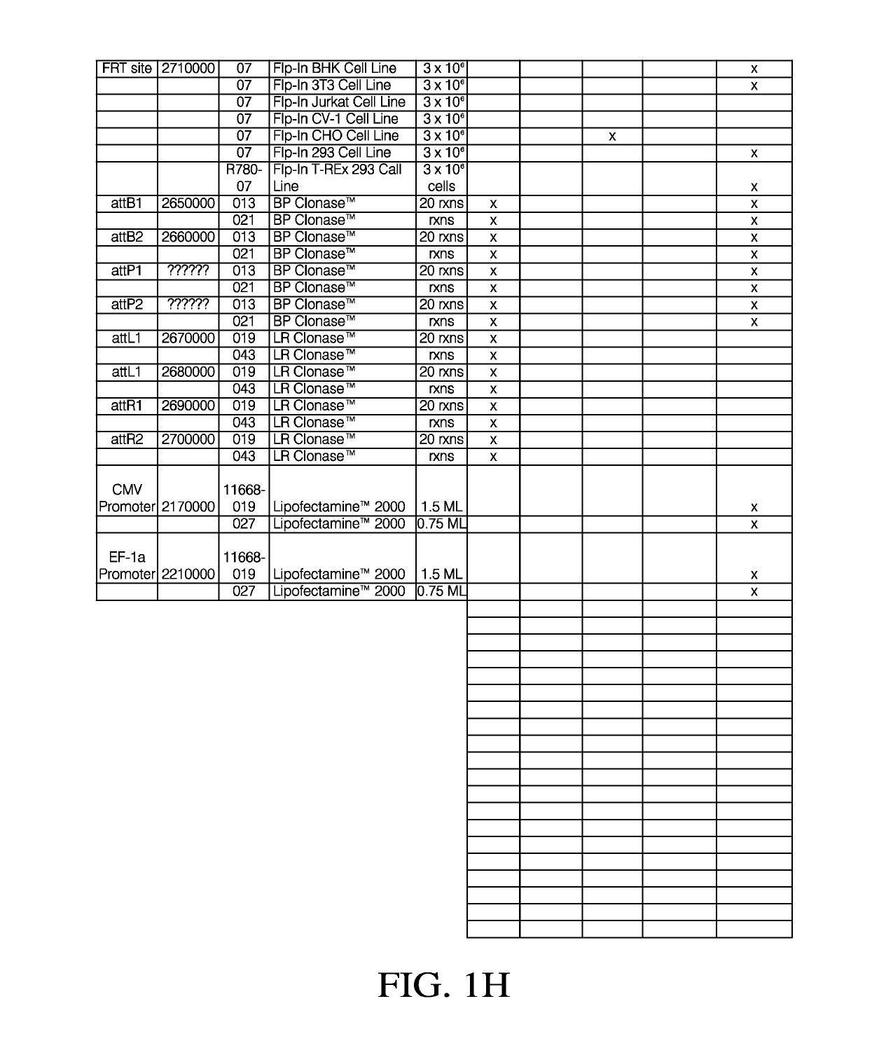

Recognition Sequence: As used herein, the phrase “recognition sequence” or “recognition site” refers to a particular sequence to which a protein, chemical compound, DNA, or RNA molecule (e.g., restriction endonuclease, a topoisomerase, a modification methylase, a recombinase, etc.) recognizes and binds. In the present invention, a recognition sequence may refer to a recombination site. For example, the recognition sequence for Cre recombinase is loxP which is a 34 base pair sequence comprising two 13 base pair inverted repeats (serving as the recombinase binding sites) flanking an 8 base pair core sequence (see FIG. 1 of Sauer, B., Current Opinion in Biotechnology 5:521-527 (1994)). Other examples of recognition sequences are the attB, attP, attL, and attR sequences, which are recognized by the recombinase enzyme X Integrase. attB is an approximately 25 base pair sequence containing two 9 base pair core-type Int binding sites and a 7 base pair overlap region. attP is an approximately 240 base pair sequence containing core-type Int binding sites and arm-type Int binding sites as well as sites for auxiliary proteins integration host factor (IHF), FIS and excisionase (Xis) (see Landy, Current Opinion in Biotechnology 3:699-707 (1993)). Such sites may also be engineered according to the present invention to enhance production of products in the methods of the invention. For example, when such engineered sites lack the P1 or HI domains to make the recombination reactions irreversible (e.g., attR or attP), such sites may be designated attR′ or attP′ to show that the domains of these sites have been modified in some way.

Recombination Proteins: As used herein, the phrase “recombination proteins” includes excisive or integrative proteins, enzymes, co-factors or associated proteins that are involved in recombination reactions involving one or more recombination sites (e.g., two, three, four, five, seven, ten, twelve, fifteen, twenty, thirty, fifty, etc.), which may be wild-type proteins (see Landy, Current Opinion in Biotechnology 3:699-707 (1993)), or mutants, derivatives (e.g., fusion proteins containing the recombination protein sequences or fragments thereof), fragments, and variants thereof. Examples of recombination proteins include Cre, Int, IHF, Xis, Flp, Fis, Hin, Gin, .PHI.C31, Cin, Tn3 resolvase, TndX, XerC, XerD, TnpX, Hjc, Gin, SpCCE1, and ParA.

Recombinases: As used herein, the term “recombinases” is used to refer to the protein that catalyzes strand cleavage and re-ligation in a recombination reaction. Site-specific recombinases are proteins that are present in many organisms (e.g., viruses and bacteria) and have been characterized as having both endonuclease and ligase properties. These recombinases (along with associated proteins in some cases) recognize specific sequences of bases in a nucleic acid molecule and exchange the nucleic acid segments flanking those sequences. The recombinases and associated proteins are collectively referred to as “recombination proteins” (see, e.g., Landy, A., Current Opinion in Biotechnology 3:699-707 (1993)).

Numerous recombination systems from various organisms have been described. See, e.g., Hoess, et al., Nucleic Acids Research 14(6):2287 (1986); Abremski, et al., J. Biol. Chem. 261(1):391 (1986); Campbell, J. Bacteriol. 174(23):7495 (1992); Qian, et al., J. Biol. Chem. 267(11):7794 (1992); Araki, et al., J. Mol. Biol. 225(1):25 (1992); Maeser and Kahnmann, Mol. Gen. Genet. 230:170-176 (1991); Esposito, et al., Nucl. Acids Res. 25(18):3605 (1997). Many of these belong to the integrase family of recombinases (Argos, et al., EMBO J. 5:433-440 (1986); Voziyanov, et al., Nucl. Acids Res. 27:930 (1999)). Perhaps the best studied of these are the Integrase/att system from bacteriophage .lamda. (Landy, A. Current Opinions in Genetics and Devel. 3:699-707 (1993)), the Cre/loxP system from bacteriophage P1 (Hoess and Abremski (1990) In Nucleic Acids and Molecular Biology, vol. 4. Eds.: Eckstein and Lilley, Berlin-Heidelberg: Springer-Verlag; pp. 90-109), and the FLP/FRT system from the Saccharomyces cerevisiae 2 .mu. circle plasmid (Broach, et al., Cell 29:227-234 (1982)).

Recombination Site: A used herein, the phrase “recombination site” refers to a recognition sequence on a nucleic acid molecule that participates in an integration/recombination reaction by recombination proteins. Recombination sites are discrete sections or segments of nucleic acid on the participating nucleic acid molecules that are recognized and bound by a site-specific recombination protein during the initial stages of integration or recombination. For example, the recombination site for Cre recombinase is loxP, which is a 34 base pair sequence comprised of two 13 base pair inverted repeats (serving as the recombinase binding sites) flanking an 8 base pair core sequence (see FIG. 1 of Sauer, B., Curr. Opin. Biotech. 5:521-527 (1994)). Other examples of recombination sites include the attB, attP, attL, and attR sequences described in U.S. provisional patent applications 60/136,744, filed May 28, 1999, and 60/188,000, filed Mar. 9, 2000, and in co-pending U.S. patent application Ser. No. 09/517,466 and Ser. No. 09/732,91—all of which are specifically incorporated herein by reference—and mutants, fragments, variants and derivatives thereof, which are recognized by the recombination protein .lamda. Int and by the auxiliary proteins integration host factor (IHF), FIS and excisionase (Xis) (see Landy, Curr Opin. Biotech. 3:699-707 (1993)).

Mutating specific residues in the core region of the att site can generate a large number of different att sites. As with the att I and att2 sites utilized in GATEWAY™. each additional mutation potentially creates a novel att site with unique specificity that will recombine only with its cognate partner att site bearing the same mutation and will not cross-react with any other mutant or wild-type att site. Novel mutated att sites (e.g., attB 1-10, attP 1-10, attR 1-10 and attL 1-10) are described in previous patent application Ser. No. 09/517,466, filed Mar. 2, 2000, which is specifically incorporated herein by reference. Other recombination sites having unique specificity (i.e., a first site will recombine with its corresponding site and will not recombine or not substantially recombine with a second site having a different specificity) may be used to practice the present invention. Examples of suitable recombination sites include, but are not limited to, loxP sites; loxP site mutants, variants or derivatives such as loxP511 (see U.S. Pat. No. 5,851,808); frt sites; frt site mutants, variants or derivatives; dif sites; dif site mutants, variants or derivatives; psi sites; psi site mutants, variants or derivatives; cer sites; and cer site mutants, variants or derivatives.

Recombination sites may be added to molecules by any number of known methods. For example, recombination sites can be added to nucleic acid molecules by blunt end ligation, PCR performed with fully or partially random primers, or inserting the nucleic acid molecules into a vector using a restriction site flanked by recombination sites.

Recombinational Cloning: As used herein, the phrase “recombinational cloning” refers to a method whereby segments of nucleic acid molecules or populations of such molecules are exchanged, inserted, replaced, substituted or modified, in vitro or in vivo. Preferably, such cloning method is an in vitro method.

Suitable recombinational cloning systems that utilize recombination at defined recombination sites have been previously described in U.S. Pat. Nos. 5,888,732, 6,143,557, 6,171,861, 6,270,969, and 6,277,608, and in pending U.S. application Ser. No. 09/517,466, and in published United States application no. 20020007051, (each of which is fully incorporated herein by reference), all assigned to the Invitrogen Corporation, Carlsbad, Calif. In brief, the GATEWAY™ Cloning System described in these patents utilizes vectors that contain at least one recombination site to clone desired nucleic acid molecules in vivo or in vitro. In some embodiments, the system utilizes vectors that contain at least two different site-specific recombination sites that may be based on the bacteriophage lambda system (e.g., att1 and att2) that are mutated from the wild-type (att0) sites. Each mutated site has a unique specificity for its cognate partner att site (i.e., its binding partner recombination site) of the same type (for example attB1 with attP1, or attL1 with attR1) and will not cross-react with recombination sites of the other mutant type or with the wild-type att0 site. Different site specificities allow directional cloning or linkage of desired molecules thus providing desired orientation of the cloned molecules. Nucleic acid fragments flanked by recombination sites are cloned and subcloned using the GATEWAY™ system by replacing a selectable marker (for example, ccdB) flanked by att sites on the recipient plasmid molecule, sometimes termed the Destination Vector. Desired clones are then selected by transformation of a ccdB sensitive host strain and positive selection for a marker on the recipient molecule. Similar strategies for negative selection (e.g., use of toxic genes) can be used in other organisms such as thymidine kinase (TK) in mammals and insects.

Topoisomerase recognition site. As used herein, the term “topoisomerase recognition site” means a defined nucleotide sequence that is recognized and bound by a site specific topoisomerase. For example, the nucleotide sequence 5′-(C/T)CCTT-3′ is a topoisomerase recognition site that is bound specifically by most poxvirus topoisomerases, including vaccinia virus DNA topoisomerase I, which then can cleave the strand after the 3′-most thymidine of the recognition site to produce a nucleotide sequence comprising 5′-(C/T)CCTT-PO.sub.4-TOPO, i.e., a complex of the topoisomerase covalently bound to the 3′ phosphate through a tyrosine residue in the topoisomerase (see, Shuman, J. Biol. Chem. 266:11372-11379, 1991; Sekiguchi and Shuman, Nucl. Acids Res. 22:5360-5365, 1994; each of which is incorporated herein by reference; see, also, U.S. Pat. No. 5,766,891; PCT/US95/16099; and PCT/US98/12372). In comparison, the nucleotide sequence 5′-GCAACTT-3′ is the topoisomerase recognition site for type IA E. coli topoisomerase III.

Repression Cassette: As used herein, the phrase “repression cassette” refers to a nucleic acid segment that contains a repressor or a selectable marker present in the subcloning vector.

Selectable Marker: As used herein, the phrase “selectable marker” refers to a nucleic acid segment that allows one to select for or against a molecule (e.g., a replicon) or a cell that contains it, often under particular conditions. These markers can encode an activity, such as, but not limited to, production of RNA, peptide, or protein, or can provide a binding site for RNA, peptides, proteins, inorganic and organic compounds or compositions and the like. Examples of selectable markers include but are not limited to: (1) nucleic acid segments that encode products that provide resistance against otherwise toxic compounds (e.g., antibiotics); (2) nucleic acid segments that encode products that are otherwise lacking in the recipient cell (e.g., tRNA genes, auxotrophic markers); (3) nucleic acid segments that encode products that suppress the activity of a gene product; (4) nucleic acid segments that encode products that can be readily identified (e.g., phenotypic markers such as (.beta.-galactosidase, green fluorescent protein (GFP), yellow flourescent protein (YFP), red fluorescent protein (RFP), cyan fluorescent protein (CFP), and cell surface proteins); (5) nucleic acid segments that bind products that are otherwise detrimental to cell survival and/or function; (6) nucleic acid segments that otherwise inhibit the activity of any of the nucleic acid segments described in Nos. 1-5 above (e.g., antisense oligonucleotides); (7) nucleic acid segments that bind products that modify a substrate (e.g., restriction endonucleases); (8) nucleic acid segments that can be used to isolate or identify a desired molecule (e.g., specific protein binding sites); (9) nucleic acid segments that encode a specific nucleotide sequence that can be otherwise non-functional (e.g., for PCR amplification of subpopulations of molecules); (10) nucleic acid segments that, when absent, directly or indirectly confer resistance or sensitivity to particular compounds; and/or (11) nucleic acid segments that encode products that either are toxic (e.g., Diphtheria toxin) or convert a relatively non-toxic compound to a toxic compound (e.g., Herpes simplex thymidine kinase, cytosine deaminase) in recipient cells; (12) nucleic acid segments that inhibit replication, partition or heritability of nucleic acid molecules that contain them; and/or (13) nucleic acid segments that encode conditional replication functions, e.g., replication in certain hosts or host cell strains or under certain environmental conditions (e.g., temperature, nutritional conditions, etc.).

Site-Specific Recombinase: As used herein, the phrase “site-specific recombinase” refers to a type of recombinase that typically has at least the following four activities (or combinations thereof): (1) recognition of specific nucleic acid sequences; (2) cleavage of said sequence or sequences; (3) topoisomerase activity involved in strand exchange; and (4) ligase activity to reseal the cleaved strands of nucleic acid (see Sauer, B., Current Opinions in Biotechnology 5:521-527 (1994)). Conservative site-specific recombination is distinguished from homologous recombination and transposition by a high degree of sequence specificity for both partners. The strand exchange mechanism involves the cleavage and rejoining of specific nucleic acid sequences in the absence of DNA synthesis (Landy, A. (1989) Ann. Rev. Biochem. 58:913-949).

Suppressor tRNAs. As used herein, the phrase “suppressor tRNA” refers to a molecule that mediates the incorporation of an amino acid in a polypeptide in a position corresponding to a stop codon in the mRNA being translated.

Homologous Recombination: As used herein, the phrase “homologous recombination” refers to the process in which nucleic acid molecules with similar nucleotide sequences associate and exchange nucleotide strands. A nucleotide sequence of a first nucleic acid molecule that is effective for engaging in homologous recombination at a predefined position of a second nucleic acid molecule will therefore have a nucleotide sequence that facilitates the exchange of nucleotide strands between the first nucleic acid molecule and a defined position of the second nucleic acid molecule. Thus, the first nucleic acid will generally have a nucleotide sequence that is sufficiently complementary to a portion of the second nucleic acid molecule to promote nucleotide base pairing.

Homologous recombination requires homologous sequences in the two recombining partner nucleic acids but does not require any specific sequences. As indicated above, site-specific recombination that occurs, for example, at recombination sites such as att sites, is not considered to be “homologous recombination,” as the phrase is used herein.

Vector: As used herein, the term “vector” refers to a nucleic acid molecule (preferably DNA) that provides a useful biological or biochemical property to an insert. Examples include plasmids, phages, viruses, autonomously replicating sequences (ARS), centromeres, and other sequences that are able to replicate or be replicated in vitro or in a host cell, or to convey a desired nucleic acid segment to a desired location within a host cell. A vector can have one or more restriction endonuclease recognition sites (e.g., two, three, four, five, seven, ten, etc.) at which the sequences can be cut in a determinable fashion without loss of an essential biological function of the vector, and into which a nucleic acid fragment can be spliced in order to bring about its replication and cloning. Vectors can further provide primer sites (e.g., for PCR), transcriptional and/or translational initiation and/or regulation sites, recombinational signals, replicons, selectable markers, etc. Clearly, methods of inserting a desired nucleic acid fragment that do not require the use of recombination, transpositions or restriction enzymes (such as, but not limited to, uracil N-glycosylase (UDG) cloning of PCR fragments (U.S. Pat. Nos. 5,334,575 and 5,888,795, both of which are entirely incorporated herein by reference), T:A cloning, and the like) can also be applied to clone a fragment into a cloning vector to be used according to the present invention. The cloning vector can further contain one or more selectable markers (e.g., two, three, four, five, seven, ten, etc.) suitable for use in the identification of cells transformed with the cloning vector.

Subcloning Vector: As used herein, the phrase “subcloning vector” refers to a cloning vector comprising a circular or linear nucleic acid molecule that includes, preferably, an appropriate replicon. In the present invention, the subcloning vector can also contain functional and/or regulatory elements that are desired to be incorporated into the final product to act upon or with the cloned nucleic acid insert. The subcloning vector can also contain a selectable marker (preferably DNA).

Primer: As used herein, the term “primer” refers to a single stranded or double stranded oligonucleotide that is extended by covalent bonding of nucleotide monomers during amplification or polymerization of a nucleic acid molecule (e.g., a DNA molecule). In one aspect, the primer may be a sequencing primer (for example, a universal sequencing primer). In another aspect, the primer may comprise a recombination site or portion thereof.

Adapter: As used herein, the term “adapter” refers to an oligonucleotide or nucleic acid fragment or segment (preferably DNA) that comprises one or more recombination sites (or portions of such recombination sites) that can be added to a circular or linear nucleic acid molecule as well as to other nucleic acid molecules described herein. When using portions of recombination sites, the missing portion may be provided by the nucleic acid molecule. Such adapters may be added at any location within a circular or linear molecule, although the adapters are preferably added at or near one or both termini of a linear molecule. Preferably, adapters are positioned to be located on both sides (flanking) a particular nucleic acid molecule of interest. In accordance with the invention, adapters may be added to nucleic acid molecules of interest by standard recombinant techniques (e.g., restriction digest and ligation). For example, adapters may be added to a circular molecule by first digesting the molecule with an appropriate restriction enzyme, adding the adapter at the cleavage site and reforming the circular molecule that contains the adapter(s) at the site of cleavage. In other aspects, adapters may be added by homologous recombination, by integration of RNA molecules, and the like. Alternatively, adapters may be ligated directly to one or more and preferably both termini of a linear molecule thereby resulting in linear molecule(s) having adapters at one or both termini. In one aspect of the invention, adapters may be added to a population of linear molecules, (e.g., a cDNA library or genomic DNA that has been cleaved or digested) to form a population of linear molecules containing adapters at one and preferably both termini of all or substantial portion of said population.

Adapter-Primer: As used herein, the phrase “adapter-primer” refers to a primer molecule that comprises one or more recombination sites (or portions of such recombination sites) that can be added to a circular or to a linear nucleic acid molecule described herein. When using portions of recombination sites, the missing portion may be provided by a nucleic acid molecule (e.g., an adapter) of the invention. Such adapter-primers may be added at any location within a circular or linear molecule, although the adapter-primers are preferably added at or near one or both termini of a linear molecule. Such adapter-primers may be used to add one or more recombination sites or portions thereof to circular or linear nucleic acid molecules in a variety of contexts and by a variety of techniques, including but not limited to amplification (e.g., PCR), ligation (e.g., enzymatic or chemical/synthetic ligation), recombination (e.g., homologous or non-homologous (illegitimate) recombination) and the like.

Template: As used herein, the term “template” refers to a double stranded or single stranded nucleic acid molecule, all or a portion of which is to be amplified, synthesized, reverse transcribed, or sequenced. In the case of a double-stranded DNA molecule, denaturation of its strands to form a first and a second strand is preferably performed before these molecules may be amplified, synthesized or sequenced, or the double stranded molecule may be used directly as a template. For single stranded templates, a primer complementary to at least a portion of the template hybridizes under appropriate conditions and one or more polypeptides having polymerase activity (e.g., two, three, four, five, or seven DNA polymerases and/or reverse transcriptases) may then synthesize a molecule complementary to all or a portion of the template. Alternatively, for double stranded templates, one or more transcriptional regulatory sequences (e.g., two, three, four, five, seven or more promoters) may be used in combination with one or more polymerases to make nucleic acid molecules complementary to all or a portion of the template. The newly synthesized molecule, according to the invention, may be of equal or shorter length compared to the original template. Mismatch incorporation or strand slippage during the synthesis or extension of the newly synthesized molecule may result in one or a number of mismatched base pairs. Thus, the synthesized molecule need not be exactly complementary to the template. Additionally, a population of nucleic acid templates may be used during synthesis or amplification to produce a population of nucleic acid molecules typically representative of the original template population.

Incorporating: As used herein, the term “incorporating” means becoming a part of a nucleic acid (e.g., DNA) molecule or primer.

Library: As used herein, the term “library” refers to a collection of nucleic acid molecules (circular or linear). In one embodiment, a library may comprise a plurality of nucleic acid molecules (e.g., two, three, four, five, seven, ten, twelve, fifteen, twenty, thirty, fifty, one hundred, two hundred, five hundred one thousand, five thousand, or more), that may or may not be from a common source organism, organ, tissue, or cell. In another embodiment, a library is representative of all or a: portion or a significant portion of the nucleic acid content of an organism (a “genomic” library), or a set of nucleic acid molecules representative of all or a portion or a significant portion of the expressed nucleic acid molecules (a cDNA library or segments derived therefrom) in a cell, tissue, organ or organism. A library may also comprise nucleic acid molecules having random sequences made by de novo synthesis, mutagenesis of one or more nucleic acid molecules, and the like. Such libraries may or may not be contained in one or more vectors (e.g., two, three, four, five, seven, ten, twelve, fifteen, twenty, thirty, fifty, etc.). In some embodiments, a library may be “normalized” library (i.e., a library of cloned nucleic acid molecules from which each member nucleic acid molecule can be isolated with approximately equivalent probability).

Normalized. As used herein, the term “normalized” or “normalized library” means a nucleic acid library that has been manipulated, preferably using the methods of the invention, to reduce the relative variation in abundance among member nucleic acid molecules in the library to a range of no greater than about 25-fold, no greater than about 20-fold, no greater than about 15-fold, no greater than about 10-fold, no greater than about 7-fold, no greater than about 6-fold, no greater than about 5-fold, no greater than about 4-fold, no greater than about 3-fold or no greater than about 2-fold.

Amplification: As used herein, the term “amplification” refers to any in vitro method for increasing the number of copies of a nucleic acid molecule with the use of one or more polypeptides having polymerase activity (e.g., one, two, three, four or more nucleic acid polymerases or reverse transcriptases). Nucleic acid amplification results in the incorporation of nucleotides into a DNA and/or RNA molecule or primer thereby forming a new nucleic acid molecule complementary to a template. The formed nucleic acid molecule and its template can be used as templates to synthesize additional nucleic acid molecules. As used herein, one amplification reaction may consist of many rounds of nucleic acid replication. DNA amplification reactions include, for example, polymerase chain reaction (PCR). One PCR reaction may consist of 5 to 100 cycles of denaturation and synthesis of a DNA molecule.

Nucleotide: As used herein, the term “nucleotide” refers to a base-sugar-phosphate combination. Nucleotides are monomeric units of a nucleic acid molecule (DNA and RNA). The term nucleotide includes ribonucleoside triphosphates ATP, UTP, CTG, GTP and deoxyribonucleoside triphosphates such as dATP, dCTP, dITP, dUTP, dGTP, dTTP, or derivatives thereof. Such derivatives include, for example, [.alpha.-S]dATP, 7-deaza-dGTP and 7-deaza-dATP. The term nucleotide as used herein also refers to dideoxyribonucleoside triphosphates (ddNTPs) and their derivatives. Illustrated examples of dideoxyribonucleoside triphosphates include, but are not limited to, ddATP, ddCTP, ddGTP, ddITP, and ddTTP. According to the present invention, a “nucleotide” may be unlabeled or detectably labeled by well known techniques. Detectable labels include, for example, radioactive isotopes, fluorescent labels, chemiluminescent labels, bioluminescent labels and enzyme labels.

Nucleic Acid Molecule: As used herein, the phrase “nucleic acid molecule” refers to a sequence of contiguous nucleotides (riboNTPs, dNTPs, ddNTPs, or combinations thereof) of any length. A nucleic acid molecule may encode a full-length polypeptide or a fragment of any length thereof, or may be non-coding. As used herein, the terms “nucleic acid molecule” and “polynucleotide” may be used interchangeably and include both RNA and DNA.

Oligonucleotide: As used herein, the term “oligonucleotide” refers to a synthetic or natural molecule comprising a covalently linked sequence of nucleotides that are joined by a phosphodiester bond between the 3′ position of the pentose of one nucleotide and the 5′ position of the pentose of the adjacent nucleotide.

Open Reading Frame (ORF): As used herein, an open reading frame or ORF refers to a sequence of nucleotides that codes for a contiguous sequence of amino acids. ORFs of the invention may be constructed to code for the amino acids of a polypeptide of interest from the N-terminus of the polypeptide (typically a methionine encoded by a sequence that is transcribed as AUG) to the C-terminus of the polypeptide. ORFs of the invention include sequences that encode a contiguous sequence of amino acids with no intervening sequences (e.g., an ORF from a cDNA) as well as ORFs that comprise one or more intervening sequences (e.g., introns) that may be processed from an mRNA containing them (e.g., by splicing) when an mRNA containing the ORF is transcribed in a suitable host cell. ORFs of the invention also comprise splice variants of ORFs containing intervening sequences.

ORFs may optionally be provided with one or more sequences that function as stop codons (e.g., contain nucleotides that are transcribed as UAG, an amber stop codon, UGA, an opal stop codon, and/or UAA, an ochre stop codon). When present, a stop codon may be provided after the codon encoding the C-terminus of a polypeptide of interest (e.g., after the last amino acid of the polypeptide) and/or may be located within the coding sequence of the polypeptide of interest. When located after the C-terminus of the polypeptide of interest, a stop codon may be immediately adjacent to the codon encoding the last amino acid of the polypeptide or there may be one or more codons (e.g., one, two, three, four, five, ten, twenty, etc) between the codon encoding the last amino acid of the polypeptide of interest and the stop codon. A nucleic acid molecule containing an ORF may be provided with a stop codon upstream of the initiation codon (e.g., an AUG codon) of the ORF. When located upstream of the initiation codon of the polypeptide of interest, a stop codon may be immediately adjacent to the initiation codon or there may be one or more codons (e.g., one, two, three, four, five, ten, twenty, etc) between the initiation codon and the stop codon.

Polypeptide: As used herein, the term “polypeptide” refers to a sequence of contiguous amino acids of any length. The terms “peptide,” “oligopeptide,” or “protein” may be used interchangeably herein with the term “polypeptide.”

Hybridization: As used herein, the terms “hybridization” and “hybridizing” refer to base pairing of two complementary single-stranded nucleic acid molecules (RNA and/or DNA) to give a double stranded molecule. As used herein, two nucleic acid molecules may hybridize, although the base pairing is not completely complementary. Accordingly, mismatched bases do not prevent hybridization of two nucleic acid molecules provided that appropriate conditions, well known in the art, are used. In some aspects, hybridization is said to be under “stringent conditions.” By “stringent conditions,” as the phrase is used herein, is meant overnight incubation at 42 .degree. C. in a solution comprising: 50% formamide, 5 .times. SSC (750 mM NaCl, 75 mM trisodium citrate), 50 mM sodium phosphate (pH 7.6), 5 .times. Denhardt's solution, 10% dextran sulfate, and 20 .mu.g/ml denatured, sheared salmon sperm DNA, followed by washing the filters in 0.1 .times. SSC at about 65 .degree. C.

Feature: As used herein, the term “feature” refers to a segment of a biomolecule that provides a specific function. For example, a “feature” can be a region of a polypeptide or polynucleotide that has a specific function. In an illustrative example, a feature is a region of a vector that has a specific function. For example, a feature on a vector includes, but is not limited to, a restriction enzyme site, a recombination site, or a tag-encoding sequence.

An exemplary list of vectors that can be used in the in silico design methods, includes the following: BaculoDirect Linear DIMA; BacuiloDirect Linear; DNA Cloning Fragment DNA; BaculoDirect N-term Linear DNA_verA; BaculoDirect™ C-Term Baculovirus Linear DNA; BaculoDirect™ N-Term Baculovirus Linear DNA; Champion™ pET100/D-TOPO®; Champion™ pET 101/D-TOPO®; Champion™ pET 102/D-TOPO®; Champion™ pET 104/D-TOPO®; Champion™ pET104-DEST; Champion™ pET151/D-TOPO©; Champion™ pET 160/D-TOPO®; Champion™ pET 160-DEST; Champion™ pET 161-DEST; Champion™ pET200/D-TOPO®; pAc5.1/V5-His A, B, and C; pAd/BLOCK-iT-DEST; pAd/BLOCK-f!.“-DEST_verA_sz; pAd/CMVA/5 DEST; pAd/PL-DEST; pAO815; pBAD/glll A, B, and C; pBAD/His A, B, and C; pBAD/myc-His A, B, and C; pBAD/Thio-TOPO®; pBAD 102/D-TOPO®; pBAD20/D-TOPO®; pBAD202/D-TOPO®; pBAD DEST49; PBAD-TOPO; PBAD-TOPO®; pBCl; pBLOCK-fT3-DEST pBLOCK-iT6-DEST pBlueBac4.5 pBlueBac4.5A/5-His TOPO®; pBlueBacHis2 A, B, and C; pBR322; pBudCE4.1; pcDN3.1A/5-His-TOPO; pcDNA3.1(−); pcDNA3.1(+); pcDNA3.1(+)/myc-HisA; pcDNA3.1(+)/myc-His A, B, C; pcDNA3.1(+)/myc-His B; pcDNA3.1(+)/myc-HisC; DCDNA3.1/CT-GFP-TOPO; pcDNA3.1/His A; pcDNA3.1/His B; pcDNA3.1/His C; pcDNA3.1/Hygro(−); pcDNA3.1/Hygro(+); pcDNA3.1/NT-GFP-TOPO; pcDNA3.1/nV5-DEST; pcDNA3.1A/5-His A; pcDNA3.1A/5-His B; pcDNA3.1A/5-His C; pcDNA3.1/Zeo(−); pcDNA3.1/Zeo(+); pcDNA3.1/Zeo(+); pcDNA3.1DA/5-His-TOPO; pcDNA3.2/V5-DEST; pcDNA3.2A/5-GW/D-TOPO; pcDNA3.2-DEST; pcDNA4/His A; pcDNA4/His B; pcDNA4/His C; pcDNA4/HisMAX A, B & C; pcDNA4/HisMax-TOPO; pcDNA4/HisMax-TOPO; pcDNA4/myc-His A, B, and C; pcDNA4/TO; pcDNA4/TO; pcDNA4/TO/myc-His A; pcDNA4/TO/myc-His A, B, C; pcDNA4/TO/myc-His B; pcDNA4/TO/myc-His C; pcDNA4/V5-His A, B, and C; pcDNA5/FRT; pcDNA5/FRT; pcDNA5/FRT/TO/CAT; pcDNA5/FRT/TO-TOPO; pcDNA5/FRT/V5-His-TOPO; pcDNA5/TO; pcDNA6.2/cGeneBLAzer-DEST_verA_sz; pcDNA6 2/cGeneBLAzer-GW/D-TOPO pcDNA6; 2/cGeneBlazer-GW/D-TOPO_verA_sz pcDNA6.2/cLumio-DEST; pcDNA6 2/cLumio-DE STverAsz pcDNA6.2/GFP-DEST_verA_sz; pcDNA6.2/nGeneBLAzer-DEST pcDNA6 2/nGeneBLAzer-DEST_verA_sz pcDMA6 2/nGeneBlazer-GW/D-TOPO_verA_s2 pcDNA6.2/nLumio-DEST; pcDNA6 2/nLumio-DEST_verB_sz; pcDNA6.2A/5-DEST pcDNA6.2A/5-GW/D-TOPO pcDNA6/BioEase-DEST verAsz; pcDNA6/H62His A, B, and C pcDNA6/His A, B, and C; pcDNA6/TR; pcDNA6/V5-His A; pcDNA6/V5-His B; pcDNA6/V5-His C; pcDNA6/V5-His C; pcDNA-DEST40; pcDNA-DEST47; pcDNA-DEST53; pCEP4; pCEP4/CAT; pCMV/myc/cyto; pCMV/myc/ER; pCMV/myc/mito; pCMV/myc/nuc; pCMVSPORT6 Notl-Sall Cut; pCoBlasi; pCR Blunt; pCR XL TOPO; pCR®T7/CT TOPO®; pCR®T7/NT TOPO®; pCR2.1-TOPO; pCR3.1; pCR3.1-Uni; pCR4BLUNT-TOPO; pCR4-TOPO; pCR8/GW/TOPO TA; pCR8/GW-TOPO_verA_sz; pCR-Blunt II-TOPO; −pCRII-TOPO; pDEST™ R4-R3; PDEST™10; PDEST™14; PDEST™15; pDEST™17; pDEST™20; pDEST™22; PDEST™24; pDEST™26; pDES™27; pDEST™32; pDEST™8; pDEST™™ 38; pDEST™™ 39; pDisplay; pDONR™ P2R P3; PDONR™ P2R-P3; pDONR™ P4-P1R; pDONR™ P4-P1R; pDONR™/Zeo; pDONR™/Zeo; pDONR™201; pDONR™201; pDONR™207; pDONR™207; pDONR™221; pDONR™221; pDONR™222; pDONR™222; pEF/myc/cyto; pEF/myc/mito; pEF/myc/nuc; pEFi/His A, B, and C; pEF1/myc-His A, B, and C; pEF1/V5-HisA, B, and C; pEF4/myc-His A, B, and C; pEF4/V5-His A, B, and C; pEF5/FRT V5 D-TOPO; pEF5/FRT/V5-DEST™; pEF6/His A, B, and C; pEF6/myc-His A, B, and C; pEF6/V5-His A, B, and C; pEF6A/5-His-TOPO; pEF-DEST51; pENTR U6_verA_sz; pENTR/HirTO_verA_sz; pENTR-TEV/D-TOPO; pENTR™/D-TOPO; pENTR™/D-TOPO; pENTR™/SD/D-TOPO; pENTR™/SD/D-TOPO; pENTR™/TEV/D-TOPO; pENTR™11; pENTR™1A; pENTR™2B; pENTR™3C; pENTR™4; pET SUMO_verA_sz; pET104.1-DEST_verA_sz; pET104-DEST; pET 160/GW/D-TOPO_verA sz pET160-DEST_verA_sz; pET161 D-TOPO; pET 161/G W/D-TOPO_verA_sz; pET161-DEST_verA_sz; pEXPi-DEST pEXP2-DEST pEXP3-DEST; pEXP3-DEST_vefA_sz; pEXP-AD502 pFastBac Dual pFastBad pFastBacHTA pFastBacHT B pFaslBacHT C; pFLDa; pFliTrx; pFRT/lacZeo; pFRT/lacZeo, pOG44, pcDNA5/FRT; pFRT/lacZeo2; pGAPZ A, B, and C; pGAPZa A, B. and C; pGene/V5-His A, B, and C; pGeneBLAzer-TOPO; pGeneBLAzer-TOPOverA sz; pGlow-TOPO; pH)1_-D2; pH1L-S1; pHybLex/Zeo; pHyBLex/Zeo-MS2; pIB/His A, B, and C; pIBA/5-His Topo; pIBA/5-His-DEST; plBA/5-His-TOPO; plZA/5-His; p!ZT/V5-His; pl_en!i4 BLOCK-iT-DEST; pLenti4/BLOCK-iT-DEST; pLenti4/T0A/5-DEST; pLenti4/T0A/5-DEST_verA sz; pLenti4A/5-DEST; p L e n 114.”/5-DE ST ye rA_sz; pLenti6/BLOCK-tT-DEST; pl_entiS/BLOCK-iT-DEST_verA_sz; pLenti6/UbCA/5-DEST; pLenti6/UbC/vSDEST_verA_sz; pLenli6A/5-DEST; pLen!i6A/5-D-TOPO; plex; pMelBac A, B, and C; pMET A, B, and C; pMETa A, B, C; pMIBA/5-His A, B, and C; pMIBA/5-His/CAT; pMT/BioEase-DESTverAsz; pMT/BioEase™-DEST; pMT/BioEase™-DEST; pMT/BiPA/5-His A, B, and C; pMT/V5-His A, B, and C; pMT/V5-His-TOPO; pMT-DEST™ 48; pNMT; pNMT1-TOPO; pNMT41-TOPO; pNMT81-TOPO; pOG44; pPIC3.5K; pPIC6 A, B, and C; pPIC6a A, B, and C; pPICZ A; pPICZ B; pPICZ C; pPICZalpha A; pPICZalpha B; pPICZalpha C; pREP4; pRH3′; pRH5.sup.f; pRSET; pSCRE EN-iT/lacZ-DEST_verA_sz; pSecTag/FRTA/5-His TOPO; pSecTag2 A, B, and C; pSecTag2/Hygro A, B, and C; pSH18-34; pThioHis A, B, and C; pTracer-CMV/Bsd; pTracer-CMV2; pTracer-EF A, B, and C; pTracer-EF/Bsd A, B, and C; pTracer-SV40; pTrcHis A, B. and C; pTrcHis2 A, B, and C; pTrcHis2-TOPO®; pTrcHis2-TOPO®; pTrcHis-TOPO®; pT-Rex-DEST30; pT-Rex-DEST30; pT-Rex-DEST™ 31; pT-REx™-DEST31; pUB/BSD TOPO; pUB6A/5-His A, B, and C; pUC18; pUC19; pUni/V5 His TOPO; pVAX1; pVP22/myc-His TOPO®; pVP22/myc-His2 TOPO®; pYC2.1-E; pYC2/CT; pYC2/Nt A, B. C; pYC2-E; pYC6/CT; pYD1; pYES2; pYES2.1A/5-His-TOPO; pYES2/CT; pYES2/NT; pYES2/NT A, B, & C; pYES3/CT; pYES6/CT; pYES-DEST™ 52; pYESTrp; pYESTrp2; pYESTrp3; pZeoSV2(−); pZeoSV2(+); pZErO-1; pZErO-2.

Related products or services. As used herein, the phrase “related product or service” refers to a product or service that relates to a region of a biomolecule, or an entire biomolecule, presented to a customer.

A directly related product or service is a product or service that relates to an entire biomolecule presented to a customer. For example, if an in silico vector design experiment is design of a primer, then a link to a service for synthesizing the primer presented to the customer by the in silico primer design function, is a directly related product.

As used herein, the phrase “indirectly related product” refers to a product that relates to a region or feature of a biomolecule presented to a customer, but is not an entire biomolecule presented to a customer. In one embodiment of the invention, an indirectly related product refers to a portion or feature of an entire biomolecule, but the indirectly related product is less then the entire biomolecule. In another embodiment, the indirectly related product may be peripheral to the specifically identified biomolecule, but related to the identified biomolecule in the sense that the product or service is useful and/or necessary in accomplishing the ultimate experimental goals of the researcher as they relate to the identified biomolecule. For example, in an in silico vector design experiment, a link to an indirectly related product may be a link to the purchase of an antibiotic that corresponds to an antibiotic resistance gene that is on a vector that is designed by the in silico biotechnology experiment design and simulation function. As another example, an insilico designed vector may be designed to express a fusion protein that includes a human open reading frame, a site for protease cleavage and an affinity tag; and indirectly related products presented to a customer that indirectly relate to the designed vector can include competent cells for transfection, media for growing the cells, an affinity resin that specifically binds to the affinity tag, protein encoded by the human open reading frame, an antibody against the human open reading frame, and a protease that recognizes the protease cleavage site. A figure listing exemplary features and associated products is attached hereto (see, FIG. 1). In addition to features and associated products, as illustrated in the figure, the table can include a feature number, a sku, a product description, and a product size. From the specific product listing, general classes of products are revealed that can be used with the methods provided herein. Products are classified as relating to cloning selection, detection, purification, and/or expression.

The phrase “indirectly related service” refers to a service that relates to a step, biomolecule, portion of a biomolecule, or feature of a biomolecule, provided by an in silico design or simulation experiment, but is not an entire step of the in silico design or simulation experiment that resulted in the presentation of the service to the customer. Furthermore, an indirectly related service can be related to a region of a biomolecule presented to a customer by the in silico design and simulation function, but is not synthesis of the entire biomolecule presented to the customer. As indicated above, FIG. 1, provides a list of features of biomolecules and exemplary directly and indirectly related products. For example, IPTG and SUMO protease are products that are indirectly related to a SUMO recognition site feature (273000), whereas a nucleic acid molecule that has the nucleotide sequence of a SUMO recognition site is a product that is directly related to a SUMO recognition site feature. All of the products in FIG. I that are not isolated nucleic acid molecules, are indirectly related products. Accordingly, in a preferred embodiment, an indirectly related product is a biologically active molecule or a kit for a biotechnology experiment or other biotechnology reagent that is not an isolated nucleic acid molecule.

Other terms used in the fields of recombinant nucleic acid technology and molecular and cell biology as used herein will be generally understood by one of ordinary skill in the applicable arts.

The invention relates to methods and compositions for electronic presentation of information. In many instances, this electronic information will be presented to customers. Further, in certain embodiments of the invention, in silico experiments are performed which lead to the generation of data. In other embodiments, no in silico experiments are performed. In particular embodiments of the invention, regardless of whether in silico experiments are performed, information (e.g., experimental data) may be presented to customers in a manner that allows for the purchase of products. Typically, these products are presented in such a manner as to allow the customer to purchase them. Such purchases may be made at the source of the electronic information (e.g., a web page) or by other means (e.g., by placing a phone call, sending a facsimile, sending an e-mail, etc.). In view of the above, the invention relates, in part, to an online store.

The present invention is based in part on the discovery that access to an online store containing biological products can be presented to a customer based on an in silico designed experiment, such as an experiment that involves the generation or modification of a nucleic acid or protein, such as by using recombinant biotechnologies. Typically, the products are indirectly related to the in silico designed experiment. For example, the product can be an antibiotic, wherein an in silico-designed vector includes an antibiotic resistance gene. Furthermore, the present invention is based on the discovery of a method by which a provider generates revenue by providing free to customers, a computer program for designing and/or performing an experiment in silico, while providing links that allow the customer to purchase related products from the provider. The method provides much less time and effort for a potential customer than traditional ordering methods for identifying and ordering products to carry out an experiment.

The present invention is additionally based in part on a model wherein revenue is generated by providing free to customers, a first computer program for designing and/or performing an experiment in silico, while providing for purchase by the customer, a second, more full-featured, or differently featured computer program for designing and/or performing an experiment in silico. Thus, in one embodiment, the invention includes a computer program product for use in conjunction with a computer system. The computer program product may include, for example, a computer readable storage medium and a computer program mechanism embedded therein, the computer program mechanism comprising computer-readable instructions for designing or simulating a biotechnology experiment in silico; and computer-readable instructions for providing a customized list of one or more biotechnology products and/or services related to the in silico designed biotechnology experiment or the product of that experiment.

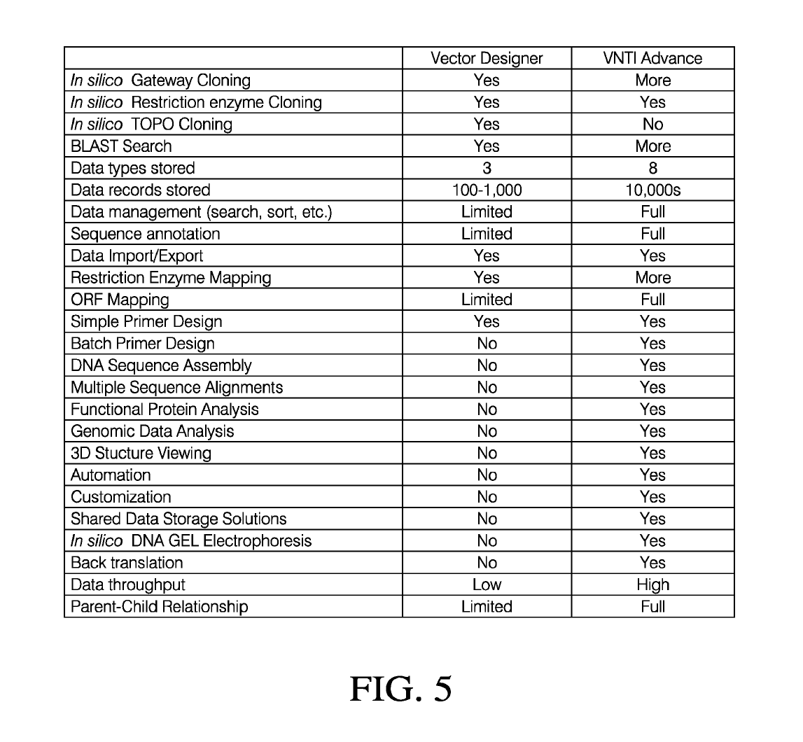

In these embodiments, the second computer program product possesses increased functionality compared to the first computer program product, or different functionality that the first computer program product. That is, the second computer program product is capable of performing a greater number of, and/or different functions compared to the first computer program product. In other words, the first computer program has reduced or different functionality compared to the second computer program product. See, e.g., FIG. 5, which provides an illustrative list of features that can be provided in a first computer program, sometimes referred to herein as VectorDesigner™ and a second computer program, sometimes referred to herein as Vector NTI Advance™ or VNTI, which contains more features than the first computer program.

In one aspect, the second program product provides batch in silico design functionality, which is not provided by the first computer program product. In in silico batch cloning a computer program product is capable of repeating the same steps multiple times with one setup. For example, the second computer program product can provide a functionality for performing an in silico experiment for designing a recombinant biomolecule from one or more than one vector and/or one or more than one open reading frame of interest, whereas the first computer program product provides a functionality for performing an in silico experiment for designing a recombinant biomolecule from a single vector and a single open reading frame. In certain illustrative aspects, the in silico experiment is a TOPO cloning experiment or an experiment for generating a recombinant molecule using a recombination site. These types of experiments are more amenable to batch processing than restriction enzyme experiments because there are far fewer recombination sites than restriction sites that could hamper an in silico experiment for designing a recombinant biomolecule. In another example, a second computer program product performs a recombinant cloning experiment, such as a Gateway® cloning experiment, where several different polynucleotides are ligated together.

In another aspect, the first computer program product is not only a biomolecular sequence viewer. In another aspect, the second computer program product provides additional parameters that relate to designing nucleic acid probes or primers, such as amplification primers, than are provided in the first computer program product. For example, the first and second program products can include parameters for designing primers to add recombination sites, for example Att sites, on both ends of a nucleic acid molecule using the primers and PCR. Parameters for primer design are known in the art and include, for example, but not intended to be limiting, length of primer, the presence of other recombination sites or recognition signals, GC content, nucleotide composition, melting temperature, optimal salt concentration. For example, the first computer program product can have less than 5%, less than 10%, less than 25%, less than 50%, or less than 75% of the primer design parameters than the second computer program product. In another example, only the second computer program product provides one or more of the following features: Design multiple pairs of PCR primers to amplify individual sequence selections, and automatically rank each pair for fitness; Amplify annotated features in batch, using convenient graphical selection techniques; Fine-tune the quality of oligonucleotides by setting parameters for many primer attributes, including uniqueness; Design primers for advanced experimental tasks such as multiplex PCR, alignment PCR, and long PCR; Order and modify primers online using seamless connectivity from to an online primer ordering website; Map existing oligos onto novel sequences to test their usefulness in additional experiments; Save parameter settings and reload them instantly for future experiments; Search all stored oligos using numerous attributes, and use any oligo to search for related DNA sequences; Export all stored oligos in spreadsheet format quickly for submission to your oligo synthesis facility

In another aspect, the second computer program product includes additional biological knowledge than is included in the first computer program product. For example, only the second computer program product can include biological knowledge related to recombinational cloning sites or other error checking features. In yet another aspect, the second computer program product allows a user to store more recombinant molecules generated using in silico experiment design tools than the first computer program product.

The invention is further based, in part, on the discovery of a method for associating one or more products with a biomolecule by identifying one or more features on the biomolecule and identifying the one or more products associated with the features from a table of features and associated products. The products in the table typically include both directly and indirectly related products. An example of a Table of products is provided in FIG. 1. In certain aspects, the method is provided as a computer program product that includes a computer program embedded on a computer storage medium. Features are typically identified by searching the primary sequence or three-dimensional structure of the biomolecule, and are based on the type of biomolecule from which features are being identified. For example, the biomolecule can be a polypeptide or a polynucleotide.

The invention is further based on the discovery of a method of generating revenue comprising providing a customer with a first computer program product for designing or performing a biotechnology experiment in silico; and providing the customer with access to a purchase function for purchasing a second computer program product for designing or performing a biotechnology experiment in silico, wherein functionality of a first computer program of the first computer program product is less than the functionality of a second computer program of the second computer program product, or the second computer program provides functions that are not provided by the first computer program. Thus, the second computer program product is capable of performing a greater number of functions compared to the first computer program product. In one aspect, the customer can be provided a first computer program product without payment to a provider, whereas the customer must provide consideration to the provider, such as payment, for the second computer program product. In this aspect, the second computer program product can require a payment to the provider.

In another embodiment, provided herein is a method for providing a biotechnology product to a customer, including providing the customer with access to an automated function for designing a biotechnology experiment in silico; and—providing the customer with access to a purchasing function for purchasing biotechnology products for carrying out the designed biotechnology experiment, or for purchasing a product that is indirectly related to a biomolecule such as a vector produced by the in silico designed or simulated experiment. The purchasing function presents to the customer a customized list of one or more related products and/or services based on the in silico designed biotechnology experiments, thereby providing the biotechnology product to the customer. In illustrative embodiments, the related products and/or services, are indirectly related products and/or services.

In certain aspects, the customer is provided access to the automated function without payment to a provider of the automated function for the access. Accordingly, another embodiment provided herein is a method for generating revenue including, providing free access for a customer to an automated function for designing a biotechnology experiment in silico; and providing the customer with access to a purchasing function for purchasing one or more biotechnology products for carrying out the designed biotechnology experiment, and/or for ordering products that are indirectly related to the product of the in silico biotechnology experiment. The purchasing function presents to the customer a customized list of one or more related products and/or services based on the in silico designed biotechnology experiments.

The automated functions disclosed herein, are typically computer programs or modules of computer programs. The computer programs can be executed by a customer while the programs reside on the customer's local computer, or while the programs reside on a server connected to the customer's local computer. The server can be a server that is connected to the customer's computer as part of an intranet or an extranet. For example, in certain embodiments, the program resides on a server of the provider that is accessed by the customer from the provider's Internet site.

As indicated herein, in certain embodiments, access to one or more of the functions, for example access to a function for designing a biotechnology experiment in silico, can be free to the customer. Typically, the computer program for in silico experimental design also provides the customer with access to a purchasing function. The access, for example, can be provided in one or more hyperlinks to related products. The purchasing function allows the customer to purchase the related products presented to the customer by the function for designing an experiment in silico. The purchasing function can be linked to an Internet based shopping cart. Therefore, the customer upon being presented with links for purchasing related biotechnology products, can click the links to learn more about the biotechnology products and/or to add the related biotechnology products to an Internet shopping cart. Therefore, the provider generates revenue when the purchaser purchases the one or more products and/or services using the purchasing function. The provider can also provide links to the customer, to learn more about the related biotechnology product or an identified biomolecule.

The in silico methods provided herein, as exemplified by portions of Vector Designer or Vector NTI, are capable of identifying a feature on a given biomolecule, such as a vector. Accordingly, provided herein is a method for associating a product with a biomolecule, comprising identifying a feature on the biomolecule and identifying the product associated with the feature from a table of features and associated products. The process of associating features with biomolecules is referred to herein as annotating a biomolecule. The features are typically assigned a unique identifier, as exemplified under the “Feature” column of FIG. 1, in the column labeled “ID.” Typically, a population of products related to the feature are identified.

In certain aspects, a table of features and associated products is delivered to a customer on a computer readable medium, such as a compact disk, along with a computer program from performing other methods provided herein. In other aspects, a link to download the table of features and associated products is provided on an Internet site, for example associated with the purchase of a computer program for performing another method provided herein. In other aspects, access to the table is provided online as part of a free tool provided to a customer. In certain aspects, the table includes an identifier of a vector and identifiers of features on that vector.

Having the table reside on a host server that is controlled by a provider of a computer program product provided herein, has the advantage of being relatively easily maintained and updatable by the provider with new information, such as new vectors, new features, and/or new products. Therefore, in certain aspects, the table of features and associated products resides on a computer server, wherein access to the server is provided to more than one user, for example over an Internet connection or in a downloadable file, or a file provided on computer readable medium, such as a compact disk.

In another aspect, provided herein is a computer program product comprising a computer program mechanism embedded on a computer storage medium, wherein the computer program mechanism comprises computer-readable instructions for performing a method disclosed herein, such as a method for associating a product with a biomolecule.

In another aspect, the present invention provides a method for generating revenue, comprising selling to an advertiser, inclusion of a first product, or a first population of products, of the advertiser in a table of features and associated products; and providing to a customer, a computer program product for performing another method provided herein. The method can include analyzing the table of features. For example, the method can associate a population of products with a biomolecule, by identifying a feature on the biomolecule, and identifying the products associated with the feature from the table of features and associated products, wherein the products associated with the feature include the first product or the first population of products.

Furthermore, a plurality of advertisers can bid on the order of products that are presented to a customer by a provider from the table of features and associated products. Alternatively, the provider can be part of an on-line affiliate program provided by an advertiser, wherein the provider receives a percentage of revenue generated by the sale of Advertiser's products using the methods provided herein

In another aspect of this embodiment, provided to the customer, is a computer program product for performing a method for identifying biotechnology products, that includes providing access to an automated function for designing or simulating a biotechnology experiment in silico; and providing a customized list of one or more biotechnology products and/or services related to the in silico designed biotechnology experiment, or a product thereof, wherein the one or more biotechnology products comprises the first product.

Access to the computer program product can be provided over the Internet or via a computer readable medium delivered to a customer.

In another embodiment, the present invention, in part, provides a computer program product, comprising a computer readable file that includes a table of biomolecules, such as vectors, and associated features. The table can also identify products associated with features. Alternatively, product information can be provided through access to an Internet site, such as through access to a computer table of feature identifiers and associated products. In certain aspects, at least 25, 50, 100, 150, 200, 250, 500, or 1000 vectors are included in the Table. Unique identifiers for the vectors can be included in the table as well as an associated vector name, such as pBR322. In certain aspects, a feature is identified for more than one sequence. For example, some sequence variants, such as, for example, ampicillin resistance variants, provide the same feature.

In one illustrative example, a method of the present invention is provided by a program such as a java applet that uses features identified by analyzing sequence information of an in silico designed recombinant molecule, and/or information regarding a vector and the features therein, to provide a molecular viewer function in by generating html pages of a recombinant molecule generated using an in silico design experiment, or by generating html pages that include links to purchase products that are associated with features on a resulting vector.

By the methods provided herein, features on vectors used for a starting reaction are tracked by the program during the in silico design reactions to determine whether they are present in a resulting recombinant molecule. Alternatively, sequences of resulting recombinant molecules are analyzed for the presence of features, including those of a parent vector used to generate the recombinant molecule. Using the illustrative example, a method provided herein is performed in real time wherein html pages are built dynamically based on a recombinant molecule generated using the methods provided herein. Therefore, a customized output list is dynamically created in real time based on a recombinant molecule generated using an in silico design experiment.

A non-limiting example of a feature, discussed for illustrative purposes, is a HisG Epitope. The identification of this feature is typically carried out using sequence comparison tools, but can also be carried out by searching 3-dimensional structures or by searching annotations available in databases that include sequence annotations. Annotations can contain the positions of a sequence that include a feature. An identified feature is correlated to one or more directly or -indirectly related products. For example, HisG Epitope can be correlated to a number of indirectly related products such as ProBond™ Purification System and Ni-NTA Purification System for purification of recombinant proteins that contain a polyhistidine (6 .times.His) sequence and Positope™ Control Protein, a positive control in western blotting for a variety of antibodies such as anti HisG Epitope antibody.

Similarly, as another example, a feature identified as Hl/TO (tet operator) promoter can be linked to products that are indirectly associated with this feature such as Tetracycline, a bacteriocid which inhibits protein synthesis, T4 DNA Ligase which catalyzes the formation of phosphodiester bonds in presence of ATP and links two DNA strands, Flp-In™ T-Rex™-293 Cell Line designed for rapid generation of stable cell lines that express a protein of interest from a Flp-In™ expression vector and Lipofectamine™ 2000 for the transfection of DNA into eukaryotic cells. FIG. 1, included herein, lists numerous non-limiting examples of features and associated products.

Furthermore, methods provided herein can include links to purchase or order indirectly related services. For example, a given DNA sequence can be selected and submitted for antigenic peptide design and production followed by animal immunization and antibody production. Furthermore, users can select a clone from a database of clones and vectors and submit the clone id or sequence for protein over-expression and purification services.

Virtually any type of biological experiment can be designed and/or simulated in silico. For example, the in silico methods provided herein can identify alternative open reading Frames (ORFs) and corresponding protein translations, identify restriction maps of a given vector or an imported DNA sequence, and perform sequence based searches of public and proprietary databases during in silico methods of designing and simulating experiments.

In certain aspects the designed biotechnology experiment includes designing a recombinant molecule, for example designing a vector. The vector can include an insert, vector elements, for example sequences to assure that the vector is replicated in a host, as well as features, for example antibiotic resistance elements. For example, the in silico designed experiment can be a cloning experiment, such as a recombinational cloning experiment, as discussed in further detail herein. For example, the in silico cloning experiment utilizes vectors that comprise at least two different site-specific recombination sites. In certain aspects, the biotechnology products and/or, services are proteomic or genomic products and/or services. In certain illustrative aspects, the related products and/or services are indirectly related products and/or services.

In certain aspects, access to the automated function is provided over a wide-area network. In another embodiment, provided herein is a method for identifying biotechnology products, including providing access to an automated function for designing a biotechnology experiment in silico; and providing a customized list of one or more biotechnology products and/or services related to the in silico designed biotechnology experiment, or the product thereof, thereby identifying the biotechnology products.

In another aspect, the present invention provides a computer program product for use in conjunction with a computer system, the computer program product including a computer readable storage medium and a computer program mechanism embedded therein, the computer program mechanism including computer-readable instructions for designing a biotechnology experiment in silico; and computer-readable instructions for providing a customized list of one or more biotechnology products and/or services related to the in silico designed biotechnology experiment, or a product thereof.

Exemplary products offered by the provider can include clone collections and individual clones, polypeptides, such as enzymes, antibodies, libraries (e.g., cDNA libraries, genomic libraries, etc.), buffers, growth media, purification systems, primers, cell lines, chemical compounds, fluorescent labels, functional assays, and variety of kits including DNA and protein purification, amplification and modification. Further, these exemplary products are provided for example only and are not intended to limit the present invention.

Exemplary services offered by the provider include clone construction services, protein expression services, antibody production services, library (e.g., cDNA library, genomic library, etc.) construction services, and research and development consulting services.

A vector can include one or more functional sequences. Examples of vectors that can be used with the present invention are provided with this filing (see above). Methods provided herein can be carried out by associating functional sequences (i.e features) with products that are related to those functional sequences. For example, a figure provided herein lists examples of features and products associated with those features (FIG. 1). Therefore, products associated with functions on a vector are products that are indirectly related to the vector.

Functional sequences on the vector may be used to control the expression of a polypeptide of interest from an ORF and to influence the characteristics of the expressed polypeptide. Such sequences may be located anywhere in the vector that allows them to exert their function. For example, a vector may comprise a variety of sequences including, but not limited to, sequences suitable for use as primer sites (e.g., sequences to which a primer, such as a sequencing primer or amplification primer may hybridize to initiate nucleic acid synthesis, amplification or sequencing), transcription or translation signals or regulatory sequences such as promoters and/or enhancers, ribosomal binding sites, Kozak sequences, start codons, termination signals such as stop codons, origins of replication, recombination sites (or portions thereof), selectable markers, and ORFs or portions of ORFs to create protein fusions (e.g., N-terminal or C-terminal) such as GST, GUS, GFP, YFP, CFP, maltose binding protein, 6 histidines (HIS6), epitopes, haptens and the like and combinations thereof. In some embodiments, any one or more of the functional sequences discussed above may be operably linked to an ORF to form a nucleic acid sequence of interest comprising the ORF and one or more functional sequences. Thus functional sequences may be provided on a vector and/or as part of a nucleic acid sequence of interest.

In certain aspects, the in silico design and simulation function can provide design of a vector for recombinational cloning. The following paragraphs set out wet lab experimentation details that can be assisted by in silico experimental design, for example by designing primers with appropriate recognition sequences. For example, PCR amplification may be conducted using a template nucleic acid comprising the ORF. In some embodiments, primers for amplification may comprise all or a portion of one or more recognition sequences (e.g., restriction sites, topoisomerase recognition sites, and/or recombination sites). The amplification product may be inserted into a nucleic acid molecule (e.g., a vector) using techniques known in the art. In some embodiments, primers for amplification of an ORF may comprise a recombination site and the amplification product may be inserted into a vector using GATEWAY™ recombinational cloning techniques available from Invitrogen Corporation, Carlsbad, Calif.

After cloning an ORF into a vector, the entire ORF may be sequenced to ensure that the cloned ORF has the desired sequence. Sequencing may be accomplished using standard techniques (e.g., dideoxy sequencing).

In some embodiments, ORFs of the invention and/or vectors comprising the ORFs of the invention may be provided with one or more recombination sites to provide for shutting of an insert between vectors using a recombination protocol or experiment. Recombination sites for use in the invention may be any nucleic acid that can serve as a substrate in a recombination reaction. Such recombination sites may be wild-type or naturally occurring recombination sites, or modified, variant, derivative, or mutant recombination sites. Examples of recombination sites for use in the invention include, but are not limited to, phage-lambda recombination sites (such as attP, attB, attL, and attR and mutants or derivatives thereof) and recombination sites from other bacteriophages such as phi80, P22, P2, 186, P4 and P1 (including lox sites such as loxP and loxP511).

Recombination proteins and mutant, modified, variant, or derivative recombination sites include those described in U.S. Pat. Nos. 5,888,732, 6,143,557, 6,171,861, 6,270,969, and 6,277,608 and in U.S. application Ser. No. 09/438,358 (filed Nov. 12, 1999), based upon U.S. provisional application No. 60/108,324 (filed Nov. 13, 1998). Mutated att sites (e.g., attB 1-10, attP 1-10, attR 1-10 and attL 1-10) are described in U.S. provisional patent application Nos. 60/122,389, filed Mar. 2, 1999, 60/126,049, filed Mar. 23, 1999, 60/136,744, filed May 28, 1999, 60/169,983, filed Dec. 10, 1999, and 60/188,000, filed Mar. 9, 2000, and in U.S. application Ser. No. 09/517,466, filed Mar. 2, 2000, and Ser. No. 09/732,914, filed Dec. 11, 2000 (published as 20020007051-A1) the disclosures of which are specifically incorporated herein by reference in their entirety. Other suitable recombination sites and proteins are those associated with the GATEWAY™ Cloning Technology available from Invitrogen Corp., Carlsbad, Calif., and described in the product literature of the GATEWAY™ Cloning Technology, the entire disclosures of all of which are specifically incorporated herein by reference in their entireties.

Sites that may be used in the present invention include att sites. The 15 bp core region of the wild-type att site (GCTTTTTTAT ACTAA (SEQ ID NO: 1)), which is identical in all wild-type att sites, may be mutated in one or more positions. Other att sites that specifically recombine with other att sites can be constructed by altering nucleotides in and near the 7 base pair overlap region, bases 6-12 of the core region. Thus, recombination sites suitable for use in the methods, molecules, compositions, and vectors of the invention include, but are not limited to, those with insertions, deletions or substitutions of one, two, three, four, or more nucleotide bases within the 15 base pair core region (see U.S. application Ser. No. 08/663,002, filed Jun. 7, 1996 (now U.S. Pat. No. 5,888,732) and Ser. No. 09/177,387, filed Oct. 23, 1998, which describes the core region in further detail, and the disclosures of which are incorporated herein by reference in their entireties). Recombination sites suitable for use in the methods, compositions, and vectors of the invention also include those with insertions, deletions or substitutions of one, two, three, four, or more nucleotide bases within the 15 base pair core region that are at least 50% identical, at least 55% identical, at least 60% identical, at least 65% identical, at least 70% identical, at least 75% identical, at least 80% identical, at least 85% identical, at least 90% identical, or at least 95% identical to this 15 base pair core region.

Analogously, the core regions in attB1, attP1, attL1 and attR1 are identical to one another, as are the core regions in attB2, attP2, attL2 and attR2. Nucleic acid molecules suitable for use with the invention also include those comprising insertions, deletions or substitutions of one, two, three, four, or more nucleotides within the seven base pair overlap region (TTTATAC, bases 6-12 in the core region). The overlap region is defined by the cut sites for the integrase protein and is the region where strand exchange takes place. Examples of such mutants, fragments, variants and derivatives include, but are not limited to, nucleic acid molecules in which (1) the thymine at position I of the seven by overlap region has been deleted or substituted with a guanine, cytosine, or adenine; (2) the thymine at position 2 of the seven by overlap region has been deleted or substituted with a guanine, cytosine, or adenine; (3) the thymine at position 3 of the seven by overlap region has been deleted or substituted with a guanine, cytosine, or adenine; (4) the adenine at position 4 of the seven by overlap region has been deleted or substituted with a guanine, cytosine, or thymine; (5) the thymine at position 5 of the seven by overlap region has been deleted or substituted with a guanine, cytosine, or adenine; (6) the adenine at position 6 of the seven by overlap region has been deleted or substituted with a guanine, cytosine, or thymine; and (7) the cytosine at position 7 of the seven by overlap region has been deleted or substituted with a guanine, thymine, or adenine; or any combination of one or more (e.g., two, three, four, five, etc.) such deletions and/or substitutions within this seven by overlap region. The nucleotide sequences of representative seven base pair core regions are set out below.

Altered att sites have been constructed that demonstrate that (1) substitutions made within the first three positions of the seven base pair overlap (TTTATAC) strongly affect the specificity of recombination, (2) substitutions made in the last four positions (TTTATAC) only partially alter recombination specificity, and (3) nucleotide substitutions outside of the seven by overlap, but elsewhere within the 15 base pair core region, do not affect specificity of recombination but do influence the efficiency of recombination. Thus, nucleic acid molecules and methods of the invention include those comprising or employing one, two, three, four, five, six, eight, ten, or more recombination sites which affect recombination specificity, particularly one or more (e.g., one, two, three, four, five, six, eight, ten, twenty, thirty, forty, fifty, etc.) different recombination sites that may correspond substantially to the seven base pair overlap within the 15 base pair core region, having one or more mutations that affect recombination specificity. Particularly preferred such molecules may comprise a consensus sequence such as NNNATAC wherein “N” refers to any nucleotide (i.e., may be A, G, T/U or C). Preferably, if one of the first three nucleotides in the consensus sequence is a T/U, then at least one of the other two of the first three nucleotides is not a T/U.

The core sequence of each att site (attB, attP, attL and attR) can be divided into functional units consisting of integrase binding sites, integrase cleavage sites and sequences that determine specificity. Specificity determinants are defined by the first three positions following the integrase top strand cleavage site. These three positions are shown with underlining in the following reference sequence: CAACTTTTTTATAC AAAGTTG (SEQ ID NO:2). Modification of these three positions (64 possible combinations) can be used to generate att sites that recombine with high specificity with other att sites having the same sequence for the first three nucleotides of the seven base pair overlap region.

Representative examples of seven base pair att site overlap regions suitable for in methods, compositions and vectors of the invention would be apparent to one skilled in the art. The invention further includes nucleic acid molecules comprising one or more (e.g., one, two, three, four, five, six, eight, ten, twenty, thirty, forty, fifty, etc.) nucleotides sequences. Thus, for example, in one aspect, the invention provides nucleic acid molecules comprising the nucleotide sequence GAAATAC, GATATAC, ACAATAC, or TGCATAC.

As noted above, alterations of nucleotides located 3′ to the three base pair region discussed above can also affect recombination specificity. For example, alterations within the last four positions of the seven base pair overlap can also affect recombination specificity.

For example, mutated att sites that may be used in the practice of the present invention include attB1 (AGCCTGCTTT TTTGTACAAA CTTGT (SEQ ID NO:3)), attP1 (TACAGGTCAC TAATACCATC TAAGTAGTTG ATTCATAGTG ACTGGATATG TTGTGTTTTA CAGTATTATG TAGTCTGTTT TTTATGCAAA ATCTAATTTA ATATATTGAT ATTTATATCA TTTTACGTTT CTCGTTCAGC TTTTTTGTAC AAAGTTGGCA TTATAAAAAA GCATTGCTCA TCAATTTGTT GCAACGAACA GGTCACTATC AGTCAAAATA AAATCATTAT TTG (SEQ ID NO:4)), attL1 (CAAATAATGA TTTTATTTTG ACTGATAGTG ACCTGTTCGT TGCAACAAAT TGATAAGCAA TGCTTTTTTA TAATGCCAAC TTTGTACAAA AAAGCAGGCT (SEQ ID NO:5)), and attR1 (ACAAGTTTGT ACAAAAAAGC TGAACGAGAA ACGTAAAATG ATATAAATAT CAATATATTA AATTAGATTT TGCATAAAAA ACAGACTACA TAATACTGTA AAACACAACA TATCCAGTCA CTATG (SEQ ID NO:6)).

Other recombination sites having unique specificity (i.e., a first site will recombine with its corresponding site and will not substantially recombine with a second site having a different specificity) are known to those skilled in the art and may be used to practice the present invention. Corresponding recombination proteins for these systems may be used in accordance with the invention with the indicated recombination sites. Other systems providing recombination sites and recombination proteins for use in the invention include the FLP/FRT system from Saccharomyces cerevisiae, the resolvase family (e.g., .γδ, TndX, TnpX, Tn3 resolvase, Hin, Hjc, Gin, SpCCE1, ParA, and Cin), and IS231 and other Bacillus thuringiensis transposable elements. Other suitable recombination systems for use in the present invention include the XerC and XerD recombinases and the psi, dif and cer recombination sites in E. coli. Other suitable recombination sites may be found in U.S. Pat. No. 5,851,808 issued to Elledge and Liu which is specifically incorporated herein by reference.

The materials and methods of the wet lab validations of in silico vector cloning experiments can further encompass the use of “single use” recombination sites which undergo recombination one time and then either undergo recombination with low frequency (e.g., have at least five fold, at least ten fold, at least fifty fold, at least one hundred fold, or at least one thousand fold lower recombination activity in subsequent recombination reactions) or are essentially incapable of undergo recombination. The invention also provides methods for making and using nucleic acid molecules which contain such single use recombination sites and molecules which contain these sites. Examples of methods which can be used to generate and identify such single use recombination sites are set out in PCT/US00/21623, published as WO 01/11058, which claims priority to U.S. provisional patent application 60/147,892, filed Aug. 9, 1999, both of which are specifically incorporated herein by reference.

Single use recombination sites are especially useful for either decreasing the frequency of or preventing recombination when either large number of nucleic acid segments are attached to each other or multiple recombination reactions are performed. Thus, the invention further includes nucleic acid molecules which contain single use recombination sites, as well as methods for performing recombination using these sites.

Recombination sites used with the invention may also have embedded functions or properties. An embedded functionality is a function or property conferred by a nucleotide sequence in a recombination site that is not directly associated with recombination efficiency or specificity. For example, recombination sites may contain protein coding sequences (e.g., intein coding sequences), intron/exon splice sites, origins of replication, and/or stop codons. Further, recombination sites that have more than one (e.g., two, three, four, five, etc.) embedded functions or properties may also be prepared.

In some instances the in silico experimental design or simulation illustrates removal of either RNA corresponding to recombination sites from RNA transcripts or amino acid residues encoded by recombination sites from polypeptides translated from such RNAs. Removal of such sequences in a wet lab validation can be performed in several ways and can occur at either the RNA or protein level. One instance where it may be advantageous to remove RNA transcribed from a recombination site will be when constructing a fusion polypeptide between a polypeptide of interest and a coding sequence present on the vector. The presence of an intervening recombination site between the ORF of the polypeptide of interest and the vector coding sequences may result in the recombination site (1) contributing codons to the mRNA that result in the inclusion of additional amino acid residues in the expression product, (2) contributing a stop codon to the mRNA that prevents the production of the desired fusion protein, and/or (3) shifting the reading frame of the mRNA such that the two protein are not fused “in-frame.”

In one aspect, the invention provides in silico methods for removing nucleotide sequences encoded by recombination sites from RNA molecules. One example of such a method employs the use of intron/exon splice sites to remove RNA encoded by recombination sites from RNA transcripts. Nucleotide sequences that encode intron/exon splice sites may be fully or partially embedded in the recombination sites used in the present invention and/or may encoded by adjacent nucleic acid sequence. Sequences to be excised from RNA molecules may be flanked by splice sites that are appropriately located in the sequence of interest and/or on the vector. For example, one intron/exon splice site may be encoded by a recombination site and another intron/exon splice site may be encoded by other nucleotide sequences (e.g., nucleic acid sequences of the vector or a nucleic acid of interest). Nucleic acid splicing is well known to those skilled in the art and is discussed in the following publications: R. Reed, Curr. Opin. Genet. Devel. 6:215-220 (1996); S. Mount, Nucl. Acids. Res. 10:459-472, (1982); P. Sharp, Cell 77:805-815, (1994); K. Nelson and M. Green, Genes and Devel. 23:319-329 (1988); and T. Cooper and W. Mattox, Am. J. Hum. Genet. 61:259-266 (1997).

Splice sites can be suitably positioned in a number of locations using the in silico design provided herein to guide wet lab experiments. For example, a vector designed to express an inserted ORF with an N-terminal fusion—for example, with a detectable marker—the first splice site could be encoded by vector sequences located 3′ to the detectable marker coding sequences and the second splice site could be partially embedded in the recombination site that separates the detectable marker coding sequences from the coding sequences of the ORF. Further, the second splice site either could abut the 3′ end of the recombination site or could be positioned a short distance (e.g., 2, 4, 8, 10, 20 nucleotides) 3′ to the recombination site. In addition, depending on the length of the recombination site, the second splice site could be fully embedded in the recombination site.

A modification of the method described above involves the connection of multiple (i.e., two or more) nucleic acid segments such that, upon expression, a fusion protein is produced. In one specific example, one nucleic acid segment encodes a detectable marker—for example, a vector comprising the GFP coding sequence—and another nucleic acid segment encodes an ORF of interest. Each of these segments may contain one or more recombination sites at one or both ends. In addition, the nucleic acid segment that encodes the detectable marker may contain an intron/exon splice site near its 3′ terminus and the nucleic acid segment that contains the ORF of interest may also contain an intron/exon splice site near its 5′ terminus. Upon recombination, the nucleic acid segment that encodes the detectable marker is positioned 5′ to the nucleic acid segment that encodes the ORF of interest. Further, these two nucleic acid segments are separated by a recombination site that is flanked by intron/exon splice sites. Excision of the intervening recombination site thus occurs after transcription of the fusion mRNA. Thus, in one aspect, the invention is directed to methods for removing RNA transcribed from recombination sites from transcripts generated from nucleic acids described herein. In many embodiments, the processed RNA-will encode an ORF of interest which upon expression results in the production of a fusion protein.

Splice sites may be introduced into nucleic acid molecules to be used in the present invention in a variety of ways as provided by in silico design methods provided herein. One method that could be used to introduce intron/exon splice sites into nucleic acid segments is PCR. For example, primers could be used to generate nucleic acid segments corresponding to an ORF of interest and containing both a recombination site and an intron/exon splice site.

The above methods can also be used to remove RNA corresponding to recombination sites when the nucleic acid segment that is recombined with another nucleic acid segment encodes RNA that is not produced in a translatable format. One example of such an instance is where a nucleic acid segment is inserted into a vector in a manner that results in the production of antisense RNA. This antisense RNA may be fused, for example, with RNA that encodes a ribozyme. Thus, the invention also provides methods for removing RNA corresponding to recombination sites from such molecules.

The invention further provides in silico design of methods for removing one or more amino acid sequences from protein expression products by protein splicing. Nucleotide sequences that encode protein splice sites may be fully or partially embedded in the sequence of the protein expression product and/or protein splice sites may be encoded by adjacent nucleotide sequences. In some embodiments, the invention provides methods of removing tag sequences by protein splicing. Suitable splice sites are encoded in the sequence of interest and/or in vector sequences and a tag sequence may be removed by splicing after translation. In some embodiments, the invention provides methods for removing amino acid sequences encoded by functional sequences (e.g., recombination sites) from protein expression products by protein splicing. Nucleotide sequences that encode protein splice sites may be fully or partially embedded in the recombination sites that encode amino acid sequences excised from proteins or protein splice sites may be encoded by adjacent nucleotide sequences. Similarly, one protein splice site may be encoded by a recombination site and another protein splice site may be encoded by other nucleotide sequences (e.g., nucleic acid sequences of the vector or a nucleic acid of interest).

It has been shown that protein splicing can occur by excision of an intein from a protein molecule and ligation of flanking segments (see, e.g., Derbyshire et al., Proc. Natl. Acad. Sci. (USA) 95:1356-1357 (1998)). In brief, inteins are amino acid segments that are post-translationally excised from proteins by a self-catalytic splicing process. A considerable number of intein consensus sequences have been identified (see, e.g., Perler, Nucleic Acids Res. 27:346-347 (1999)). Thus, inteins can be used, for example, to separate tags from proteins encoded by ORFs of interest.

Similar to intron/exon splicing, N- and C-terminal intein motifs have been shown to be involved in protein splicing. Thus, the invention further provides in silico methods for designing compositions and methods for removing one or more amino acid sequences from protein expression products by protein splicing. Nucleotide sequences that encode protein splice sites may be fully or partially embedded in the sequence of the protein expression product and/or protein splice sites may be encoded by adjacent nucleotide sequences. In some embodiments, the invention provides compositions and methods for removing amino acid residues encoded by functional sequences (e.g., recombination sites) from protein expression products by protein splicing. In a particular embodiment, this aspect of the invention is related to the positioning of nucleic acid sequences that encode intein splice sites on both the 5′ and 3′ end of recombination sites positioned between two coding regions. Thus, when the protein expression product is incubated under suitable conditions, amino acid residues encoded by these recombination sites will be excised. In another particular embodiment, this aspect of the invention is related to the positioning of nucleic acid sequences that encode intein splice sites on both the 5′ and 3′ end of amino acid tag sequences, which may be on the N-terminal, C-terminal and/or interior of the expression product. Thus, when the protein expression product is incubated under suitable conditions, amino acid residues of the tag sequence will be excised.

Protein splicing may be used to remove all or part of the amino acid sequences encoded by one or more recombination sites or amino acids sequences of one or more tags. Nucleic acid sequence that encode inteins may be, for example, fully or partially embedded in recombination sites or may adjacent to such sites. In certain circumstances, it may be desirable to remove a considerable number of amino acid residues. For example, an expression product may comprise a tag sequence and amino acids encoded by a recombination site. Such amino acids may extend beyond the N- and/or C-terminal ends of a polypeptide of interest. In such instances, intein coding sequence may be located a distance (e.g., 30, 50, 75, 100, etc. nucleotides) 5′ and/or 3′ of the sequences to be removed (e.g., the sequences encoded by the recombination site and the tag sequence).

While conditions suitable for intein excision will vary with the particular intein, as well as the protein that contains this intein, Chong et al., Gene 192:271-281 (1997), have demonstrated that a modified Saccharomyces cerevisiae intein, referred to as Sce VMA intein, can be induced to undergo self-cleavage by a number of agents including 1,4-dithiothreitol (DTT), β-mercaptoethanol, and cysteine. For example, intein excision/splicing can be induced by incubation in the presence of 30 mM DTT, at 4 .degree. C. for 16 hours.

Polypeptides

In some embodiments, the present invention provides methods wherein a customer is provided a link to purchase a polypeptide(s) that is related to the in silico designed or simulated experiments, or a product thereof. The polypeptide can be expressed from clones containing ORFs. The polypeptides may be expressed as native polypeptides, i.e., without any modifications to the primary sequence. Polypeptides may also be expressed as fusion proteins (e.g., N-terminal and/or C-terminal) and/or may be post-translationally modified (e.g., glycosylated, etc.).

In some embodiments, the polypeptides can be modified to contain a tag (e.g., an affinity tag) in order to facilitate the purification of the polypeptide. Suitable tags are well known to those skilled in the art and include, but are not limited to, repeated sequences of amino acids such as six histidines, epitopes such as the hemagglutinin epitope, the V5 epitope, and the myc epitope, and other amino acid sequences that permit the simplified purification of the polypeptide.

The invention further relates to fusion proteins comprising (1) a polypeptide, or fragment thereof, having one or more desired characteristics and/or activities and (2) a tag (e.g., an affinity tag), as well as nucleic acid molecules and collections of nucleic acid molecules which encode such fusion proteins. In particular embodiments, the invention includes a polypeptide described herein having one or more (e.g., one, two, three, four, five, six, seven, eight, etc.) tags. These tags may be located, for example, (1) at the N-terminus, (2) at the C-terminus, or (3) at both the N-terminus and C-terminus of the protein, or a fragment thereof having one or more desired characteristic and/or activity. A tag may also be located internally (e.g., between regions of amino acid sequence derived from a polypeptide encoded by a cloned ORF). The invention further includes collections of RNA (e.g., mRNA) and polypeptide expression products (e.g., fusion proteins, non-fusion proteins etc.) encoded by clone collections described herein.

Tags used in the invention may vary in length but will typically be from about 5 to about 100, from about 10 to about 100, from about 15 to about 100, from about 20 to about 100, from about 25 to about 100, from about 30 to about 100 from about 35 to about 100, from about 40 to about 100, from about 45 to about 100, from about 50 to about 100, from about 55 to about 100, from about 60 to about 100, from about 65 to about I 00, from about 70 to about 100, from about 75 to about 100, from about 80 to about 100, from about 85 to about 100, from about 90 to about 100, from about 95 to about 100, from about 5 to about 80, from about 10 to about 80, from about 20 to about 80, from about 30 to about 80, from about 40 to about 80, from about 50 to about 80, from about 60 to about 80, from about 70 to about 80, from about 5 to about 60, from about 10 to about 60, from about 20 to about 60, from about 30 to about 60, from about 40 to about 60, from about 50 to about 60, from about 5 to about 40, from about 10 to about 40, from about 20 to about 40, from about 30 to about 40, from about 5 to about 30, from about 10 to about 30, from about 20 to about 30, from about 5 to about 25, from about 10 to about 25, or from about 15 to about 25 amino acid residues in length.

Tags used in the practice of the invention may serve any number of purposes. For example, such tags may (1) contribute to protein-protein interactions both internally within a protein (e.g., between a tag sequence and a polypeptide sequence to which the tag has been attached) and with other protein molecules, (2) make the polypeptide amenable to particular purification methods (e.g., affinity purification), (3) enable one to identify whether the polypeptide is present in a composition (e.g. ELISA, Western blot, etc.), and/or (4) stabilize or destabilize intra-protein interactions with the protein to which the tag has been added (e.g., increase or decrease thermostability of the protein).

Examples of tags which may be used in the practice of the invention include metal binding domains (e.g., a poly-histidine segments such as a three, four, five, six, or seven histidine region), immunoglobulin binding domains (e.g., (1) Protein A; (2) Protein G; (3) T cell, B cell, and/or Fc receptors; and/or (4) complement protein antibody-binding domain); sugar binding domains (e.g., a maltose binding domain); and detectable domains (e.g., at least a portion of β-galactosidase). Fusion proteins may contain one or more tags such as those described above. Typically, fusion proteins that contain more than one tag will contain these tags at one terminus or both termini (i.e., the N-terminus and the C-terminus) of the polypeptide, although one or more tags may be located internally in addition to those present at the termini. Further, more than one tag may be present at one terminus, internally and/or at both termini of the polypeptide. For example, three consecutive tags could be linked end-to-end at the N-terminus of the polypeptide. The invention further includes compositions and reaction mixture that contain the above fusion proteins, as well as methods for preparing these fusion proteins, nucleic acid molecules (e.g., vectors) which encode these fusion proteins and recombinant host cells that contain these nucleic acid molecules. The invention also includes methods for using these fusion proteins as described elsewhere herein.

Tags that assist in identifying whether the fusion protein is present in a composition include, for example, tags that can be used to identify the protein in an electrophoretic gel. A number of such tags are known in the art and include epitopes and antibody binding domains, which can be used for Western blots.

The amino acid composition of the tags for use in the present invention may vary. In some embodiments, a tag may contain from about 1% to about 5% amino acids that have a positive charge at physiological pH, e.g., lysine, arginine, and histidine, or from about 5% to about 10% amino acids that have a positive charge at physiological pH, or from about 10% to about 20% amino acids that have a positive charge at physiological pH, or from about 10% to about 30% amino acids that have a positive charge at physiological pH, or from about 10% to about 50% amino acids that have a positive charge at physiological pH, or from about 10% to about 75% amino acids that have a positive charge at physiological pH. In some embodiments, a tag may contain from about 1% to about 5% amino acids that have a negative charge at physiological pH, e.g., aspartic acid and glutamic acid, or from about 5% to about 10% amino acids that have a negative charge at physiological pH, or from about 10% to about 20% amino acids that have a negative charge at physiological pH, or from about 10% to about 30% amino acids that have a negative charge at physiological pH, or from about 10% to about 50% amino acids that have a negative charge at physiological pH, or from about 10% to about 75% amino acids that have a negative charge at physiological pH. In some embodiments, a tag may comprise a sequence of amino acids that contains two or more contiguous charged amino acids that may be the same or different and may be of the same or different charge. For example, a tag may contain a series (e.g., two, three, four, five, six, ten etc.) of positively charged amino acids that may be the same or different. A tag may contain a series (e.g., two, three, four, five, six, ten etc.) of negatively charged amino acids that may be the same or different. In some embodiments, a tag may contain a series (e.g., two, three, four, five, six, ten etc.) of alternating positively charged and negatively charged amino acids that may be the same or different (eg., positive, negative, positive, negative, etc.). Any of the above-described series of amino acids (e.g., positively charged, negatively charged or alternating charge) may comprise one or more neutral polar or non-polar amino acids (e.g., two, three, four, five, six, ten etc.) spaced between the charged amino acids. Such neutral amino acids may be evenly distributed through out the series of charged amino acids (e.g., charged, neutral, charged, neutral) or may be unevenly distributed throughout the series (e.g., charged, a plurality of neutral, charged, neutral, a plurality of charged, etc.).

In some embodiments, tags to be attached to the polypeptides of the invention may have an overall charge at physiological pH (e.g., positive charge or negative charge). The size of the overall charge may vary, for example, the tag may contain a net plus one, two, three, four, five, etc. or may possess a net negative one, two, three, four, five, etc.

In some embodiments, it may be desirable to remove all or a portion of a tag sequence from a fusion protein comprising a tag sequence and a polypeptide sequence encoded by a cloned ORF of the invention. In embodiments of this type, one or more amino acids forming a cleavage site, e.g., for a protease enzyme, may be incorporated into the primary sequence of the fusion protein. The cleavage site may be located such that cleavage at the site may remove all or a portion of the tag sequence from the fusion protein. In some embodiments, the cleavage site may be located between the tag sequence and the sequence of the polypeptide such that all of the tag sequence is removed by cleavage with a protease enzyme that recognizes the cleavage site. Examples of suitable cleavage sites include, but are not limited to, the Factor 1A cleavage site having the sequence Ile-Glu-Gly-Arg (SEQ ID NO:7), which is recognized and cleaved by blood coagulation factor 1A, and the thrombin cleavage site having the sequence Leu-Val-Pro-Arg (SEQ ID NO:8), which is recognized and cleaved by thrombin. Other suitable cleavage sites are known to those skilled in the art and may be used in conjunction with the present invention.

Polypeptides of the invention may be post-translationally modified, for example, may be glycosylated, acylated, etc. Various eukaryotic expression systems may used to produce glycosylated polypeptides (e.g., baculovirus, vaccinia virus, yeast, etc.). Those skilled in the art will appreciate that the number and character of glycosyl chains that may be added to the polypeptides of the invention by post-translational modification may vary depending upon the expression system used (e.g., expression vector and host cell). The invention thus includes collections of vectors, which allow for the expression of glycosylated polypeptides, as well as vectors (e.g., an entry vector) that can be used to prepare such expression vectors.

Antibodies

In some embodiments, the present invention provides methods wherein a customer is provided a link to purchase an antibody or a series of antibodies, that are related to the in silico designed or simulated experiments, or a product thereof Antibodies may be prepared that are specific to one or more of the polypeptides encoded by the cloned ORFs of a collection. Antibodies may be polyclonal and/or monoclonal. They may be prepared against an entire polypeptide or against a fragment of the polypeptide.

In some instances, antibodies are prepared that recognize all, substantially all, or a representative number of the polypeptides encoded by the ORFs of a collection. In other instances, antibodies may be prepared that are specific to a single polypeptide. In some embodiments, antibodies may be prepared that specifically bind to a subset of the polypeptides encoded by the ORFs of a collection. Thus, the invention also includes collections of antibodies that bind to proteins encoded by one or more ORFs of a collection.

Antibodies may be used for the detection of the polypeptides in an immunoassay, such as ELISA, Western blot, radioimmunoassay, enzyme immunoassay, and may be used in immunocytochemistry. In some embodiments, an anti-polypeptide antibody may be in solution and the polypeptide to be recognized may be in solution (e.g., an immunopreciptitation) or may be on or attached to a solid surface (e.g., a Western blot). In other embodiments, the antibody may be attached to a solid surface and the polypeptide may be in solution (e.g., affinity chromatography).

Antibodies to the polypeptides encoded by the ORFs of a collection may be used to determine the presence, absence or amount of one or more of the polypeptides in a sample (e.g., a patient-derived sample). The amount of specifically bound polypeptide may be determined using an antibody to which is attached a label or other marker, such as a radioactive, a fluorescent, or an enzymatic label. Alternatively, a labeled secondary antibody (e.g., an antibody that recognizes the antibody that is specific to the polypeptide) may be used to detect a polypeptide-antibody complex between the specific antibody and the polypeptide.

Kits

In some embodiments, the present invention provides methods wherein a customer is provided a link to purchase a kit that is related to the in silico designed or simulated experiments, or a product thereof. Kits according to this aspect of the invention may comprise one or more containers, which may contain one or more components selected from the group consisting of one or more nucleic acid molecules (e.g., one or more vectors comprising a selectable marker, one or more vectors comprising one or more recombination sites and/or functional sequences, and the like) and/or clones comprising nucleic acid sequences of interest (e.g., sequences encoding ORFs, RNAi, ribozymes, etc.), one or more primers, one or more polymerases, one or more reverse transcriptases, one or more recombination proteins (or other enzymes for carrying out the methods of the invention), one or more buffers, one or more detergents, one or more restriction endonucleases, one or more nucleotides, one or more terminating agents (e.g., ddNTPs), one or more transfection reagents, pyrophosphatase, and the like. In some embodiments, kits of the invention may comprise a plurality of clones of the invention wherein each clone is in a different container. In some embodiments of this type, a kit may comprise a plurality of clones, each of which is separately contained in a well of a 96-well plate.

A wide variety of nucleic acid molecules and/or clones comprising nucleic acid sequences of interest (e.g., sequences encoding ORFs, RNAi, ribozymes, etc.) can be used with the invention. Further, when nucleic acid sequences of interest are provided with flanking recombination sites, these sequences can be combined with a wide range of other nucleic acid molecules comprising recombination sites (e.g., vectors, genomic DNA, etc) in wide range of ways. Examples of nucleic acid molecules that can be supplied in kits of the invention include those that contain functional sequences such as promoters, signal peptides, enhancers, repressors, selection markers, transcription signals, translation signals, primer hybridization sites (e.g., for sequencing or PCR), recombination sites, restriction sites and polylinkers, sites that suppress the termination of translation in the presence of a suppressor tRNA, suppressor tRNA coding sequences, sequences that encode domains and/or regions (e.g., 6 His tag) for the preparation of fusion proteins, origins of replication, telomeres, centromeres, and the like.

Similarly, collections and/or libraries can be supplied in kits of the invention. These collections and/or libraries may be in the form of replicable nucleic acid molecules or they may comprise nucleic acid molecules that are not associated with an origin of replication. As one skilled in the art would recognize, the-nucleic acid molecules of libraries, as well as other nucleic acid molecules that are not associated with an origin of replication, either could be inserted into other nucleic acid molecules that have an origin of replication or would be an expendable kit components.

Further, in some embodiments, collections and/or libraries supplied in kits of the invention may comprise two components: (1) the nucleic acid molecules of these collections and/or libraries and (2) 5′ and/or 3′ recombination sites and/or topoisomerase recognition sites. In some embodiments, when the nucleic acid molecules of a collection and/or library are supplied with 5′ and/or 3′ recombination sites, it will be possible to insert these molecules into nucleic acid molecules comprising one or more compatible recombination sites, which also may be supplied as a kit component, using recombination reactions. In other embodiments, recombination sites can be attached to the nucleic acid molecules of the collections and/or libraries before use (e.g., by the use of a ligase, which may also be supplied with the kit). In such cases, nucleic acid molecules that contain recombination sites or primers that can be used to generate recombination sites may be supplied with the kits.

Nucleic acid molecules to be supplied in kits of the invention (e.g., vectors, clones comprising ORFs, etc.) can vary greatly. In some instances, these molecules will contain an origin of replication, at least one selectable marker, and at least one recombination site. For example, molecules supplied in kits of the invention can have four separate recombination sites that allow for insertion of sequence of interest at two different locations. Other attributes of vectors supplied in kits of the invention are described elsewhere herein.

In some embodiments, the kits of the invention may comprise a plurality of containers, each container comprising one or more nucleic acid segments comprising a nucleic acid sequence of interest (e.g., sequence encoding an ORF, RNAi, ribozyme, etc.) and/or recombination sites. Segments may be provided with recombination sites such that a series of segments (e.g., two, three, four, five six, seven, eight, nine, ten, etc.) may be combined in order to construct a nucleic acid comprising multiple sequences of interest, which may be the same or different. Segments may be combined in reactions involving two or more segments (e.g., three, four, five, six, seven, eight, nine, ten, etc.). Each segment may be from about 100 bp to about 35 kb in length, or from about 100 bp to about 20 kb in length, or from about 100 bp to about 10 kb in length, or from about 100 bp to about 5 kb in length, or from about 100 bp to about 2.5 kb in length, or from about 100 bp to about 1 kb in length, or from about 100 bp to about 500 bp in length.

A kit of the present invention may comprise a container containing a nucleic acid molecule comprising all or a portion of a nucleic acid sequence of interest (e.g., sequence encoding an ORF, RNAi, ribozyme, etc.) and comprising two recombination sites that do not recombine with each other. The recombination sites may flank a selectable marker that allows selection for or against the presence of the nucleic acid molecule in a host cell or identification of a host cell containing or not containing the nucleic acid. A nucleic acid molecule to be included in a kit may comprise more than two recombination sites, for example, a nucleic acid molecule may comprise multiple pairs of recombination sites (e.g., two, three, four, five, six, seven, eight, nine, ten, etc.) where members of a pair of recombination sites do not recombine or substantially recombine with each other. In some embodiments, members of one pair of recombination sites do not recombine with members of another pair present in the same nucleic acid molecule.

Kits of the invention may comprise containers containing one or more recombination proteins. Suitable recombination proteins have been disclosed above and include, but are not limited to, Cre, Int, IHF, Xis, Flp, Fis, Hin, Gin, Cin, Tn3 resolvase, .PHI.C31, TndX, XerC, and XerD.

Kits of the invention may also comprise one or more topoisomerase proteins and/or one or more nucleic acids comprising one or more topoisomerase recognition sequence. Suitable topoisomerases include Type IA topoisomerases, Type IB topoisomerases and/or Type II topoisomerases. Suitable topoisomerases include, but are not limited to, poxvirus topoisomerases, including vaccinia virus DNA topoisomerase I, E. coli topoisomerase III, E. coli topoisomerase I, topoisomerase III, eukaryotic topoisomerase II, archeal reverse gyrase, yeast topoisomerase III, Drosophila topoisomerase III, human topoisomerase III, Streptococcus pneumoniae topoisomerase III, bacterial gyrase, bacterial DNA topoisomerase IV, eukaryotic DNA topoisomerase II, and T-even phage encoded DNA topoisomerases, and the like. Suitable recognition sequences have been described above.

In use, a nucleic acid molecule comprising all or a portion of a nucleic acid sequence of interest, which may be provided in a kit of the invention, may be combined with a nucleic acid molecule comprising a functional sequence (e.g., using recombinational cloning, topoisomerase-mediated cloning, etc.). The nucleic acid molecule comprising all or a nucleic acid sequence of interest may be provided, for example, with two recombination sites that do not recombine with each other. The nucleic acid molecule comprising a functional sequence may also be provided with two recombination sites, each of which is capable of recombining with one of the two sites present on the a nucleic acid molecule comprising all or a portion of a nucleic acid sequence of interest. In the presence of the appropriate recombination proteins, the nucleic acid molecule comprising a functional sequence recombines the nucleic acid molecule comprising all or a portion of a nucleic acid sequence of interest in order to form a recombinant nucleic acid molecule containing the functional sequence and all or a portion of a nucleic acid sequence of interest. In embodiments of this type, the functional sequence may become operably linked to the nucleic acid sequence of interest as a result of the recombination reaction. When the nucleic acid molecule comprising all or a portion of a nucleic acid sequence of interest comprises multiple pairs of recombination sites, multiple nucleic acid molecules comprising functional sequences and/or other sequences of interest, which may be the same or different, may be combined with the nucleic acid molecule comprising all or a portion of a nucleic acid sequence of interest in order to form a nucleic acid molecule comprising all or a portion of a nucleic acid sequence of interest and also comprising multiple functional sequences and/or multiple sequences of interest. In such embodiments, some or all of the functional sequences and/or other sequences of interest may be operably linked to one or more nucleic acid sequences of interest or portion thereof.

Kits of the invention can also be supplied with primers. These primers will generally be designed to anneal to molecules having specific nucleotide sequences. For example, these primers can be designed for use in PCR to amplify a particular nucleic acid molecule. Further, primers supplied with kits of the invention can be sequencing primers designed to hybridize to vector sequences. Thus, such primers will generally be supplied as part of a kit for sequencing nucleic acid molecules that have been inserted into a vector.

One or more buffers (e.g., one, two, three, four, five, eight, ten, fifteen) may be supplied in kits of the invention. These buffers may be supplied at a working concentrations or may be supplied in concentrated form and then diluted to the working concentrations. These buffers will often contain salt, metal ions, co-factors, metal ion chelating agents, etc. for the enhancement of activities of the stabilization of either the buffer itself or molecules in the buffer. Further, these buffers may be supplied in dried or aqueous forms. When buffers are supplied in a dried form, they will generally be dissolved in water prior to use.

Kits of the invention may contain virtually any combination of the components set out above or described elsewhere herein. As one skilled in the art would recognize, the components supplied with kits of the invention will vary with the intended use for the kits. Thus, kits may be designed to perform various functions set out in this application and the components of such kits will vary accordingly.

Kits of the invention may comprise one or more pages of written instructions for carrying out the methods of the invention. For example, instructions may comprise methods steps necessary to carryout recombinational cloning of an ORF provided with recombination sites and a vector also comprising recombination sites and optionally further comprising one or more functional sequences.

### DETAILED EXEMPLARY SERVICES DESCRIPTION

In some embodiments, the present invention provides methods wherein a customer is provided a link to purchase a service that is related to the in silico designed or simulated experiments, or a product thereof. Exemplary services offered by the provider include clone construction services, protein expression services, antibody production services, library (e.g. cDNA library, genomic library, etc.) construction services, and research and development consulting services. More particularly, for example, a clone (e.g., an entry clone) may be prepared. A clone may comprise a nucleic acid sequence of interest to a customer, which sequence may be optionally flanked by one or more recognition sites (e.g., recombination sites, topoisomerase sites, etc.). Using recombinational cloning, the nucleic acid sequence of interest may be transferred to a plurality of expression vectors and tested in a plurality of expression systems to identify a suitable system or systems. Factors that may be considered in determining the expression system(s) of choice may include amount and/or activity of the polypeptide, cost per unit of polypeptide produced, and/or length of time required to produce a desired amount of polypeptide.

After a suitable expression system has been selected, the present invention also provides the service of producing and purifying the polypeptide of interest. This can be done using techniques known in the art including, but not limited to, chromatography, electrophoresis, differential precipitation and the like.

Purified polypeptide may be used for a variety of purposes. Purified polypeptide may be characterized by any number of methods. For example, crystals may be grown of the polypeptide and the crystal structure determined. This may be useful to identify an active site of a polypeptide, which may then be further used to model compounds to identify those that modulate polypeptide activity. Purified polypeptide may be used directly, for example in assays. Polypeptides also may be used to generate antibodies.

In some embodiments, clones (e.g., entry clones) containing nucleic acid sequences of interest may be further manipulated to produce vectors that may be used in gene targeting applications. For example, an ORF (with or without additional sequences) may be introduced into a cell and/or organism to produce a recombinant cell and/or organism that expresses the polypeptide encoded by the ORF.

Construction of Clones and Clone Collections

Suitable nucleic acid sequences to be cloned and included in a collection may be identified using techniques known in the art. For example, a collection may comprise clones of members of a family of proteins. A collection of clones may comprise nucleic acids that do not encode proteins (e.g., ribozymes, tRNAs, RNAis, etc).

Suitable sequences (e.g., protein-encoding or otherwise) to be included in a collection may be identified by percentage sequence identity with, for example, a reference sequence. For example, a family may be a set of sequences having a sequence that is at least a specified percentage (e.g., 20%, 30%, 40%, 50%, 60%, 70%, 80%, 90%, 95%, etc.) identical to a reference sequence.

By a sequence of interest (e.g., amino acid or nucleotide) at least, for example, 70% “identical” to a reference sequence, it is intended that the sequence of interest is identical to the reference sequence except that the sequence of interest may include up to 30 alterations per each 100 positions (e.g., amino acids or nucleotides) of the reference sequence.

In other words, to obtain a protein having an amino acid sequence at least 70% identical to a reference amino acid sequence, up to 30% of the amino acid residues in the reference sequence may be deleted or substituted with another amino acid, or a number of amino acids up to 30% of the total amino acid residues in the reference sequence may be inserted into the reference sequence. These alterations of the reference sequence may occur at the amino (N-) and/or carboxy (C-) terminal positions of the reference amino acid sequence and/or anywhere between those terminal positions, interspersed either individually among residues in the reference sequence and/or in one or more contiguous groups within the reference sequence. As a practical matter, whether a given amino acid sequence is, for example, at least 70% identical to the amino acid sequence of a reference protein can be determined conventionally using known computer programs such as the CLUSTAL W program (Thompson, J. D., et al., Nucleic Acids Res. 22:4673-4680 (1994)).

To obtain a nucleic acid sequence at least 70% identical to a reference nucleic acid sequence, up to 30% of the nucleotides in the reference sequence may be deleted or substituted with another nucleotide, or a number of nucleotides up to 30% of the total nucleotides in the reference sequence may be inserted into the reference sequence. These alterations of the reference sequence may occur at the 5′-terminal, 3′-terminal and/or anywhere between those terminal positions, interspersed either individually among nucleotides in the reference sequence and/or in one or more contiguous groups within the reference sequence. Percent sequence identity may be determined using a computer program as discussed herein.

Sequence identity may be determined by comparing a reference sequence or a subsequence of the reference sequence to a test sequence. The reference sequence and the test sequence are optimally aligned over an arbitrary number of residues termed a comparison window. In order to obtain optimal alignment, additions or deletions, such as gaps, may be introduced into the test sequence. The percent sequence identity is determined by determining the number of positions at which the same residue is present in both sequences and dividing the number of matching positions by the total length of the sequences in the comparison window and multiplying by 100 to give the percentage. In addition to the number of matching positions, the number and size of gaps is also considered in calculating the percentage sequence identity.

Sequence identity is typically determined using computer programs. A representative program is the BLAST (Basic Local Alignment Search Tool) program publicly accessible at the National Center for Biotechnology Information (NCBI, http://www.ncbi.nlm.nih.gov/). This program compares segments in a test sequence to sequences in a database to determine the statistical significance of the matches, then identifies and reports only those matches that that are more significant than a threshold level. A suitable version of the BLAST program is one that allows gaps, for example, version 2.X (Altschul, et al., Nucleic Acids Res. 25(17):3389-402, 1997). Standard BLAST programs for searching nucleotide sequences (blastn) or protein (blastp) may be used. Translated query searches in which the query sequence is translated, i.e., from nucleotide sequence to protein (blastx) or from protein to nucleic acid sequence (tbblastn) may also be used as well as queries in which a nucleotide query sequence is translated into protein sequences in all 6 reading frames and then compared to an NCBI nucleotide database which has been translated in all six reading frames (tbblastx).

Additional suitable programs for identifying ORFs to be included in a collection of a family of proteins include, but are not limited to, PHI-BLAST (Pattern Hit Initiated BLAST, Zhang, et al., Nucleic Acids Res. 26(17):3986-90, 1998) and PSI-BLAST (Position-Specific Iterated BLAST, Altschul, et al., Nucleic Acids Res. 25(17):3389-402, 1997).

Programs may be used with default searching parameters. Alternatively, one or more search parameter may be adjusted. Selecting suitable search parameter values is within the abilities of one of ordinary skill in the art.

Once a suitable nucleic acid molecule comprising the nucleic acid sequence of interest has been identified, the nucleic acid sequence of interest (e.g., ORF) may be prepared from the nucleic acid molecule. In some embodiments, the sequence of interest may be amplified by PCR using primers constructed to contain a sequence corresponding to all or a portion of a recombination site. After amplification, the amplification product may be contacted with one or more recombination proteins and one or more vectors comprising recombination sites to effect insertion of the amplification product into the vector.

A vector used to prepare a clone of the invention may or may not provide one or more sequences that may be operably linked to the sequence of interest. A sequence of interest (Insert) is cloned into a vector. The vector contains an origin of replication and a selectable marker and does not contain any sequences that are operably linked to the Insert. The sequence of interest can be cloned into a vector containing one or more transcriptional regulatory sequences (e.g., promoters). Such transcriptional regulatory sequences may be operably linked to the sequence of interest (Insert). The promoter can be used to produce RNA corresponding to the sequence of interest, which may or may not be translated into a polypeptide. In certain examples the vector comprises a tag sequence located at the 3′ end of the sequence of interest. The tag sequence is separated from the sequence of interest by a suppressible stop codon. The tag is also followed by a stop codon. Transcription and translation in the absence of a suppressor tRNA results in the expression of a polypeptide having a native C-terminal. Expression of a suppressor tRNA that suppresses the suppressible stop codon results in the expression of a polypeptide containing a C-terminal tag. In another example, the vector contains a promoter followed by a tag sequence and an internal ribosome entry site (IRES) operably linked to a sequence of interest (Insert). Transcription from the promoter and translation of the resultant mRNA results in the production of two different polypeptides. Translation starting at the ATG of the tag sequence results in the production of a polypeptide having an N-terminal fag. Translation starting at an ATG in the context of an IRES results in a polypeptide not containing an N-terminal tag sequence. In yet another example, the vector can contain the promoter, tag, and IRES structure in combination with the suppressible stop codon and tag sequenc. A tag at the N-terminal (Tag1) may be the same or different as a tag at the C-terminal (Tag2). A construct of this sort permits the expression of native polypeptide-when translation is initiated at the IRES and terminated at the suppressible stop codon, an N-terminal tagged protein when translation begins at the ATG of the Tag1 sequence and terminates at the suppressible stop codon, an N- and C-terminal tagged polypeptide when translation begins at the ATG of the Tag1 sequence and termination at the suppressible stop codon is suppressed by the presence of the appropriate suppressor tRNA, and a C-terminal tagged polypeptide when translation is initiated at the IRES and termination at the suppressible stop codon is suppressed by the presence of the appropriate suppressor tRNA. Finally, in another example, the vector provides a tag sequence that may be operably linked to the sequence of interest. In embodiments of this type, the sequence of interest may or may not contain a promoter.

Recognition sites (e.g., recombination sites, topoisomerase recognition sites, restriction enzyme recognition sites, etc.) may be provided at one or both ends of any one or more of the segments of the vectors (e.g., promoter, Insert, Tag1, Tag2, ori, IRES, and/or suppressible stop codon). When more than one recombination sites are provided, they may have the same or different specificities. Vectors used to prepare clones and/or collections of clones may be any vector that can be used for molecular cloning and/or expression, including, but not limited to, plasmids, cosmids, phagemids, BACs, YACS, baculoviruses, adenovirus, and the like

In some embodiments, the present invention provides a link to the service of constructing a clone comprising the entire coding sequence of an open reading frame. A customer may have a portion of a sequence of interest, for example, may have the sequence of a proteolytic fragment of a polypeptide of interest. Using the sequence information provided by the customer, a sequence corresponding to the full-length coding sequence can be obtained and used to construct a clone of the invention.

In some embodiments, the present invention provides the service of constructing a clone comprising a sequence corresponding to the full-length of an mRNA molecule whose sequence is input into the in silico design program. For example, an mRNA molecule may be identified by a customer, for example, by providing a sequence of the polypeptide encoded by the mRNA. Using techniques known in the art, for example, 5′-RACE, a cDNA molecule corresponding to the full-length of the mRNA (including 5′ and/or 3′-un-translated regions) may be obtained and used to construct a clone of the invention. Any method known in the art may be used to construct the full length clones of the invention.

Protein Expression Services

Expression of Polypeptides

In some embodiments, the present invention provides a link to a service of optimizing the expression of a polypeptide for a customer. In addition, the invention contemplates the construction of a panel of expression vectors comprising the ORF of a polypeptide.

To optimize expression of the polypeptides of the present invention, inducible or constitutive promoters may be used to express high levels of a polypeptide in a recombinant host. Similarly, high copy number vectors, well known in the art, may be used to achieve high levels of expression. Vectors having an inducible high copy number may also be useful to enhance expression of the polypeptides of the invention in a recombinant host.

To express the desired polypeptide in a prokaryotic cell (such as, E. coli; B. subtilis, Pseudomonas, etc.), it is necessary to operably link the ORF encoding the polypeptide to a functional prokaryotic promoter. Such promoters may be used to enhance expression and may either be constitutive or regulatable (i.e., inducible or derepressible) promoters. Examples of constitutive promoters include the int promoter of bacteriophage λ, and the bla promoter of the β-lactamase gene of pBR322. Examples of inducible prokaryotic promoters include the major right and left promoters of bacteriophage λ (P_{R} and P_{L}), trp, recA, lacZ, lad, tet, gal, trc, and tac promoters of E. coli. The B. subtilis promoters include α-amylase (Ulmanen, et al., J. Bacteriol 162:176-182 (1985)) and Bacillus bacteriophage promoters (Gryczan, T., In: The Molecular Biology Of Bacilli, Academic Press, New York (1982)). Streptomyces promoters are described by Ward, et al., Mol. Gen. Genet. 203:468478 (1986)). Prokaryotic promoters are also reviewed by Glick, J. Ind. Microbiol. 1:277-282 (1987); Cenatiempto, Y., Biochimie 68:505-516 (1986); and Gottesman, Ann. Rev. Genet. 18:415-442 (1984). Expression in a prokaryotic cell also requires the presence of a ribosomal binding site upstream of the gene-encoding sequence. Such ribosomal binding sites are disclosed, for example, by Gold, et al., Ann. Rev. Microbiol. 35:365404 (1981).

To enhance the expression of polypeptides of the invention in a eukaryotic cell, well known eukaryotic promoters and hosts may be used. Suitable promoters include, for example, the cytomegalovirus promoter, the gal 10 promoter and the Autographa californica multiple nuclear polyhedrosis virus (AcMNPV) polyhedral promoter.

Examples of eukaryotic hosts suitable for use with the present invention include fungal cells (e.g., Saccharomyces cerevisiae cells, Pichia pastoris cells, etc.), plant cells, and animal (e.g., insect and mammalian) cells (e.g., Drosophila melanogaster cells, Spodoptera frugiperda Sf9 and Sf21 cells, Trichoplusa High-Five cells, C. elegans cells, Xenopus laevis cells, CHO cells, COS cells, VERO cells, BHK cells, Hela cells, 293 cells, etc.).

Those skilled in the art will appreciate that each organism has preferred codons for each amino acid. Thus, the present invention contemplates optimizing the codon usage to comport with the host cell type chosen. A nucleic acid encoding the polypeptide of interest can be constructed so as to contain the codons most commonly used by a particular organism in order to optimize the expression of the polypeptide in the particular organism.

A polypeptide encoded by a cloned ORF of the present invention is preferably produced by growth in culture of the recombinant host containing and expressing the desired polypeptide. Fragments of a polypeptide encoded by an ORF of the invention are also included in the present invention. Such fragments include proteolytic fragments and fragments having a desired characteristic and/or activity (e.g., antigenic fragments, enzymatically active fragments, etc.).

Any nutrient that can be assimilated by a host containing a clone comprising an ORF may be added to the culture medium. Optimal culture conditions should be selected case by case according to the strain used and the composition of the culture medium. Antibiotics may also be added to the growth media to insure maintenance of vector DNA containing the desired ORF to be expressed. Media formulations have been described in DSM or ATCC Catalogs and Sambrook et al., In: Molecular Cloning, a Laboratory Manual (2nd ed.), Cold Spring Harbor Laboratory Press, Cold Spring Harbor, N.Y. (1989).

Recombinant host cells producing polypeptide expressed from a cloned ORF of the invention can be separated from liquid culture, for example, by centrifugation. In general, the collected cells (e.g., eukaryotic or prokaryotic) are dispersed in a suitable buffer, and then broken open by well known procedures (e.g., hypotionic lysis, detergent treatment, enzyme treatment, french press, sonication, and the like) to allow extraction of the polypeptide by the buffer solution. After removal of cell debris by ultracentrifugation or centrifugation, the polypeptide can be purified by standard protein purification techniques such as extraction, precipitation, chromatography, affinity chromatography, electrophoresis or the like. Assays to detect the presence of the polypeptide during purification are well known in the art and can be used during conventional biochemical purification methods to determine the presence of the polypeptide.

The invention also provides in certain aspects, links to purchase host cells comprising one or more of the vectors and/or nucleic acids molecules of the invention containing one or more nucleic acids of interest (e.g., two, three, four, five, seven, ten, twelve, fifteen, twenty, thirty, fifty, etc.), particularly those vectors described in detail herein. Representative host cells that may be used according to this aspect of the invention include, but are not limited to, bacterial cells, yeast cells, plant cells and animal cells. Preferred bacterial host cells include Escherichia spp. cells (particularly E. coli cells and most particularly E. coli strains DH10B, Stb12, DH5.a, DB3, DB3.1 (preferably E. coli LIBRARY EFFICIENCY® DB3.1™ Competent Cells; Invitrogen Corp., Carlsbad, Calif.), DB4 and DB5 (see U.S. application Ser. No. 09/518,188, filed on Mar. 2, 2000, and U.S. Provisional Application No. 60/122,392, filed on Mar. 2, 1999, the disclosures of which are incorporated by reference herein in their entireties), Bacillus spp. cells (particularly B. subtilis and B. megaterium cells), Streptomyces spp. cells, Erwinia spp. cells, Klebsiella spp. cells, Serratia spp. cells (particularly S. marcessans cells), Pseudomonas spp. cells (particularly P. aeruginosa cells), and Salmonella spp. cells (particularly S. typhimurium and S. typhi cells). Preferred animal host cells include insect cells (most particularly Drosophila melanogaster cells, Spodoptera frugiperda Sf9 and Sf21 cells and Trichoplusa High-Five cells), nematode cells (particularly C. elegans cells), avian cells, amphibian cells (particularly Xenopus laevis cells), reptilian cells, and mammalian cells (most particularly NIH3T3, 293, CHO, COS, VERO, BHK and human cells). Preferred yeast host cells include Saccharomyces cerevisiae cells and Pichia pastoris cells. These and other suitable host cells are available commercially, for example, from Invitrogen Corp., (Carlsbad, Calif.), American Type Culture Collection (Manassas, Va.), and Agricultural Research Culture Collection (NRRL; Peoria, Ill.).

Methods for introducing the vectors and/or nucleic acids molecules of the invention into the host cells described herein, to produce host cells comprising one or more of the vectors and/or nucleic acids molecules of the invention, will be familiar to those of ordinary skill in the art. For instance, the nucleic acid molecules and/or vectors of the invention may be introduced into host cells using well known techniques of infection, transduction, electroporation, transfection, and transformation. The nucleic acid molecules and/or vectors of the invention may be introduced alone or in conjunction with other nucleic acid molecules and/or vectors and/or proteins, peptides or RNAs. Alternatively, the nucleic acid molecules and/or vectors of the invention may be introduced into host cells as a precipitate, such as a calcium phosphate precipitate, or in a complex with a lipid. Electroporation also may be used to introduce the nucleic acid molecules and/or vectors of the invention into a host. Likewise, such molecules may be introduced into chemically competent cells such as E. coli. If the vector is a virus, it may be packaged in vitro or introduced into a packaging cell and the packaged virus may be transduced into cells. Thus nucleic acid molecules of the invention may contain and/or encode one or more packaging signal (e.g., viral packaging signals that direct the packaging of viral nucleic acid molecules). Hence, a wide variety of techniques suitable for introducing the nucleic acid molecules and/or vectors of the invention into cells in accordance with this aspect of the invention are well known and routine to those of skill in the art. Such techniques are reviewed at length, for example, in Sambrook, J., et al., Molecular Cloning, a Laboratory Manual, 2nd Ed., Cold Spring Harbor, N.Y.: Cold Spring Harbor Laboratory Press, pp. 16.30-16.55 (1989), Watson, J. D., et al., Recombinant DNA, 2nd Ed., New York: W.H. Freeman and Co., pp. 213-234 (1992), and Winnacker, E.-L., From Genes to Clones, New York: VCH Publishers (1987), which are illustrative of the many laboratory manuals that detail these techniques and which are incorporated by reference herein in their entireties for their relevant disclosures.

The present invention also provides in silico design for producing a polypeptide with a tag sequence from the same clone used to produce the un-tagged polypeptide by suppressing one or more stop codons present in the clone. Mutant tRNA molecules that recognize what are ordinarily stop codons suppress the termination of translation of an mRNA molecule and are termed suppressor tRNAs. Three codons are used by both eukaryotes and prokaryotes to signal the end of gene. When transcribed into mRNA, the codons have the following sequences: UAG (amber), UGA (opal) and UAA (ochre). Under most circumstances, the cell does not contain any tRNA molecules that recognize these codons. Thus, when a ribosome translating an mRNA reaches one of these codons, the ribosome stalls and falls off the RNA, terminating translation of the mRNA. The release of the ribosome from the mRNA is mediated by specific factors (see S. Mottagui-Tabar, Nucleic Acids Research 26(11), 2789, 1998). A gene with an in-frame stop codon (TAA, TAG, or TGA) will ordinarily encode a protein with a native carboxy terminus. However, suppressor tRNAs, can result in the insertion of amino acids and continuation of translation past stop codons.

A number of such suppressor tRNAs have been found. Examples include, but are not limited to, the supE, supP, supD, supF and supZ suppressors, which suppress the termination of translation of the amber stop codon, supB, glT, supL, supN, supC and supM suppressors, which suppress the function of the ochre stop codon and glyT, trpT and Su-9 suppressors, which suppress the function of the opal stop codon. In general, suppressor tRNAs contain one or more mutations in the anti-codon loop of the tRNA that allows the tRNA to base pair with a codon that ordinarily functions as a stop codon. The mutant tRNA is charged with its cognate amino acid residue and the cognate amino acid residue is inserted into the translating polypeptide when the stop codon is encountered. For a more detailed discussion of suppressor tRNAs, the reader may consult Eggertsson, et al., (1988) Microbiological Review 52(3):354-374, and Engleerg-Kukla, et al. (1996) in Escherichia coli and Salmonella Cellular and Molecular Biology, Chapter 60, pps 909-921, Neidhardt, et al. eds., ASM Press, Washington, D.C.

Mutations that enhance the efficiency of termination suppressors, i.e., increase the read through of the stop codon, have been identified. These include, but are not limited to, mutations in the uar gene (also known as the prfA gene), mutations in the ups gene, mutations in the sueA, sueB and sueC genes, mutations in the rpsD (ramA) and rpsE (spcA) genes and mutations in the rplL gene. Suppression in some organisms (e.g., E. coli) may be improved when the stop codon is followed immediately by the nucleotide adenosine. Thus, the present invention contemplates nucleic acid sequences comprising stop codons followed by adenosine (e.g., comprising the sequences TAGA, TAAA and/or TGAA).

Under ordinary circumstances, host cells would not be expected to be healthy if suppression of stop codons is too efficient. This is because of the thousands or tens of thousands of genes in a genome, a significant fraction will naturally have one of the three stop codons; complete read-through of these would result in a large number of aberrant proteins containing additional amino acids at their carboxy termini. If some level of suppressing tRNA is present, there is a race between the incorporation of the amino acid and the release of the ribosome. Higher levels of tRNA may lead to more read-through although other factors, such as the codon context, can influence the efficiency of suppression.

Organisms ordinarily have multiple genes for tRNAs. Combined with the redundancy of the genetic code (multiple codons for many of the amino acids), mutation of one tRNA gene to a suppressor tRNA status does not lead to high levels of suppression. The TAA stop codon is the strongest, and most difficult to suppress. The TGA is the weakest, and naturally (in E. coli) leaks to the extent of 3%. The TAG (amber) codon is relatively tight, with a read-through of .about.1% without suppression. In addition, the amber codon can be suppressed with efficiencies on the order of 50% with naturally occurring suppressor mutants.

Suppression has been studied for decades in bacteria and bacteriophages. In addition, suppression is known in yeast, flies, plants and other eukaryotic cells including mammalian cells. For example, Capone, et al. (Molecular and Cellular Biology 6(9):3059-3067, 1986) demonstrated that suppressor tRNAs derived from mammalian tRNAs could be used to suppress a stop codon in mammalian cells. A copy of the E. coli chloramphenicol acetyltransferase (cat) gene having a stop codon in place of the codon for serine 27 was transfected into mammalian cells along with a gene encoding a human serine tRNA that had been mutated to form an amber, ochre, or opal suppressor derivative of the gene. Successful expression of the cat gene was observed. An inducible mammalian amber suppressor has been used to suppress a mutation in the replicase gene of polio virus and cell lines expressing the suppressor were successfully used to propagate the mutated virus (Sedivy, et al., Cell 50: 379-389 (1987)). The context effects on the efficiency of suppression of stop codons by suppressor tRNAs has been shown to be different in mammalian cells as compared to E. coli (Phillips-Jones, et al., Molecular and Cellular Biology 15(12): 6593-6600 (1995), Martin, et al., Biochemical Society Transactions 21: (1993)) Since some human diseases are caused by nonsense mutations in essential genes, the potential of suppression for gene therapy has long been recognized (see Temple, et al., Nature 296(5857):537-40 (1982)). The suppression of single and double nonsense mutations introduced into the diphtheria toxin A-gene has been used as the basis of a binary system for toxin gene therapy (Robinson, et al., Human Gene Therapy 6:137-143 (1995)).

The present invention contemplates in silico design of fusion polypeptides wherein a portion of the fusion protein is translated from an mRNA sequence that is 3′-to at least one stop codon. In general terms, a gene may be expressed in four forms: native at both amino and carboxy termini, modified at either end, or modified at both ends. A construct containing an ORF of interest may include the N-terminal methionine ATG codon, and a stop codon at the carboxy end, of the open reading frame, or ORF, thus ATG-ORF-stop. Frequently, a gene construct will include translation initiation sequences, tis, that may be located upstream of the ATG that allow expression of the ORF, thus tis-ATG-ORF-stop. Constructs of this sort allow expression of a gene as a protein that contains the same amino and carboxy amino acids as in the native, uncloned, protein. When such a construct is fused in-frame with an amino-terminal protein tag, e.g., GST, the tag will have its own tis, thus tis-ATG-tag-tis-ATG-ORF-stop, and the bases comprising the tis of the ORF will be translated into amino acids between the tag and the ORF. In addition, some level of translation initiation may be expected in the interior of the mRNA (i.e., at the ORF's ATG and not the tag's ATG) resulting in a certain amount of native protein expression contaminating the desired protein.

DNA (lower case):
tis1-atg-tag-tis2-atg-orf-stop
RNA (lower case, italics):
tis1-atg-tag-tis2-atg-orf-stop

Protein (upper case): ATG-TAG-TIS2-ATG-ORF (tis1 and stop are not translated)+contaminating ATG-ORF (translation of ORF beginning at tis2).

Using one or more of the cloning techniques described herein (e.g., recombinational cloning, topoisomerase-mediated cloning, etc.) it is a simple matter for those skilled in the art to construct a vector containing a tag adjacent to a recombination site permitting the in frame fusion of a tag to the C- and/or N-terminus of the ORF of interest.

Given the ability to rapidly create a number of clones in a variety of vectors, there is a need in the art to maximize the number of ways a single cloned ORF can be expressed without the need to manipulate the ORF-containing clone itself. The present invention meets this need by providing in silico design of materials and methods for the controlled expression of a C- and/or N-terminal fusion to a target ORF using one or more suppressor tRNAs to suppress the termination of translation at a stop codon. Thus, the present invention provides materials and methods in which an ORF-containing clone is prepared such that the ORF is flanked with recombination sites.

The construct may be prepared with a sequence coding for a stop codon preferably at the C-terminus of the ORF of interest. In some embodiments, a stop codon can be located adjacent to the ORF, for example, within a recombination site flanking the ORF or at or near the 3′ end of the sequence of the ORF before a recombination site. The ORF construct can be transferred through recombination to various vectors that can provide various C-terminal or N-terminal tags (e.g., GFP, GST, His Tag, GUS, etc.) to the ORF of interest. When the stop codon is located at the carboxy terminus of the ORF, expression of the corresponding polypeptide with a “native” carboxy end amino acid sequence occurs under non-suppressing conditions (i.e., when the suppressor tRNA is not expressed) while expression of the polypeptide as a carboxy fusion protein occurs under suppressing conditions. Those skilled in the art will recognize that any suppressors and any stop codons could be used in the practice of the present invention.

In some embodiments, the gene coding for the suppressing tRNA may be incorporated into the vector from which the ORF of interest is to be expressed. In other embodiments, the gene for the suppressor tRNA may be in the genome of the host cell. In still other embodiments, the gene for the suppressor may be located on a separate other vector—i.e., plasmid, cosmid, virus, etc.—and provided in trans.

More than one copy of a gene encoding a suppressor tRNA may be provided in all of the embodiments described herein. For example, a host cell may be provided that contains multiple copies of a gene encoding the suppressor tRNA. Alternatively, multiple gene copies of the suppressor tRNA under the same or different promoters may be provided in the same vector background as the target gene of interest. In some embodiments, multiple copies of a suppressor tRNA may be provided in a different vector than the one containing the target gene of interest. In other embodiments, one or more copies of the suppressor tRNA gene may be provided on the vector containing the ORF of the polypeptide of interest and/or on another vector and/or in the genome of the host cell or in combinations of the above. When more than one copy of a suppressor tRNA gene is provided, the genes may be expressed from the same or different promoters that may be the same or different as the promoter used to express the ORF encoding the polypeptide of interest.

In some embodiments, two or more different suppressor tRNA genes may be provided. In embodiments of this type one or more of the individual suppressors may be provided in multiple copies and the number of copies of a particular suppressor tRNA gene may be the same or different as the number of copies of another suppressor tRNA gene. Each suppressor tRNA gene, independently of any other suppressor tRNA gene, may be provided on the vector used to express the ORF of interest and/or on a different vector and/or in the genome of the host cell. A given tRNA gene may be provided in more than one place in some embodiments. For example, a copy of the suppressor tRNA may be provided on the vector containing the ORF of interest while one or more additional copies may be provided on an additional vector and/or in the genome of the host cell. When more than one copy of a suppressor tRNA gene is provided, the genes may be expressed from the same or different promoters that may be the same or different as the promoter used to express the gene encoding the protein of interest and may be the same or different as a promoter used to express a different tRNA gene.

In some embodiments of the present invention, the ORF of interest and the gene expressing the suppressor tRNA may be controlled by the same promoter. In other embodiments, the ORF of interest may be expressed from a different promoter than the suppressor tRNA. Those skilled in the art will appreciate that, under certain circumstances, it may be desirable to control the expression of the suppressor tRNA and/or the ORF of interest using a regulatable promoter. For example, either the ORF of interest and/or the gene expressing the suppressor tRNA may be controlled by a promoter such as the lac promoter or derivatives thereof such as the tac promoter. In some embodiments, both the ORF of interest and the suppressor tRNA gene are expressed from the T7 RNA polymerase promoter and, optionally, are expressed as part of one RNA molecule. In embodiments of this type, the portion of the RNA corresponding to the suppressor tRNA is processed from the originally transcribed RNA molecule by cellular factors.

In some embodiments, the expression of the suppressor tRNA gene may be under the control of a different promoter from that of the ORF of interest. In some embodiments, it may be possible to express the suppressor gene before the expression of the ORF. This would allow levels of suppressor to build up to a high level, before they are needed to allow expression of a fusion protein by suppression of a the stop codon. For example, in embodiments of the invention where the suppressor gene is controlled by a promoter inducible with IPTG, the ORF may be controlled by the T7 RNA polymerase promoter and the expression of the T7 RNA polymerase may controlled by a promoter inducible with an inducing signal other than IPTG, e.g., NaCl, one could turn on expression of the suppressor tRNA gene with IPTG prior to the induction of the T7 RNA polymerase gene and subsequent expression of the ORF of interest. In some embodiments, the expression of the suppressor tRNA might be induced about 15 minutes to about one hour before the induction of the T7 RNA polymerase gene. In one embodiment, the expression of the suppressor tRNA may be induced from about 15 minutes to about 30 minutes before induction of the T7 RNA polymerase gene. In some embodiments, the expression of the T7 RNA polymerase gene is under the control of an inducible promoter.

In additional embodiments, the expression of the ORF of interest and the suppressor tRNA can be arranged in the form of a feedback loop. For example, the ORF of interest may be placed under the control of the T7 RNA polymerase promoter while the suppressor gene is under the control of both the T7 promoter and the lac promoter. The T7 RNA polymerase gene itself is also under the control of both the T7 promoter and the lac promoter. In addition, the T7 RNA polymerase gene has an amber stop mutation replacing a normal tyrosine codon, e.g., the 28th codon (out of 883). No active T7 RNA polymerase can be made before levels of suppressor are high enough to give significant suppression. Then expression of the polymerase rapidly rises, because the T7 polymerase expresses the suppressor gene as well as itself. In other preferred embodiments, only the suppressor gene is expressed from the T7 RNA polymerase promoter. Embodiments of this type would give a high level of suppressor without producing an excess amount of T7 RNA polymerase. In other preferred embodiments, the T7 RNA polymerase gene has more than one amber stop mutation. This will require higher levels of suppressor before active T7 RNA polymerase is produced.

In some embodiments of the present invention it may be desirable to have more than one stop codon suppressible by more than one suppressor tRNA. A recombinant vector may be constructed so as to permit the regulatable expression of N- and/or C-terminal fusions of a polypeptide expressed from an ORF of interest from the same construct. A vector may comprise a first tag sequence expressed from a promoter and may include a first stop codon in the same reading frame as the tag. The stop codon may be located anywhere in the tag sequence and is preferably located at or near the C-terminal of the tag sequence. The stop codon may also be located in a recombination site or in an internal ribosome entry sequence (IRES). The vector may also include an ORF of interest that includes a second stop codon. The first tag and the ORF of interest are preferably in the same reading frame although inclusion of a sequence that causes frame shifting to bring the first tag into the same reading frame as the ORF of interest is within the scope of the present invention. The second stop codon is preferably in the same reading frame as the ORF of interest and is preferably located at or near the end of the coding sequence of the ORF. The second stop codon may optionally be located within a recombination site located 3′ to the ORF of interest. The construct may also include a second tag sequence in the same reading frame as the ORF of interest and the second tag sequence may optionally include a third stop codon in the same reading frame as the second tag. A transcription terminator and/or a polyadenylation sequence may be included in the construct after the coding sequence of the second tag. The first, second and third stop codons may be the same or different. In some embodiments, all three stop codons are different. In embodiments where the first and the second stop codons are different, the same construct may be, used to express an N-terminal fusion, a C-terminal fusion and the native protein by varying the expression of the appropriate suppressor tRNA. For example, to express the native protein, no suppressor tRNAs are expressed and protein translation is controlled by an appropriately located IRES. When an N-terminal fusion is desired, a suppressor tRNA that suppresses the first stop codon is expressed while a suppressor tRNA that suppresses the second stop codon is expressed in order to produce a C-terminal fusion. In some instances it may be desirable to express a doubly tagged protein of interest in which case suppressor tRNAs that suppress both the first and the second stop codons may be expressed.

Antibody Production Services

One or more of the polypeptides encoded by the ORFs of a collection may be used as immunogens to prepare polyclonal an/or monoclonal antibodies capable of binding the polypeptides using techniques well known in the art (Harlow & Lane, Antibodies: A Laboratory Manual, Cold Spring Harbor Laboratory, Cold Spring Harbor, N.Y., 1988). In brief, antibodies are prepared by immunization of suitable subjects (e.g., mice, rats, rabbits, goats, etc.) with all or a part of the polypeptides of the invention. If the polypeptide or fragment thereof is sufficiently immunogenic, it may be used to immunize the subject. If necessary or desired to increase immunogenicity, the polypeptide or fragment may be conjugated to a suitable carrier molecule (e.g., BSA, KLH, and the like). Polypeptides of the invention or fragments thereof may be conjugated to carriers using techniques well known in the art. For example, they may be directly conjugated to a carrier using, for example, carbodiimide reagents. Other suitable linking reagents are commercially available from, for example, Pierce Chemical Co., Rockford, Ill.

Suitably prepared polypeptides of the invention or fragments thereof may be administered by injection over a suitable time period. They may be administered with or without the use of an adjuvant (e.g., Freunds). They may be administered one or more times until antibody titers reach a desired level.

In some embodiments, it may be desirable to produce monoclonal antibodies to the polypeptides of the invention or fragments thereof. Immortalized cell lines that produce the desired monoclonal antibodies may be prepared using the standard method of Kohler and Milstein or other techniques well known in the art. Cells producing the desired monoclonal antibody can be cultured either in vitro or by production in ascites fluid.

In some embodiments, it may be desirable to use a fragment of an antibody that is capable of binding a polypeptide of the invention or fragment thereof. For example, Fab, Fab′, of F(ab′).sub.2 fragments may be produced using techniques well known in the art.

Construction of cDNA Libraries

In some embodiments, the present invention provides a link to the service of preparing cDNA molecules and cDNA libraries for a customer. Such cDNAs and cDNA libraries may be prepared for any cell or tissue source.

In accordance with the invention, cDNA molecules (single-stranded or double-stranded) may be prepared from a variety of nucleic acid template molecules. Preferred nucleic acid molecules for use in the present invention include single-stranded or double-stranded DNA and RNA molecules, as well as double-stranded DNA:RNA hybrids. More preferred nucleic acid molecules include messenger RNA (mRNA), transfer RNA (tRNA) and ribosomal RNA (rRNA) molecules, although mRNA molecules are the preferred template according to the invention.

The nucleic acid molecules that are used to prepare cDNA molecules according to the methods of the present invention may be prepared synthetically according to standard organic chemical synthesis methods that will be familiar to one of ordinary skill More preferably, the nucleic acid molecules may be obtained from natural sources, such as a variety of cells, tissues, organs or organisms. Cells that may be used as sources of nucleic acid molecules may be prokaryotic (bacterial cells, including but not limited to those of species of the genera Escherichia, Bacillus, Serratia, Salmonella, Staphylococcus, Streptococcus, Clostridium, Chlamydia, Neisseria, Treponema, Mycoplasma, Borrelia, Legionella, Pseudomonas, Mycobacterium, Helicobacter, Erwinia, Agrobacterium, Rhizobium, Xanthomonas and Streptomyces) or eukaryotic (including fungi (especially yeasts), plants, protozoans and other parasites, and animals including insects (particularly Drosophila spp. cells), nematodes (particularly Caenorhabditis elegans cells), and mammals (particularly human cells)).

Mammalian somatic cells that may be used as sources of nucleic acids include blood cells (reticulocytes and leukocytes), endothelial cells, epithelial cells, neuronal cells (from the central or peripheral nervous systems), muscle cells (including myocytes and myoblasts from skeletal, smooth or cardiac muscle), connective tissue cells (including fibroblasts, adipocytes, chondrocytes, chondroblasts, osteocytes and osteoblasts) and other stromal cells (e.g., macrophages, dendritic cells, Schwann cells). Mammalian germ cells (spermatocytes and oocytes) may also be used as sources of nucleic acids for use in the invention, as may the progenitors, precursors and stem cells that give rise to the above somatic and germ cells. Also suitable for use as nucleic acid sources are mammalian tissues or organs such as those derived from brain, kidney, liver, pancreas, blood, bone marrow, muscle, nervous, skin, genitourinary, circulatory, lymphoid, gastrointestinal and connective tissue sources, as well as those derived from a mammalian (including human) embryo or fetus.

Any of the above prokaryotic or eukaryotic cells, tissues and organs may be normal, diseased, transformed, established, progenitors, precursors, fetal or embryonic. Diseased cells may, for example, include those involved in infectious diseases (caused by bacteria, fungi or yeast, viruses (including AIDS, HIV, HTLV, herpes, hepatitis and the like) or parasites), in genetic or biochemical pathologies (e.g., cystic fibrosis, hemophilia, Alzheimer's disease, muscular dystrophy or multiple sclerosis) or in cancerous processes. Transformed or established animal cell lines may include, for example, COS cells, CHO cells, VERO cells, BHK cells, HeLa cells, HepG2 cells, K562 cells, 293 cells, L929 cells, F9 cells, and the like. Other cells, cell lines, tissues, organs and organisms suitable as sources of nucleic acids for use in the present invention will be apparent to one of ordinary skill in the art.

Once the starting cells, tissues, organs or other samples are obtained, nucleic acid molecules (such as mRNA) may be isolated therefrom by methods that are well-known in the art (See, e.g., Maniatis, T., et al., Cell 15:687-701 (1978); Okayama, H., and Berg, P., Mol. Cell. Biol. 2:161-170 (1982); Gubler, U., and Hoffinan, B. J., Gene 25:263-269 (1983)). The nucleic acid molecules thus isolated may then be used to prepare cDNA molecules and cDNA libraries in accordance with the present invention.

In the practice of the invention, cDNA molecules or cDNA libraries are produced by mixing one or more nucleic acid molecules obtained as described above, which is preferably one or more mRNA molecules such as a population of mRNA molecules, with a reverse transcriptase and/or a DNA polymerase under conditions favoring the reverse transcription of the nucleic acid molecule to form a cDNA molecule (single-stranded or double-stranded). Methods of preparing cDNA and cDNA libraries are well known in the art (see, e.g., Gubler, U., and Hoffman, B. J., Gene 25:263-269 (1983); Krug, M. S., and Berger, S. L., Meth. Enzymol. 152:316-325 (1987); Sambrook, J., et al., Molecular Cloning: A Laboratory Manual, 2nd ed., Cold Spring Harbor, N.Y.: Cold Spring Harbor Laboratory Press, pp. 8.60-8.63 (1989); WO 99/15702; WO 98/47912; and WO 98/51699). Other methods of cDNA synthesis which may advantageously use the present invention will be readily apparent to one of ordinary skill in the art.

Methods for generating full-length cDNA molecules are known in the art. For example, U.S. Pat. No. 6,197,554 issued to Lin, et al., discloses a method for preparing a full-length cDNA library from a single cell or a small number of cells suing repeated reverse transcription and amplification steps. U.S. Pat. No. 6,187,544, issued to Bergsma, et al., discloses a method for high throughput cloning of full length cDNA sequences using a plurality of clone arrays prepared from cDNA libraries which have been preferably enriched for 5′ mRNA sequences and size fractionated into several discrete ranges (sub-libraries). U.S. Pat. No. 6,174,669, issued to Hayashizaki, et al., relates to a method for making full-length cDNAs having a length corresponding to full-length mRNAs by binding a tag molecule to a diol structure present in the cap of mRNAs, reverse transcribing the mRNA to make a RNA-DNA hybrid and isolating the RNA-DNA hybrids using the tag molecule.

In some embodiments, the libraries constructed according to the present invention may be normalized. As discussed above, a normalized library is one that has been constructed so as to reduce the relative variation in abundance among member nucleic acid molecules in the library. In brief, a library may be normalized by reducing the abundance of molecules that are represented at a high level in the library.

The present invention encompasses methods of preparing normalized libraries and the normalized libraries (i.e., libraries of cloned nucleic acid molecules from which each member nucleic acid molecule can be isolated with approximately equivalent probability) prepared by such methods, clones comprising such members of such libraries, and compositions comprising such clones and/or libraries.

A normalized library may be produced by synthesizing one or more nucleic acid molecules complementary to all or a portion of the nucleic acid molecules of the library, wherein the synthesized nucleic acid molecules comprise at least one ha pten, thereby producing haptenylated nucleic acid molecules (which may be RNA molecules or DNA molecules); incubating a nucleic acid library to be normalized with the haptenylated nucleic acid molecules (e.g. also referred to as driver) under conditions favoring the hybridization of the more highly abundant molecules of the library with the haptenylated nucleic acid molecules; and removing the hybridized molecules, thereby producing a normalized library.

In some embodiments, the relative concentration of all members of the normalized library are within one to two orders of magnitude. In another aspect, contaminating nucleic acid molecules (e.g., vectors without inserts) are removed from the normalized library. In this manner, all or a substantial portion of the normalized library will comprise vectors containing inserted nucleic acid molecules of the library.

In some embodiments, a population of mRNA is incubated under conditions sufficient to produce a population of cDNA molecules complementary to all or a portion of said mRNA molecules. Conditions may comprise mixing the population of mRNA molecules with one or more polypeptides having reverse transcriptase activity and incubating the mixture under conditions sufficient to produce a population of single stranded cDNA molecules complementary to all or a portion of the mRNA molecules. The single stranded cDNA molecules may then be used to make double stranded cDNA molecules by incubating the mixture under appropriate conditions in the presence of one or more DNA polymerases. The resulting population of double-stranded or single-stranded cDNA molecules makes up a library that may be normalized using the methods of the invention. Such cDNA libraries may be inserted into one or more vectors prior to normalization. Alternatively, the cDNA libraries may be normalized prior to insertion within one or more vectors, and after normalization may be cloned into one or more vectors.

The library to be normalized may be contained in (inserted in) one or more vectors, which may be a plasmid, a cosmid, a phagemid, a virus and the like. Such vectors preferably comprise one or more promoters that allow the synthesis of at least one RNA molecule from all or a portion of the nucleic acid molecules (preferably cDNA molecules) inserted in the vector. Thus, by use of the promoters, haptenylated RNA molecules complementary to all or a portion of the nucleic acid molecules of the library may be made and used to normalize the library in accordance with the invention. Such synthesized RNA molecules (which have been haptenylated) will be complementary to all or a portion of the vector inserts of the library. More highly abundant molecules in the library may then be preferentially removed by hybridizing the haptenylated RNA molecules to the library, thereby producing the normalized library of the invention. Without being limited, the synthesized RNA molecules are thought to be representative of-the library; that is, more highly abundant species in the library result in more highly abundant haptenylated RNA using the above method. The relative abundance of the molecules within the library, and therefore, within the haptenylated RNA determines the rate of removal of particular species of the library; if a particular species abundance is high, such highly abundant species will be removed more readily while low abundant species will be removed less readily from the population. Normalization by this process thus allows one to substantially equalize the level of each species within the library.

In another aspect of the invention, the library to be normalized need not be inserted in one or more vectors prior to normalization. In such aspect of the invention, the nucleic acid molecules of the library may be used to synthesize haptenylated nucleic acid molecules using well known techniques. For example, haptenylated nucleic acid molecules may be synthesized in the presence of one or more DNA polymerases, one or more appropriate primers or probes and one or more nucleotides (the nucleotides and/or primers or probes may be haptenylated). In this manner, haptenylated DNA molecules will be produced and may be used to normalized the library in accordance with the invention. Alternatively, one or more promoters may be added to (e.g., ligated, attached using topoisomerase, attached via recombination, etc) the library molecules, thereby allowing synthesis of haptenylated RNA molecules for use to normalize the library in accordance with the invention. For example, adapters containing one or more promoters may be added to one or more ends of double stranded library molecules (e.g., cDNA library prepared from a population of mRNA molecules). Such promoters may then be used to prepare haptenylated RNA molecules complementary to all or a portion of the nucleic acid molecules of the library. In accordance with the invention, the library may then be normalized and, if desired, inserted into one or more vectors.

While haptenylated RNA is preferably used to normalize libraries, other haptenylated nucleic acid molecules may be used in accordance with the invention. For example, haptenylated DNA may be synthesized from the library and used in accordance with the invention.

Haptens suitable for use in the methods of the invention include, but are not limited to, avidin, streptavidin, protein A, protein G, a cell-surface Fc receptor, an antibody-specific antigen, an enzyme-specific substrate, polymyxin B, endotoxin-neutralizing protein (ENP), Fe+++, a transferrin receptor, an insulin receptor, a cytokine receptor, CD4, spectrin, fodrin, ICAM-1, ICAM-2, C3bi, fibrinogen, Factor X, ankyrin, an integrin, vitronectin, fibronectin, collagen, laminin, glycophorin, Mac-1, LFA-1, .beta.-actin, gp120, a cytokine, insulin, ferrotransferrin, apotransferrin, lipopolysaccharide, an enzyme, an antibody, biotin and combinations thereof. A particularly preferred hapten is biotin.

In accordance with the invention, hybridized molecules produced by the above-described methods may be isolated, for example by extraction or by hapten-ligand interactions. Preferably, extraction methods (e.g. using organic solvents) are used. Isolation by hapten-ligand interactions may be accomplished by incubation of the haptenylated molecules with a solid support comprising at least one ligand that binds the hapten. Preferred ligands for use in such isolation methods correspond to the particular hapten used, and include, but are not limited to, biotin, an antibody, an enzyme, lipopolysaccharide, apotransferrin, ferrotransferrin, insulin, a cytokine, gp120, .beta.-actin, LPA-1, Mac-1, glycophorin, laminin, collagen, fibronectin, vitronectin, an integrin, ankyrin, C3bi, fibrinogen, Factor X, ICAM-1, ICAM-2, spectrin, fodrin, CD4, a cytokine receptor, an insulin receptor, a transferrin receptor, Fe+++, polymyxin B, endotoxin-neutralizing protein (ENP), an enzyme-specific substrate, protein A, protein G, a cell-surface Fc receptor, an antibody-specific antigen, avidin, streptavidin or combinations thereof. The solid support used in these isolation methods may be nitrocellulose, diazocellulose, glass, polystyrene, polyvinylchloride, polypropylene, polyethylene, dextran, Sepharose, agar, starch, nylon, a latex bead, a magnetic bead, a paramagnetic bead, a superparamagnetic bead or a microtitre plate. Preferred solid supports are magnetic beads, paramagnetic beads and superparamagnetic beads, and particularly preferred are such beads comprising one or more streptavidin or avidin molecules.

In another aspect of the invention, normalized libraries are subjected to further isolation or selection steps which allow removal of unwanted contamination or background. Such contamination or background may include undesirable nucleic acids. For example, when a library to be normalized is constructed in one or more vectors, a low percentage of vector (without insert) may be present in the library. Upon normalization, such low abundance molecules (e.g. vector background) may become a more significant constituent as a result of the normalization process. That is, the relative level of such low abundance background may be increased as part of the normalization process.

Removal of such contaminating nucleic acids may be accomplished by incubating a normalized library with one or more haptenylated probes which are specific for the nucleic acid molecules of the library (e.g. target specific probes). In principal, removal of contaminating sequences can be accomplished by selecting those nucleic acids having the sequence of interest or by eliminating those molecules that do not contain sequences of interest. In accordance with the invention, removal of contaminating nucleic acid molecules may be performed on any normalized library (whether or not the library is constructed in a vector). Thus, the probes will be designed such that they will not recognize or hybridize to contaminating nucleic acids. Upon hybridization of the haptenylated probe with nucleic acid molecules of the library, the haptenylated probes will bind to and select desired sequences within the normalized library and leave behind contaminating nucleic acid molecules, resulting in a selected normalized library. The selected normalized library may then be isolated. In a preferred aspect, such isolated selected normalized libraries are single-stranded, and may be made double stranded following selection by incubating the single-stranded library under conditions sufficient to render the nucleic acid molecules double-stranded. The double stranded molecules may then be transformed into one or more host cells. Alternatively, the normalized library may be made double stranded using the haptenylated probe or primer (preferably target specific) and then selected by extraction or ligand-hapten interactions. Such selected double stranded molecules may then be transformed into one or more host cells.

In another aspect of the invention, contaminating nucleic acids may be reduced or eliminated by incubating the normalized library in the presence of one or more primers specific for library sequences. This aspect of the invention may comprise incubating the single stranded normalized library with one or more nucleotides (preferably nucleotides which confer nuclease resistance to the synthesized nucleic acid molecules), and one or more polypeptides having polymerase activity, under conditions sufficient to render the nucleic acid molecules double-stranded. The resulting double stranded molecules may then be transformed into one or more host cells. Alternatively, resulting double stranded molecules containing nucleotides which confer nuclease resistance may be digested with such a nuclease and transformed into one or more host cells.

In yet another aspect, the elimination or removal of contaminating nucleic acid may be accomplished prior to normalization of the library, thereby resulting in selected normalized library of the invention. In such a method, the library to be normalized may be subjected to any of the methods described herein to remove unwanted nucleic acid molecules and then the library may then be normalized by the process of the invention to provide for the selected normalized libraries of the invention.

In accordance with the invention, double stranded nucleic acid molecules are preferably made single stranded before hybridization. Thus, the methods of the invention may further comprise treating the above-described double-stranded nucleic acid molecules of the library under conditions sufficient to render the nucleic acid molecules single-stranded. Such conditions may comprise degradation of one strand of the double-stranded nucleic acid molecules (preferably using gene II protein and Exonuclease III), or denaturing the double-stranded nucleic acid molecules using heat, alkali and the like.

The invention also relates to normalized nucleic acid libraries, selected normalized nucleic acid libraries and transformed host cells produced by the above-described methods.

The above-described technique may be used to prepare a normalized library from any organism or tissue source. In some embodiments, normalized libraries may be prepared from tissue of mammalian origin (e.g., human, rat, mouse, dog, etc.). Normalized libraries may be prepared from numerous tissue types from a single organism (e.g., from human heart, lung, liver, kidney, brain, etc.).

An additional service available in the present invention is the normalization of libraries prepared by a customer. For example, a customer may have previously prepared a library from a particular source. The customer may request that the provider prepare a normalized library from the previously prepared library. The provider may prepare the normalized library using the technique described above or any other suitable technique.

Research and Development Consulting.

In some embodiments, the present invention provides the service of analyzing subscriber Research and Development. A provider may provide one or more individuals to a subscriber in order to analyze the methodology used by the subscriber. The individuals may identify portions of the subscriber's Research and Development that might be improved using materials and/or knowledge provided by the provider. For example, a subscriber may, as part of its business, analyze the effects of small molecules on enzymes. The provider may provide improved materials and/or methods to facilitate this type of analysis. For example, the provider may provide improved reaction conditions under which to assay an enzyme of interest. The provider might provide a more suitable assay to assess the effects of the small molecules on enzyme activity than the assay used by the customer.

RNAi

The invention also includes, in part, materials that guide users to materials which may be used for particular applications. In many instances these users will be customers or potential customers seeking information about products and/or services related to particular applications. In specific embodiments, the user is an individual who is seeking materials for use in RNAi mediated processes. Thus, the invention includes, in part, methods for assisting individuals (e.g., customers) in the selection of products or services. The invention thus further includes methods of presenting products or services to individuals. Often, this presentation is done in a manner that allows for the individual to select one or more products or services from one or more groups of products or services. In many instances, the products or services presented to individuals will be presented in a manner that allows for rapid and time effective product or service selection.

Guides of the invention include web pages and other software based presentation media which provide users with information related to materials which may be used for particular application. These guides may be structured in any number of ways but will typically be set up such that information is presented which allows for selection of one or more items for which an individual user desires additional information. In many instances, these guides will be multifuntional in that they allow for the selection of multiple choices of separate groups of items and additional choices of items within those groups.

Guides of the invention may be designed to present information regarding any number of different products or services. In many instances, the products or services will be in the pharmaceutical or biotechnology fields (e.g., genomics, proteomics, drug discovery, genetic testing, etc.). In other instances, guides of the invention will be used to present information in fields unrelated to pharmaceutical or biotechnology fields and include fields such as consumer products and services (e.g., mortgages, credit scores or services, household products, electronics, etc.) or business services (e.g., food services, office supplies, computers, etc.)

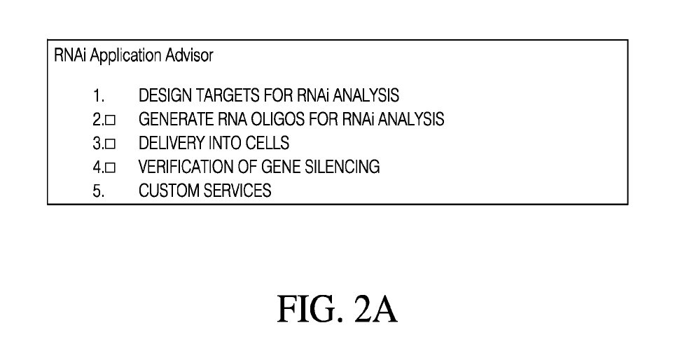

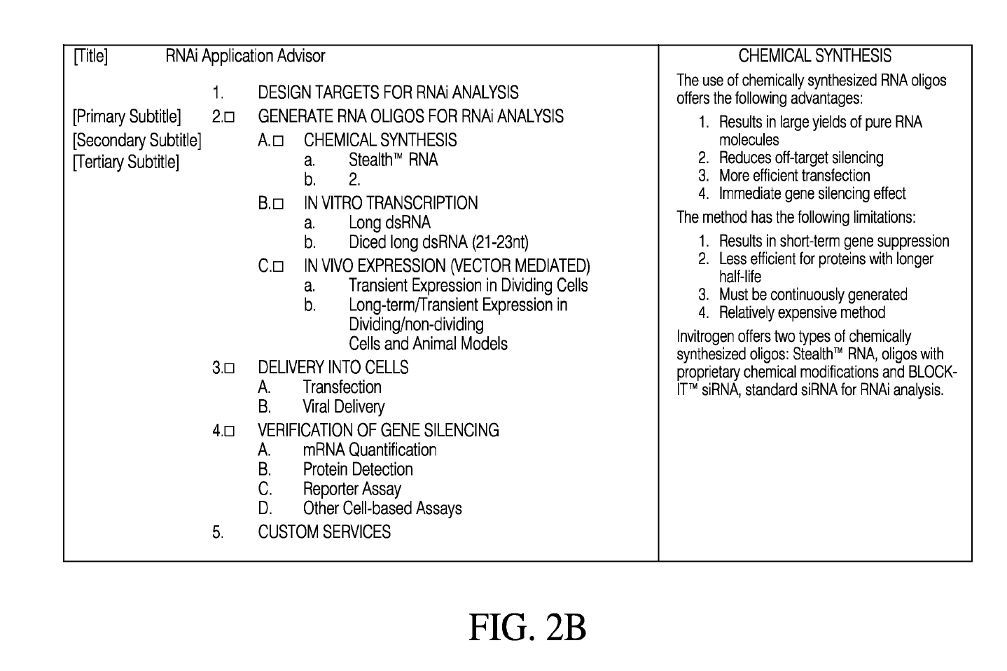

One illustration of the invention is shown in FIG. 2A. This figure shows a title (i.e., “RNAi Application Advisor”) with five separate primary subtitles set out below. Three of the primary subtitles are shown with boxes next to the primary subtitle number. “Clicking” on one of these boxes results in a list of secondary subtitles appearing under the primary subtitle. As an example, when the box next to primary subtitle number 3 is selected, the secondary subtitles “Transfection” and “Viral Delivery” appear. These secondary subtitles are set out in bold and are terminal subtitles.

As used herein, a “terminal subtitle” is a subtitle which cannot be selected to lead to additional subtitles. Any of the titles or subtitles referred to herein may be a terminal subtitle. Examples of terminal subtitles in FIG. 2B are subtitle 1 and tertiary subtitle 2, A, a, entitled “Stealth™ RNA”. Terminal subtitles will often be marked in such as manner to make it apparent that there are no additional subtitles which will be displayed by selection of the terminal subtitle. One method of marking a terminal subtitle is by setting it out in bold text.

There is essentially no limit on the number of subtitle layers which may be provided. Thus, under a title, there may be primary, secondary, tertiary, quaternary, etc. subtitles. The interconnection between title and subtitle layers may be visualized, in appropriate circumstances, like branches of a tree, where under a title there may direct a user to one or more primary subtitles and one or more of the primary subtitles may direct a user to one or more secondary subtitles, and so on.

One or more information sets may be associated with each title and/or subtitle. For example, selection of one portion of a title or subtitle may lead to the presentation of certain information and selection of another portion of the same title may lead to the presentation of different information. Thus, multiple sets of information may be associated with each title and/or subtitle. This is shown in FIG. 2B, where selection of a box results in addition subtitles being displayed and selection of the text of a subtitle results in information related to that subtitle being presented.

Selection of any title or subtitle may lead to the presentation of product related information. Such product information may include one or more of the following: (a) the name of the product, (b) product specifications (e.g., size or amount, a description of components present in the product, etc.), (c) catalog number, (d) price or prices, (e) information on how to order the product, or (f) information on related products.

The right hand side of FIG. 2B shows exemplary information which is presented when a title or subtitle is selected. In this instance, the information is associated with subtitle 2, A entitled “CHEMICAL SYNTHESIS”.

Information provided by guides of the invention may also lead users to (a) links to web sites or web pages or (b) software for performing particular methods or functions.

When a guide leads a user to another web site or web page, the web site or web page may be another guide or may contain web based software which serves a particular method or function. When a guide leads a user to software, whether or not the software is designed to run from a web page, this software may be designed to perform any number of different methods or functions. As an example, the software may be designed to characterize features of an inputted data set. Examples of inputted data sets include nucleotide and amino acid sequences.

Nucleotide and amino acid sequences are data which described nucleic acid and protein molecules. As an example, programs are available which allow for one to characterize physical characteristics of proteins or peptides having particular amino acid sequences. Characteristics of proteins or peptides which may be identified include the location of antigenic regions, proteolytic enzyme or reagent cleavage digest sites, secretory sequences, PEST motifs, nucleic acid binding motifs, helix, regions, turn regions, coil regions, etc. Software for characterizing proteins based upon any number of parameters is available though numerous sources. One example of such a source is located on the World Wide Web at the URL “hgmp.mrc.ac.uk/Software/EMBOSS/Apps/”.

One common protein characterization process results in the identification of antigenic regions. These antigenic regions may then be used to generate antibodies which are predicted to bind to (e.g., bind with high specificity) the protein. Software for such an application is described in Maksyutov and Zagrebelnaya, Comput. Appl. Biosci. 9:291-297. (1993).

An example of software which may be used to characterize nucleic acids is RNAi designer, available on the web site of Invitrogen Corporation, Carlsbad, Calif., at URL https://rnaidesigner.invitrogen.com/sirna/. RNAi designer may be used to identify nucleic acids which knock down expression of a target gene by RNA interference. In order to use RNAi designer, either an NCBI access number or a nucleotide sequence of a target gene is input into a window which is typically on a web page. After a number of other choices are made by the user, the nucleotide sequence is searched to identify suitable regions for which RNAi molecules may be generated. Typically, more than one suitable region is identified and these regions are scored for the probability that the dsRNA designed by the software will knock down expression of the target gene.

When the use of a software leads to the identification of either (a) items which may be used with or (b) sub-components of the molecules described by the input sequence data, users of the software may be directed to selections which allow for the user to purchase the items or molecules corresponding to the sub-components. As an example, when software has be used to identify an antigenic region of a protein, the user may be directed to a selection which allows for an order to be placed for antibodies having binding activity towards the antigenic region. In some instances, the user may order antibodies with binding activity generated in response to a peptide corresponding to the antigenic region or to the entire protein. Further, the user may order a specific type of antibody (e.g., a monoclonal antibody, a polyclonal antibody, a humanized antibody, etc.).

As another example, when software is used to identify regions of a nucleic acid molecule which are predicted to function in RNAi mediated gene knockdown, the user may be directed to a selection which allows for an order to be placed for dsRNA molecules which correspond to one or more identified regions.

When products and/or services are sold to a customer, these products and/or services will often be sold with a guarantee that they will function for the intended purpose or that the service will lead to intended data or products. A guarantee of this type will generally apply to products or services which are designed by or rely upon materials designed by computer software. This is so because molecules designed by according to algorithms to function in a particular way do not always function as predicted. More specifically, in some cases, molecules designed to have particular functional activities either lack one or more desired activity or have lower levels of one or more activity than predicted. In such cases, customers may be assured that either (a) their money will be returned or (b) another molecule will be provided or service performed if the initial software designed molecules do not perform as expected. Thus, this invention includes, in part, methods for selling products and services which are accompanied by a guarantee that the product will function as intended or that the service will provide data which it is intended to provide. Often these products will be products which are custom designed for the customers and these services will employ custom materials which are specifically designed for performing the services.

As noted above, methods and informational products of the invention may be used to present RNA interference products and/or services to customers. One method of silencing genes involves the production of double-stranded RNA (dsRNA) in cells or contact of cell with dsRNA. This silencing, also referred to as knock down of gene expression, is termed RNA interference (RNAi). (See, e.g., Mette et al., EMBO J., 19:5194-5201 (2000)). Web pages of the invention may direct customers to information related to products such as vectors which express dsRNA molecules, dsRNA molecules themsleves, vectors which may be modified by customers to express dsRNA molecules which knock down expression of particular genes, or products for introducing these vector or dsRNA molecules into cells (e.g., transfection reagents).

RNAi is mediated by double-stranded RNA that results in degradation of specific RNA transcription products, and can also be used to lower or eliminate gene expression. These dsRNA molecules may fold back upon themselves to generate a hairpin molecule containing a double-stranded portion. In such instances, one strand of the double-stranded portion may correspond to all or a portion of the sense strand of the RNA transcribed from the gene to be silenced while the other strand of the double-stranded portion may correspond to all or a portion of the antisense strand. These dsRNA molecules may also be composed of two separate strands which hybridize to each other.

In some embodiments, a dsRNA to be used to silence a gene may have one or more regions of homology to a gene to be silenced. Regions of homology may be from about 20 bp to about 100 bp in length, from about 20 bp to about 90 bp in length, from about 20 bp to about 80 bp in length, from about 20 bp to about 70 bp in length, from about 20 bp to about 60 bp in length, from about 20 bp to about 50 bp in length, from about 20 bp to about 40 bp in length, from about 20 bp to about 30 bp in length, from about 20 bp to about 25 bp in length, from about 15 bp to about 25 bp in length, from about 17 bp to about 25 bp in length, from about 19 bp to about 25 bp in length, from about 19 bp to about 23 bp in length, or from about 19 bp to about 21 bp in length.

As discussed above, a hairpin containing molecule having a double-stranded region may be used as RNAi. The length of the double stranded region may be 20 bp to about 750 bp in length, from about 20 bp to about 500 bp in length, 20 bp to about 400 bp in length, 20 bp to about 300 bp in length, 20 bp to about 250 bp in length, from about 20 bp to about 200 bp in length, from about 20 bp to about 150 bp in length, from about 20 bp to about 100 bp in length, 20 bp to about 90 bp in length, 20 bp to about 80 bp in length, 20 bp to about 70 bp in length, 20 bp to about 60 bp in length, 20 bp to about 50 bp in length, 20 bp to about 40 bp in length, 20 bp to about 30 bp in length, or from about 20 bp to about 25 bp in length. The non-base-paired portion of the hairpin (i.e., loop) can be of any length that permits the two regions of homology that make up the double-stranded portion of the hairpin to fold back upon one another.

Any suitable promoter may be used to control the production of RNA. Promoters may be those recognized by any polymerase enzyme. For example, promoters may be promoters for RNA polymerase II or RNA polymerase III (e.g., a U6 promoter, an H1 promoter, etc.). Other suitable promoters include, but are not limited to, T7 promoter, cytomegalovirus (CMV) promoter, mouse mammary tumor virus (MMTV) promoter, metallothionein, RSV (Rous sarcoma virus) long terminal repeat, SV40 promoter, human growth hormone (hGH) promoter. Other suitable promoters are known to those skilled in the art and are within the scope of the present invention. In many instances, when a vector products or other products designed to lead to expression of dsRNA are presented to customers, these products will contain an RNA polymerase III promoter.

In the appropriate circumstances, the invention also relates to methods for (a) providing information about products and services to customers, (b) producing products, (c) shipping products to customers, (d) performing services, (e) sending data and/or materials which result from the performance of services to customers, and (f) collection of money from customers. When more than one item set out above is performed, these items may be performed in any manner. As an example, a customer may order an “on the shelf” product or a custom product. In the first instance, item (b) will often be performed before (a). In the second instance, item (b) will most often be performed after (a). Further, once a customer has ordered a product, it is typically necessary to ensure that the product is sent to the customer and that the product is paid for. Similarly, when a service has been ordered, it is typically necessary to ensure that the services are performed, results of that services are transferred to the customer, and payment related to the performance of the service occurs.

As indicated above, the present invention also provides a system and method of providing company products and services to a party outside of the company, for example, a system and method for providing a customer or a product distributor a product of the company such as a kit containing a double stranded nucleic acid molecule which is capable of inhibiting expression of a gene, an antibody designed in response to a particular antigen, a clone, a primer, etc. Product and services of the invention may further be provided with instructions regarding how to use the products and/or services. FIG. 3 provides a schematic diagram of a product management system. In practice, the blocks in FIG. 3 can represent an intra-company organization, which can include departments in a single building or in different buildings, a computer program or suite of programs maintained by one or more computers, a group of employees, a computer I/O device such as a printer or fax machine, a third party entity or company that is otherwise unaffiliated with the company, or the like.

The product management system as shown in FIG. 3 is exemplified by company 100, which receives input in the form of an order from a party outside of the company, e.g., distributor 150 or customer 140, to order department 126, or in the form of materials and parts 130 from a party outside of the company; and provides output in the form of a product delivered from shipping department 119 to distributor 150 or customer 140. Company 100 system is typically organized to optimize receipt of orders and delivery of a product to a party outside of the company in a cost efficient manner and to obtain payment for such product from the party. The products generated by the product management system may be “on the shelf” products or custom products.

Similar systems to that shown in FIG. 3 may be used for services. When services are provided to customers very often the product will be data derived from the performance of the service. In such a case, customer orders serve as instructions to perform particular services.

With respect to methods of the present invention, the term “materials and parts” refers to items that are used to make a device, other component, or product, which generally is a device, other component, or product that company sells to a party outside of the company. As such, materials and parts include, for example, nucleotides, nucleotides, single stranded or double stranded nucleic acid molecules, host cells, enzymes (e.g., polymerases), amino acids, culture media, buffers, paper, ink, reaction vessels, etc. In comparison, the term “devices”, “other components”, and “products” refer to items sold by the company. Devices are exemplified by nucleic acid molecules that are to be sold by the company, for example, single stranded or double stranded nucleic acid molecules which may or may not contain one or more chemical modifications in one or both strands. Other components are exemplified by instructions, including instructions for determining a ratio of nucleic acid molecules to be combined with cells for optimal inhibition of gene expression according to a method of the invention. Other components also can be items that may be included in a kit, e.g., a kit product containing, for example, single stranded or double stranded nucleic acid molecules or cells of one or more type (e.g., 293 cells, HUVEC cells, etc). As such, it will be recognized that an item useful as materials and parts as defined herein further can be considered an “other component”, which can be sold by the company. The term “products” refers to devices, other components, or combinations thereof, including combinations with additional materials and parts, that are sold or desired to be sold or otherwise provided by a company to one or more parties outside of the company. Products are exemplified herein by kits, which can contain instructions according to the present invention, and single stranded or double stranded nucleic acid molecules, or combinations thereof. In appropriate instances, products may be materials used in services and data supplied to a customer. Data will often be a product when a customer has directed company 100 to perform a service on their behalf.

Referring to FIG. 3, company 100 includes manufacturing 110 and administration 120. Devices 112 and other components 114 are produced in manufacturing 110, and can be stored separately therein such as in device storage 113 and other component storage 115, respectively, or can be further assembled and stored in product storage 117. Materials and parts 130 can be provided to company 100 from an outside source and/or materials and parts 114 can be prepared in company, and used to produce devices 112 and other components 116, which, in turn, can be assembled and sold as a product. Manufacturing 110 also includes shipping department 119, which, upon receiving input as to an order, can obtain products to be shipped from product storage 117 and forward the product to a party outside the company.

For purposes of the present invention, product storage 117 can store instructions, for example, for determining transfection conditions which are suitable for use with a particular cell type or how to design a double stranded nucleic acid molecule which will function for inhibiting gene expression, as well as combinations of such instructions and/or kits. Upon receiving input from order department 126, for example, that customer 140 has ordered such a kit and instructions, shipping department 119 can obtain from product storage 117 such kit for shipping, and can further obtain such instructions in a written form to include with the kit, and ship the kit and instructions to customer 140 (and providing input to billing department 124 that the product was shipped; or shipping department 119 can obtain from product storage 117 the kit for shipping, and can further provide the instructions to customer 140 in an electronic form, by accessing a database in company 100 that contains the instructions, and transmitting the instructions to customer 140 via the internet (not shown).

As further exemplified in FIG. 3, administration 120 includes order department 126, which receives input in the form of an order for a product from customer 140 or distributor 150. Order department 126 then provides output in the form of instructions to shipping department 119 to fill the order, i.e., to forward products as requested to customer 140 or distributor 150. Shipping department 119, in addition to filling the order, further provides input to billing department 124 in the form of confirmation of the products that have been shipped. Billing department 124 then can provide output in the form of a bill to customer 140 or distributor 150 as appropriate, and can further receive input that the bill has been paid, or, if no such input is received, can further provide output to customer 140 or distributor 150 that such payment may be delinquent. Additional optional component of company 100 include customer service department 122, which can receive input from customer 140 and can provide output in the form of feedback or information to customer 140. Furthermore, although not shown in FIG. 3, customer service 122 can receive input or provide output to any other component of company. For example, customer service department 122 can receive input from customer 140 indicating that an ordered product was not received, wherein customer service department 122 can provide output to shipping department 119 and/or order department 126 and/or billing department 124 regarding the missing product, thus providing a means to assure customer 140 satisfaction. Customer service department 122 also can receive input from customer 140 in the form of requested technical information, for example, for confirming that instructions of the invention can be applied to the particular need of customer 140, and can provide output to customer 140 in the form of a response to the requested technical information.

As such, the components of company 100 are suitably configured to communicate with each other to facilitate the transfer of materials and parts, devices, other components, products, and information within company 100, and company 100 is further suitably configured to receive input from or provide output to an outside party. For example, a physical path can be utilized to transfer products from product storage 117 to shipping department 119 upon receiving suitable input from order department 126. Order department 126, in comparison, can be linked electronically with other components within company 100, for example, by a communication network such as an intranet, and can be further configured to receive input, for example, from customer 140 by a telephone network, by mail or other carrier service, or via the internet. For electronic input and/or output, a direct electronic link such as a T1 line or a direct wireless connection also can be established, particularly within company 100 and, if desired, with distributor 150 or materials or parts 130 provider, or the like.

Although not illustrated, company 100 may contain one or more data collection systems, including, for example, a customer data collection system, which can be realized as a personal computer, a computer network, a personal digital assistant (PDA), an audio recording medium, a document in which written entries are made, any suitable device capable of receiving data, or any combination of the foregoing. Data collection systems can be used to gather data associated with a customer 140 or distributor 150, including, for example, a customer's shipping address and billing address, as well as more specific information such as the customer's ordering history and payment history, such data being useful, for example, to determine that a customer has made sufficient purchases to qualify for a discount on one or more future purchases.

Company 100 can utilize a number of software applications to provide components of company 100 with information or to provide a party outside of company access to one or more components of company 100, for example, access to order department 126 or customer service department 122. Such software applications can comprise a communication network such as the Internet, a local area network, or an intranet. For example, in an internet-based application, customer 140 can access a suitable web site and/or a web server that cooperates with order department 126 such that customer 140 can provide input in the f6rm of an order to order department 126. In response, order department 126 can communicate with customer 140 to confirm that the order has been received, and can further communicate with shipping department 119, providing input that products such as a kit of the invention, which contains, for example, a double-stranded nucleic acid molecule and instructions for use, should be shipped to customer 140. In this manner, the business of company 100 can proceed in an efficient manner.

In a networked arrangement, billing department 124 and shipping department 119, for example, can communicate with one another by way of respective computer systems. As used herein, the term “computer system” refers to general purpose computer systems such as network servers, laptop systems, desktop systems, handheld systems, personal digital assistants, computing kiosks, and the like. Similarly, in accordance with known techniques, distributor 150 can access a web site maintained by company 100 after establishing an online connection to the network, particularly to order department 126, and can provide input in the form of an order. If desired, a hard copy of an order placed with order department 126 can be printed from the web browser application resident at distributor 150.

The various software modules associated with the implementation of the present invention can be suitably loaded into the computer systems resident at company 100 and any party outside of company 100 as desired, or the software code can be stored on a computer-readable medium such as a floppy disk, magnetic tape, or an optical disk. In an online implementation, a server and web site maintained by company 100 can be configured to provide software downloads to remote users such as distributor 150, materials and parts 130, and the like. When implemented in software, the techniques of the present invention are carried out by code segments and instructions associated with the various process tasks described herein.

Accordingly, the present invention further includes methods for providing various aspects of a product (e.g., a kit and/or instructions of the invention), as well as information regarding various aspects of the invention, to parties such as the parties shown as customer 140 and distributor 150 in FIG. 3. Thus, methods for selling devices, products and methods of the invention to such parties are provided, as are methods related to those sales, including customer support, billing, product inventory management within the company, etc. Examples of such methods are shown in FIG. 3, including, for example, wherein materials and parts 130 can be acquired from a source outside of company 100 (e.g., a supplier) and used to prepare devices (e.g., double-stranded nucleic acid molecules) used in preparing a composition or practicing a method of the invention, for example, kits, which can be maintained as an inventory in product storage 117. It should be recognized that devices 112 can be sold directly to a customer and/or distributor (not shown), or can be combined with one or more other components 116, and sold to a customer and/or distributor as the combined product. The other components 116 can be obtained from a source outside of company 100 (materials and parts 130) or can be prepared within company 100 (materials and parts 114). As such, the term “product” is used generally herein to refer an item sent to a party outside of the company (a customer, a distributor, etc.) and includes items such as devices 112, which can be sent to a party alone or as a component of a kit or the like.

At the appropriate time, the product is removed from product storage 117, for example, by shipping department 119, and sent to a requesting party such as customer 140 or distributor 150. Typically, such shipping occurs in response to the party placing an order, which is then forwarded the within the organization as exemplified in FIG. 3, and results in the ordered product being sent to the party. Data regarding shipment of the product to the party may be transmitted further within the organization, for example, from shipping department 119 to billing department 124, which, in turn, can transmit a bill to the party, either with the product, or at a time after the product has been sent. Further, a bill can be sent in instances where the party has not paid for the product shipped within a certain period of time (e.g., within 30 days, within 45 days, within 60 days, within 90 days, within 120 days, within from 30 days to 120 days, within from 45 days to 120 days, within from 60 days to 120 days, within from 90 days to 120 days, within from 30 days to 90 days, within from 30 days to 60 days, within from 30 days to 45 days, within from 60 days to 90 days, etc.). Typically, billing department 124 also is responsible for processing payment(s) made by the party. It will be recognized that variations from the exemplified method can be utilized; for example, customer service department 122 can receive an order from the party, and transmit the order to shipping department 119 (not shown), thus serving the functions exemplified in FIG. 3 by order department 126 and the customer service department 122.

Methods of the invention also include providing technical service to parties using a product, particularly a kit of the invention. While such a function can be performed by individuals involved in product research and development, inquiries related to technical service generally are handled, routed, and/or directed by an administrative department of the organization (e.g., customer service department 122). Often communications related to technical service (e.g., solving problems related to use of the product or individual components of the product) require a two way exchange of information, as exemplified by arrows indicating pathways of communication between customer 150 and customer service department 122.

Any number of variations of the process exemplified in FIG. 3 are possible and within the scope of the invention. Accordingly, the invention includes methods (e.g., business methods) that involve (1) the production of products (e.g., antibodies, clones, proteins such as enzymes, vectors, dyes, buffers, salts, double-stranded nucleic acid molecules, transfection reagents, kits that contain instructions for performing methods of the invention, etc.); (2) receiving orders for these products; (3) sending the products to parties placing such orders; (4) sending bills to parties obliged to pay for products sent to such; and/or (5) receiving payment for products sent to parties. For example, methods are provided that comprise two or more of the following steps: (a) obtaining parts, materials, and/or components from a supplier; (b) preparing one or more first products (e.g., one or more double-stranded nucleic acid molecules); (c) storing the one or more first products of step (b); (d) combining the one or more first products of step (b) with one or more other components to form one or more second products (e.g., a kit); (e) storing the one or more first products of step (b) or one or more second products of step (d); (f) obtaining an order a first product of step (b) or a second product of step (d); (g) shipping either the first product of step (b) or the second product of step (d) to the party that placed the order of step (f); (h) tracking data regarding to the amount of money owed by the party to which the product is shipped in step (g); (i) sending a bill to the party to which the product is shipped in step (g); (j) obtaining payment for the product shipped in step (g) (generally, but not necessarily, the payment is made by the party to which the product was shipped in step (g); and (k) exchanging technical information between the organization and a party in possession of a product shipped in step (d) (typically, the party to which the product was shipped in step (g)).

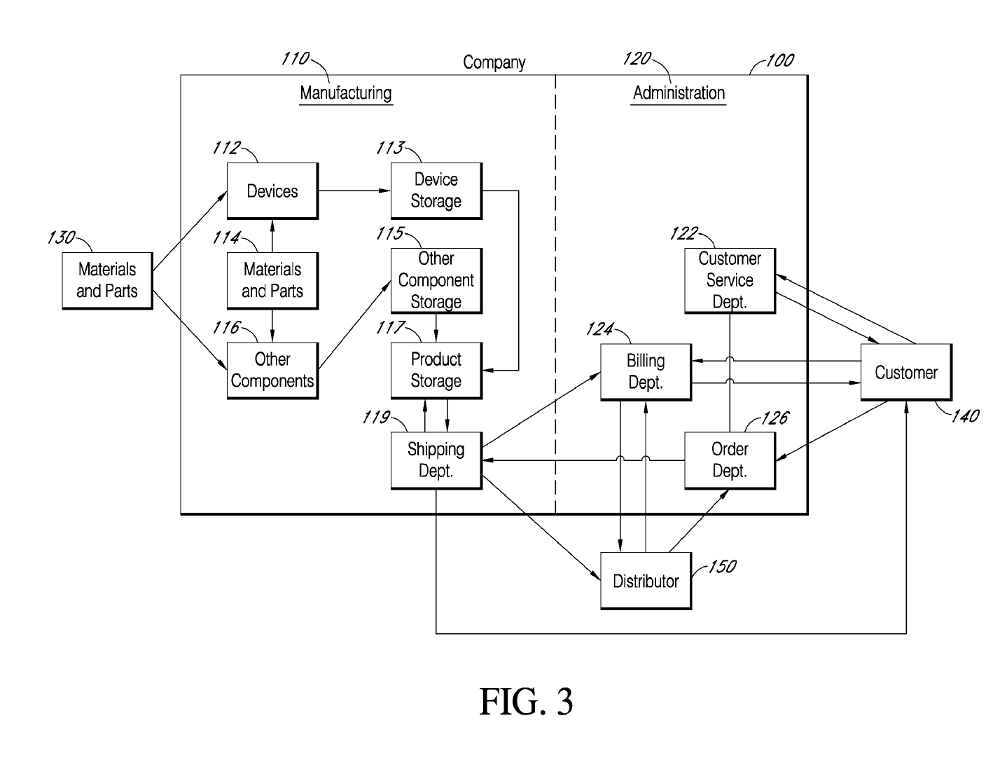

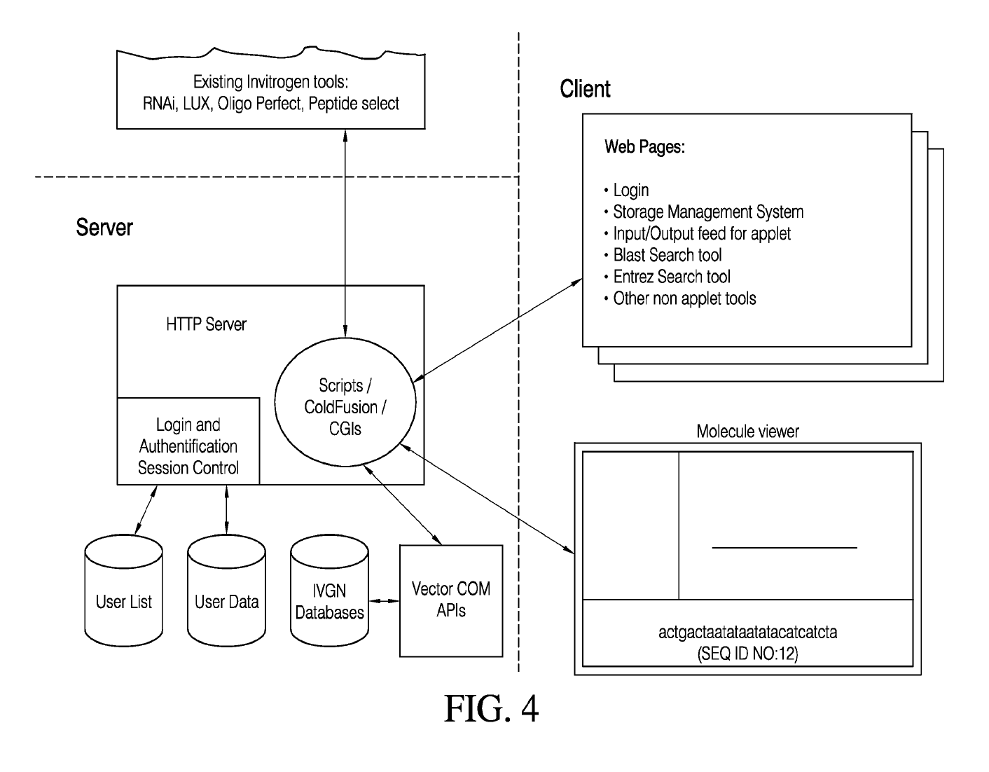

FIG. 4 provides an exemplary general architecture for performing methods provided herein within a client/server environment. The general architecture includes server functions, including design of biomolecules such as RNAi, and other scripts which are run on a server computer and that can access databases on the server, and web pages that are delivered to the client. Typically, the server computer is maintained by a provider of biological products and of the computer products provided herein, and the client computer is a computer of the customer.

In another aspect of the invention, a documented Application Programming Interface (API) is provided to a customer that is associated with an in silico design method, a method for providing products to a customer, and a computer program product. API further can provide product ordering options to a customer such that a customer can route orders through that customer's computer system, such as a business-to-business system.

It will be understood by one of ordinary skill in the relevant arts that other suitable modifications and adaptations to the methods and applications described herein are readily apparent from the description of the invention contained herein in view of information known to the ordinarily skilled artisan, and may be made without departing from the scope of the invention or any embodiment thereof.

The entire disclosures of U.S. application Ser. No. 08/486,139, (now abandoned), filed Jun. 7, 1995, U.S. application Ser. No. 08/663,002, filed Jun. 7, 1996 (now U.S. Pat. No. 5,888,732), U.S. application Ser. No. 09/233,492, filed Jan. 20, 1999, (now U.S. Pat. No. 6,270,969), U.S. application Ser. No. 09/233,493, filed Jan. 20, 1999, (now U.S. Pat. No. 6,143,557), U.S. application Ser. No. 09/005,476, filed Jan. 12, 1998, (now U.S. Pat. No. 6,171,861), U.S. application Ser. No. 09/432,085 filed Nov. 2, 1999, U.S. application Ser. No. 09/498,074, filed Feb. 4, 2000, U.S. application No. 60/065,930, filed Oct. 24, 1997, U.S. application Ser. No. 09/177,387, filed Oct. 23, 1998, U.S. application Ser. No. 09/296,280, filed Apr. 22, 1999, (now U.S. Pat. No. 6,277,608), U.S. application Ser. No. 09/296,281, filed Apr. 22, 1999, (now abandoned), U.S. application Ser. No. 09/648,790, filed Aug. 28, 2000, U.S. application Ser. No. 09/855,797, filed May 16, 2001, U.S. application Ser. No. 09/907,719, filed Jul. 19, 2001, U.S. application Ser. No. 09/907,900, filed Jul. 19, 2001, U.S. application Ser. No. 09/985,448, filed Nov. 2, 2001, U.S. application No. 60/108,324, filed Nov. 13, 1998, U.S. application Ser. No. 09/438,358, filed Nov. 12, 1999, U.S. application No. 60/161,403, filed Oct. 25, 1999, U.S. application Ser. No. 09/695,065, filed Oct. 25, 2000, U.S. application Ser. No. 09/984,239, filed Oct. 29, 2001, U.S. application No. 60/122,389, filed Mar. 2, 1999, U.S. application No. 60/126,049, filed Mar. 23, 1999, U.S. application No. 60/136,744, filed May 28, 1999, U.S. application Ser. No. 09/517,466, filed Mar. 2, 2000, U.S. application No. 60/122,392, filed Mar. 2, 1999, U.S. application Ser. No. 09/518,188, filed Mar. 2, 2000, U.S. application No. 60/169,983, filed Dec. 10, 1999, U.S. application No. 60/188,000, filed Mar. 9, 2000, U.S. application Ser. No. 09/732,914, filed Dec. 11, 2001, U.S. application No. 60/284,528, filed Apr. 19, 2001, U.S. application No. 60/291,973, filed May 21, 2001, U.S. application No. 60/318,902, filed Sep. 14, 2001, U.S. application No. 60/333,124, filed Nov. 27, 2001, and U.S. application Ser. No. 10/005,876, filed Dec. 7, 2001, are herein incorporated by reference.

The following examples are intended to illustrate but not limit the invention.

### Example 1

The following example illustrates one specific aspect of the methods and computer systems of the invention.

### Overview of VectorDesigner

VectorDesigner is a secure, online tool for clone construction and management. Using VectorDesigner, you can import, view, construct, analyze, and save DNA and protein sequences in a Web-based environment, and then export your molecule constructions as standalone files to share with colleagues.

VectorDesigner provides a secure Web-based database for storage and management of your clone sequences and designs. It includes interactive tools for identifying ORFs and restriction sites, translating sequences, generating PCR primer designs, searching public sequence databases, and performing other types of molecule analysis. You can design complex cloning experiments using proprietary Gateway® and TOPO® technologies or common methodologies such as restriction-ligation and PCR. You can analyze your sequences using other Invitrogen tools (BLOCK-iT™ RNAi Designer, CloneRanger™, OligoPerfect™ Designer, LUX™ Designer) and import the results back into VectorDesigner.

VectorDesigner is based on VectorNTI Advance™, a software suite for sequence analysis and molecular data management, available for Windows® and Macintosh® operating systems. Files created and saved using VectorDesigner can be opened seamlessly in VectorNTI Advance™, which provides more powerful analysis tools and enhanced databasing capabilities. See FIG. 5 for a comparison of the functionalities of VectorDesigner™ and Vector NTI Advance™. See also, Invitrogen's Bioinformatics Software Web page for more information about VectorNTI Advance™

Database Operations VectorDesigner Database Browser

The VectorDesigner database contains DNA, RNA, and protein molecule files in a hierarchy of folders and subfolders. The Database Browser provides access to the entire contents of the database.

Click on the Browse Database tab in VectorDesigner to view the Database Browser. The Browser window is divided into two main panes: the “Folder tree” and the “Molecules list”.

The Folder tree displays the database folder structure. Use the folder tree to navigate through the database. Click on a folder name to view its contents. Click on the .+−.button next to each folder name to expand or collapse the folder. Note: The Folder tree is only visible if you approved the signed security certificate when VectorDesigner first opens.

The Molecules list displays the contents of the currently selected folder. Click on a molecule name in the list to open the molecule file. Select the checkbox next to the molecule name to rename, move, or delete the molecule file. Click on the Import button to enter a new molecule sequence or import a molecule file from another source.

Database Folders

The Database Browser window displays the folder structure of the VectorDesigner database. The database has five main folders—three user folders (DNA/RNAs, Proteins, and Primers) and two read-only folders (Invitrogen Vectors and

### Examples

User Folders

User folders are private, secure folders that contain molecule files that you create or modify (e.g., DNA/RNAs; Proteins; Primers). The contents of these folders are created and controlled by the user, are keyed to your user name and password, and cannot be viewed by other users. The molecule files in these folders can be edited, renamed, deleted, moved, and exported for collaboration with other users.

You can create new folders within the three main user folders. However, you cannot delete or move the three main user folders, and you cannot add new main user folders.

Each main user folder can contain only molecules of the specified type (DNA/RNAs, Proteins, and Primers). For example, you cannot store DNA molecule files in the Proteins folder.

Read-Only Folders

Read-only folders contain molecule files created by Invitrogen: Invitrogen Vectors, which contains sequences and maps of vectors sold by Invitrogen, including Gateway® and TOPO® vectors; and Examples, which contains sequence-verified example files of common DNA, protein, and primer molecules. These folders and files cannot be modified or deleted and are accessible to all users. You can copy the molecule files in these folders into your private user folders and edit them.

Editing Folders

You can add folders within the main user folders. Click on a folder name to select it and click on the Create a New Folder button to create a subfolder within that folder. To delete a folder that you created, click on the folder name to select it and click on the Delete Folder button. Note: Deleting a folder will also delete all its contents.

You can rename the main user folders or any of their subfolders. Click on the folder to select it, and click on the Rename Folder button. Enter the new name in the pop-up box and click on OK. Note that renaming a user folder will not change the file type restriction for that folder.

Folder Restrictions

User folders have the following restrictions: The DNA/RNAs folder and Proteins folder can contain up to 100 molecules each; The Primers folder can contain up to 1,000 molecules. DNA and protein molecules are restricted to 350,000 base pairs or amino acids in length; Primers are restricted to 250 bases in length; Each folder can contain only molecules of the specified type (e.g., you cannot store DNA molecule files in the Proteins folder); Each main user folder can have only 10 subfolders; Molecules with the same name cannot be saved in the same folder.

Database Capacity

The VectorDesigner database has the following limits: The DNA/RNAs folder and Proteins folder can contain up to 100 molecules each; The Primers folder can contain up to 1,000 molecules; DNA and protein molecules are restricted to 350,000 base pairs or amino acids in length; Primers may be restricted in size (e.g., 250 bases in length).

Molecule Files

A molecule file contains all the information about a molecule, including sequence, name, description, features, references, comments, analysis, etc. Molecule files for DNA/RNA and protein molecules are based on the GenBank/GenPept format, which is an ASCII text-based format, and can be exported as stand-alone files in a variety of formats.

Molecule files that are created, imported, or modified by you are stored in private user folders in the database and are accessible using your user name and password. Example molecule files created by Invitrogen are stored in read-only folders (Invitrogen Vectors and Examples) and are viewable by everyone.

The Database Browser window provides access to all the molecule files in the database. Using the Browser, you can open, rename, move, delete, import, and export the molecule files in your user folders, and you can export molecule files in the read-only folders.

Molecule File Types

Molecule files in VectorDesigner can contain DNA or RNA sequences, protein sequences, or primer sequences. The type of molecule determines the information contained in the molecule file, which user folder it is stored in, and which viewer it is displayed in. DNA and RNA Molecule Files contain circular or linear nucleotide sequences, are stored in the DNA/RNAs folder in the database, and are displayed in the Molecule Viewer. Protein Molecule Files contain amino acid sequences, are stored in the Proteins folder in the database, and are displayed in the Molecule Viewer. Primer Files contain DNA or RNA primer sequences, are stored in the Primers folder in the database, and are displayed in the Edit Primer Properties window.

Molecule Files in the Database Browser

Molecule files are listed in the right pane of the Database Browser window. Click on a folder name in the Browser to display the molecule files in that folder. If you make changes to the molecules list in the Browser and those changes are not updated in the Browser window, click on the Reload button to refresh the list. If you have more than 50 molecules in the list, use the scroll buttons to scroll through the list.

Opening Molecules

To open a molecule file: 1. Navigate to the appropriate folder in the Database Browser; and 2. Click on the molecule name in the molecules list. For DNA/RNA and protein molecules, the Molecule Viewer window for that molecule will open. For primers, the Edit Primer Properties window will open.

Saving Molecules

You can save changes that you make to molecule files. Changes to molecules opened from read-only folders must be saved under a different file name in your private user folders. Unsaved DNA/RNA/protein molecules are flagged with a “*” in the Molecule Viewer title bar.

Saving DNA/RNA and Protein Molecules

To save a DNA/RNA or protein molecule in the Molecule Viewer, go the Molecule menu and select Save or click on the Save button on the main toolbar. To save a molecule with a different file name or in a different location, go the Molecule menu and select Save As or click on the Save As button on the main toolbar. The Save As dialog will open. In the dialog, rename the file and/or select or create a new folder to save it in.

Saving Primer Molecules

To save a standalone primer file, in the Edit Primer Properties dialog, select the Rename or the Overwrite option button, and click on Save. If you selected Rename, the primer file will be automatically saved with a numerical extension appended to the file name (e.g., a file named Primer will saved as Primer (1)).

Importing Molecules

You can import molecule and primer sequences and other information into VectorDesigner in a variety of file formats, including: GenBank/GenPept; EMBL; SWISS-PROT; Vector NTI® (uses the GenBank format); FASTA; Plain text.

Exporting Molecules

You can export molecules from VectorDesigner in a variety of file formats. You can export the data for one or more molecules at a time from the Database Browser, or you can export the data for the current molecule loaded in the Molecule Viewer. You can export one or more molecules from the Database Browser to a file (text format) or to a browser window (HTML format). You can export the data for a DNA, RNA, or protein molecule displayed in the Molecule Viewer to a variety of formats.

Export to Vector NTIO

You can export the molecule data from VectorDesigner to Vector NTI®. In the Molecule

Viewer window, click on the Export to Vector NTI button on the main toolbar or select the command from the Molecule menu.

You will be prompted to save the file (.gb extension for DNA/RNA files, .gp extension for protein files) or automatically launch Vector NTI® and display the molecule in the application window. Note that Vector NTI® software must be installed on your computer to automatically launch the application.

Export to GIF

You can export the molecule image as it is displayed in the Molecule Viewer as a GIF image. Note: This command will export only the current view of the molecule. If the displayed information (sequence, graphics, text, etc.) is cut off at the margins of the panes in the Molecule Viewer, the data will appear cut off in the resulting image. Be sure to configure your Molecule Viewer panes as desired for the resulting image.

Export Format

The exported information will vary depending on the export format you select. Each database format (GenBank, EMBL, Vector NTI®, etc.) will include formatting and information compatible with that database. All formats include the molecule sequence. The available formats are: DNA/RNA molecules—GenBank, EMBL, and FASTA; Proteins—GenPept, Protein FASTA, SWISS-PROT; Primers—GenBank, EMBL, FASTA, and Tab-delimited

Moving Molecules

To move one or more molecule files the user can (1) Navigate to the appropriate user folder in the Database Browser; (2) Select the checkbox(es) next to the molecule name(s); (2) Click on the Move button; and (3) In the Pick a Folder window, navigate to the desired folder and click on OK. You can only move molecule files within the same main user folder. For example, you cannot move DNA molecule files into the Proteins folder. Molecules with the same name must be stored in separate folders.

Deleting Molecules

You can delete molecule files from the user folders of the VectorDesigner database. Note that deleted molecule files cannot be recovered from the database, and you will be prompted to confirm the deletion. To delete one or more molecule files the user can (1) Navigate to the appropriate user folder in the Database Browser; (2) Select the checkbox(es) next to the molecule name(s); (3) Click on the Delete button; (4) Click on OK to confirm the deletion.

Creating New Molecules

You can create a new molecule based on the molecule currently displayed in the Molecule Viewer. You can create a new molecule from a selected area of the existing molecule, such as a restriction fragment, or from the whole molecule.

For DNA or RNA molecules, you can create DNA/RNA molecules that are the reverse complement of the existing molecule or you can create protein molecules from a translation of the sequence. In the Molecule Viewer, click on the Create New Molecule button on the main toolbar or select the command from the Molecule menu. In the dialog, enter a name for the new molecule in the Name field, and a description (if any) in the Description field. Next, specify which part of the existing molecule to use as the basis for the new molecule. If you selected or marked a region of the existing molecule before you opened the dialog, the Selection or Mark options will be available and selected. Otherwise, select Molecule to select the whole molecule or Specified Range to enter the sequence range in the From and To fields. DNA/RNA molecules only: Select the Reverse Complement checkbox to create a molecule from the complementary sequence. Select Translate to create a protein molecule from a translation of the sequence. When you have made your selections, click on OK. The new molecule will be created and displayed in a new Molecule Viewer window.

Renaming Molecules

You can rename the molecule files in the user folders of the VectorDesigner database. To rename a molecule file: Navigate to the appropriate user folder in the Database Browser; Select the checkbox next to the molecule name in the molecules list; Click on the Rename button; Enter the new file name in the pop-up window and click on OK.

Revert Changes

You can undo all changes that you have made to a DNA/RNA molecule since it was last saved. Go to the Molecule menu and select Revert Changes to execute this command.

Molecule Viewer

The Molecule Viewer displays all the information in the database for DNA/RNA molecules and protein molecules. (Information for primers is displayed in the Edit Primer Properties dialog.) When you open a DNA/RNA or protein molecule file from the Database Browser, the Molecule Viewer will launch and display the molecule.

The Molecule Viewer can display: The molecule sequence; A graphical representation of the molecule; Information about the molecule, including a list of molecule features; The results of analysis performed on the molecule.

The Viewer can be divided into three main panes, the Text Pane, the Graphics Pane, and the Sequence Pane, each with its own set of tools and resources. The Text Pane provides database information about the molecule, including a molecule description, and list of molecule features, database keywords for the molecule, references to literature/other materials, links to resources related to the molecule, fields for user comments, and information about any analysis performed on the molecule (restriction sites, primer designs, etc.). The Graphics Pane displays a feature map of the molecule, and includes interactive tools for adding and editing features, highlighting and marking areas of the sequence, and displaying the molecule. An Analysis Pane can also be displayed in the Graphics Pane.

The Sequence Pane displays the entire nucleotide/amino acid sequence, and includes interactive tools for editing and marking the sequence, adding features, rearranging sequence elements, and copying and pasting the sequence. In this pane you can also toggle between a view of the sequence and a detailed view of the molecule feature list. A Feature List can also be displayed in the Sequence Pane.

The Text Pane in the Molecule Viewer contains textual information about the molecule, including a general description, comments, references, descriptions of molecule features, and the results of any analysis. To change the molecule description, comments, associated genes, keywords, references, etc. in the Text Pane, use the Molecule Properties dialog.

The Text Pane is structured as a directory tree. Click on the .+−.buttons to expand or collapse the branches of the tree. Alternatively, right-click on the branch and select Expand Branch or Collapse Branch.

Copying Text

To copy and paste text from the Text Pane: Click on the branch or feature that you want to copy. To select multiple branches/features, use Shift-Click or Control-Shift key commands. To select all branches and features, right-click anywhere in the Text Pane and select Select AH. Next, right-click on the selection and select Copy Text. The text will be copied to the computer clipboard. Paste the text into the application of your choice.

Link Mode

You can link the display in the Graphics and Sequence Panes to the folders that are open in the Text Pane control using the Link Mode command. When linked, information from the open folders in the Text Pane is displayed in the Graphics and Sequence Panes, while information in closed folders is not displayed. (Note that the molecule name and length is always displayed in the Graphics and Sequence Panes.)

Protein Parameters (Protein Molecules Only)

The Text Pane for protein molecules includes a table of Protein Parameters, which lists some of the biochemical properties of the protein, such as molecular weight, A280 absorbance, isoelectric point, etc. These properties are automatically calculated by VectorDesigner from the amino acid sequence.

Graphics Pane

The Graphics Pane in the Molecule Viewer contains a graphical representation of the DNA, RNA, or protein molecule, highlighting the results of any analyses such as ORFs, restriction sites, and other defined features. It includes a toolbar below the pane. Additional tools are located on the View menu and on the context menu if you right-click in the Graphics Pane. Defined features in the molecule are shown as colored bars in the Graphics Pane. Directional features (such as coding DNA sequences, or CDSs) are shown as bars with directional arrows. Open reading frames are shown as thin directional arrows. Restriction endonuclease sites are labeled with the name of the enzyme.

Circular and Linear Display of DNA/RNA Molecules

For circular DNA/RNA molecules (as defined in the Molecule Properties dialog), you can toggle between a circular and linear display. Click on the Display as Circular button or the Display as Linear button below the Graphics Pane, or select the commands from the View Graphics Map submenu.

Note that this only changes the molecule display. To change the actual molecule structure from circular to linear or vice versa, use the Molecule Properties dialog.

Showing Labels

To show and hide labels in the Graphics Pane, click on the Show/Hide Labels button below the Graphics Pane, or select the command from the View>Graphics Map submenu. For molecules with more than 80 features, labels are hidden by default.

Link Mode

You can link the display of features (including ORFS, restriction sites, etc.) in the Graphics Pane to folders that are open in the Text Pane using the Link Mode command. When linked, features of open folders in the Text Pane are displayed in the Graphics Pane, while features in closed folders are not displayed.

Standard Arrangement

If you change the displayed labels and features in the Graphics Pane (e.g., using Link Mode), you can reconfigure the pane to make best use of the available space. Go to the View Graphics Map submenu and select Standard Arrangement.

Sequence Pane

The Sequence Pane in the Molecule Viewer shows the sequence of a DNA/RNA or protein molecule in a scrollable, wrap-around field, with the starting base/amino acid number of each line shown to the left. The Sequence Pane uses standard code letters to indicate the bases/amino acids in the sequence. For DNA molecules, by default, both the direct and complementary strands are shown. (See Changing the Sequence Display, below.) Hold your cursor over the sequence to display a popup box showing the base/amino acid number at that point in the sequence.

The Feature List is also displayed in the Sequence Pane. Click on the Feature List button to the left of the Sequence Pane to view the Feature List. Click on the Sequence Pane button to return to a view of the sequence.

To change how the sequence is displayed in the pane, right-click in the Sequence Pane and select Sequence Properties. Various sequence and feature representation styles are available. In the Sequence Properties dialog, you can select the following display options:

Types Filter

To filter the types of features highlighted in the Sequence Pane, right-click in the pane and select Types Filter. In the dialog, all available features will be selected. Deselect the checkboxes next to the filters that you do not want to view in the Sequence Pane, and click on OK to make the changes.

Link Mode

You can link the display of features (including ORFs, restriction sites, etc.) in the Sequence Pane to the folders that are open in the Text Pane using the Link Mode command. When linked, features of open folders in the Text Pane are displayed in the Sequence Pane, while features in closed folders are not displayed. To enable this feature, click on the Link Mode button on the main toolbar or select the command from the View menu.

Analysis Pane

The Analysis Pane displays graphical plots of a variety of a DNA and protein sequence analyses. You can display multiple plots at a time in the Analysis Pane. The available analyses depend on the molecule type (DNA/RNA or protein).

The Analysis Pane and the Graphics Pane are displayed in the same pane in the Molecule Viewer. The Graphics Pane is displayed by default. To display the Analysis Pane, click on the Analysis Pane button below the Graphics Pane. To return to a view of the Graphics Pane, click on the Graphics-Pane button.

Graph Format

The graphs in the Analysis Pane display different physiochemical properties of the sequence. Many of properties are based on parameters like charge that exert effects over distance. Other properties represented in the plot depend on the way adjacent bases/amino acids fold in 3-dimensional space, which is a function of the sequence itself.

The vertical (Y) axis in the graph shows the values of the analysis results; the horizontal (X) axis displays either numerical positions in the sequence or residues. At any point along the sequence, the Y value is derived not just from the specific residue at that point but also from adjacent residues. Each analysis algorithm uses an optimum window of adjacent residues to calculate the value for a point. You can adjust this window size in the Plot Properties dialog (see below).

Note: No values may be calculated at the beginning and end of the sequence if there are not enough bases/amino acids to the left or right of each base/amino acid for the algorithm to calculate a value. To calculate values for those regions, you can reduce the window size in the Plot Properties dialog.

Plots Setup

Use the Plots Setup dialog to select and arrange the analysis graphs to display in the pane. To open the dialog, click on the Plots Setup button below the Analysis Pane or select the command from the right-click menu.

In the Plots Setup dialog, the available analyses are listed in the top window and the selected graphs are listed in the bottom window. Analysis graphs are displayed in panels. You can add one or more analyses to a panel, and display multiple panels in the Analysis Pane.

Plot Properties

The Plot Properties dialog controls how each plot is displayed in the graph. To open the dialog, right-click on an graph in the Analysis Pane and select Plot Properties. The dialog is divided into three tabs. When you have made your selections, click on OK.

Diagram Tab

Click on the Graph Color button to open a dialog in which you can select a plot color and/or adjust the Red-Green-Blue (RGB) values of the color. Select the Draw Type from the dropdown list. Min-Max-Average displays the calculated minimum, maximum, and average values over each analysis region within the sequence as levels of shading along the line of the graph.

Under Preprocess Type, select Linear Interpolation to provide a linear interpolation of the graph line, or No Preprocessing to display the line without interpolation.

Params Tab

Window Size is the size of the processing “window” used to scan the sequence for analysis. Enter a number of bases/amino acids in the Window Size field (see example below). Step Size is the number of bases/amino acids in a sequence that constitute an analysis point in the plot. Enter number of bases/amino acids in the Step Size field (see example below). Example: If you select a % GC Content analysis with a window size of 21 and a step size of 1, the GC content percentage will be calculated for a 21-base region centered on each base in the sequence (10 bases on either side of the base). A step size of 5 would calculate the percentage for a 21-base region centered on each 5-base region in the sequence.

Info Tab

This tab provides information on the type of analysis in the plot, including any references to external literature.

Feature List

The Feature List is list of the defined features in the molecule in an easy-to-read table format.

The Feature List is displayed in the Sequence Pane. Click on the Feature List button (Efs) to the left of the Sequence Pane to view the Feature List. Click on the Sequence Pane button (IiIcJl) to return to a view of the sequence. Click on a column header in the Feature List table to sort the list by that column. Right-click on a feature in the list and select Edit Feature Properties to open the Add/Edit Feature dialog. Right-click on a feature in the list and select Copy Text to copy the feature information to the computer clipboard in a tab-delimited format. Right-click on a feature in the list and select Open Link to access a variety of links to online databases with information about the feature. Note that links are available for only certain types of imported molecules.

Window Manager

Use the Window Manager dialog to switch between multiple open Molecule Viewer windows. To open the Windows Manager, go the Windows menu and select Windows.

All open Molecule Viewer windows will be listed in the dialog. To bring a window to the front, double-click on it in the list. To close a window, select it in the list and click on Close Windows. To close multiple windows, select them using Control+Click and Shift+Click key commands and click on Close Windows. Click on Exit to close the manager.

Molecule Features

Using VectorDesigner, you can label the various features in a DNA/RNA or protein molecule, including promoter regions, open reading frames, binding sites, epitopes, or any other region of interest. The Feature Map folder in the Text Pane of the Molecule Viewer contains a list of labeled features. The Imported Features Not Shown on Map folder contains a list of unlabeled features. You can label as many features in a molecule as you want. Features are listed in the Text Pane and shown in the Graphics and Sequence Panes.

Adding Features

Note: You can label an open reading frame, restriction fragment, or primer as a feature. See Annotating Analysis.

To add a feature to the Feature Map folder: Select the part of the sequence that you want to label as a feature, or mark multiple areas of the sequence that you want to label as a single feature. Click on the Add Feature button or select the command from the Edit menu. (You can also right-click in the Graphics or Sequence Pane and select Add Feature from the context menu.) In the Add/Edit Feature dialog, the Feature Type field lists the available feature types in the database for the molecule. Select a feature type from the list. If you cannot find the precise type you are looking, select Misc. Feature. Note that you cannot add new feature types in VectorDesigner. Enter a name for the feature in the Feature Name field. Select the format to use for defining the sequence region: Use Start.End Format or Use Start-Length Format. If you selected the feature region or marked multiple regions in the sequence before opening the dialog, the start and length/endpoint(s) of the feature will be automatically entered in the dialog. To change the region, enter the start and length/endpoint(s) in the fields. For features with multiple components (i.e., internal start and endpoints), select Multi-component and enter each start and length/endpoint in the field. Use the following format: <start1> . . . <length/endpoint1>, <start2 . . . length/endpoint2>, etc. Click on Reset to Selection to undo any changes you may have made to a preselected sequence region. Click on Reset to Mark to undo any changes you may have made to a marked sequence region. Select the Complementary checkbox if the feature is located on the complementary molecule strand. Note: VectorDesigner uses the currently accepted convention for calculating the coordinates of complementary features. All coordinates are given as if on the direct strand, from left to right in the sequence. Enter a description for the feature in the Description field. When you have made your selections, click OK to add the feature.

When you click on OK, information about the feature will be added to the Feature Map in the Text Pane, and the feature will be flagged in the Graphics and Sequence Panes as described below.

Viewing and Selecting Features

Text Pane: In the Text Pane, labeled features are listed by type under the Feature Map folder. Note that many of the feature types in VectorDesigner are mapped to keys in the GenBank and GenPept databases.

The user may click on the +button next to each feature type to view all the features of that type. Click on the +button next to each feature name to view the information for that feature, including sequence location, length, description, and any Web links. Features with multiple components will list each component separately under the feature information. Double-click on the feature name in the Text Pane to display the feature in the Graphics and Sequence Panes.

Graphics Pane: Features are displayed in the Graphics Pane by large colored arrows. Hold your cursor over feature arrow to display a popup information box for that feature. Click on a feature arrow to select that feature in the Sequence Pane, or right-click on the arrow and select Find in Tree to locate the feature in the Text Pane.

Sequence Pane: In the Sequence Pane, features are marked by colored bars above the sequence. Click on feature bar in the Sequence Pane to select the feature in the Graphics Pane, or right-click on the arrow and select Find in Tree to locate the feature in the Text Pane.

Feature List: The Feature List, displayed in the Sequence Pane, lists each feature in the molecule in an easy-to-read table format. Double-click on the feature name in the Feature List to display the feature in the Graphics Pane.

Editing Features

To edit a feature: Right-click on the feature in the Feature Map folder, Feature List, or Imported Features Not Shown in Map folder; and Select Edit Feature Properties from the context menu. This opens the Add/Edit Feature dialog.

Deleting Features

You can delete the feature definition and information without removing the actual sequence of the feature from the molecule. In the Text Pane or Feature List, right-click on a feature and select Remove Feature. The feature information will be removed from the molecule file, but the sequence will remain unchanged. To undo a feature deletion, right-click in any pane in the Molecule Viewer and select Undo. To remove the sequence of a feature, see Inserting and Deleting Sequences. Marking Features You can mark features in the Sequence and Graphics Panes and combine them into new features.

Molecule Properties

The Molecule Properties dialog contains basic information about a DNA/RNA or protein molecule, including a description, references, associated genes, whether the molecule is circular or linear, and database links. Information entered in this dialog is shown in the Text Pane of the Molecule Viewer. To open the dialog, click on the Molecule Properties button on the main toolbar or select Properties from the Edit menu. The dialog is divided into several tabs.

The General Tab includes database information about the molecule file, including the database ID number and creation date.

Molecule Tab

DNA/RNA molecules: Select Circular or Linear and DNA or RNA from the dropdown lists. Molecules with compatible overhangs will not circularize by joining the overhangs; rather, the ends will be filled in. Only DNA molecules flagged as Linear in this dialog can be used in the Molecule Construction workspace as inserts or vectors. The user may enterr a brief description of the molecule in this field.

For Associated Genes, the user can click on Add Gene to add a gene associated with the molecule to the list. A gene entry is created in the table. Click in the editable text field to enter the gene name. This creates a database link that is useful if you export the molecule file to another format (GenBank, SWISSPROT, VectorNTI, etc.). To delete a gene entry, click on it in the table, then click on Remove Gene.

The Comment Tab Enter any comments about the molecule in this field.

Standard Fields

This tab contains two subtabs. DNA/RNA molecules: The first tab is called Division/Organella/Keywords. You can click in the Division column and Organella column to select appropriate categories for the molecule. These will be highlighted for the molecule. Then you can enter the keywords as described below. Keywords: Click on Add Keyword to add a database keyword associated with the molecule to the list. A keyword entry is created in the table. Click in the editable text field (DO) to enter the keyword. This creates a database link that is useful if you export the molecule file to another format. To delete a keyword, click on it in the table, then click on Remove Keyword.

Source Organism: Click on this tab to display a table of organisms associated with the molecule. Click on Add Organism to add an organism associated with the molecule to the table. An organism entry is created in both columns in the table. Click in the editable text field in each column to enter the organism name in Latin and English. This creates a database link that is useful if you export the molecule file to another format (GenBank, SWISSPROT, VectorNTI, etc.). To delete a source organism, click on it in the table, then click on Remove Organism.

References Tab

Enter any references for the molecule in the field under this tab. This is a simple text-entry field. If you want to export the molecule in a particular format (e.g., GenBank), be sure to enter text in that format.

Feature List

The Feature List is list of the defined features in the molecule in an easy-to-read table format. The Feature List is displayed in the Sequence Pane. Click on the Feature List button to the left of the Sequence Pane to view the Feature List. Click on the Sequence Pane button to return to a view of the sequence. Click on a column header in the Feature List table to sort the list by that column. Right-click on a feature in the list and select Edit Feature Properties to open the Add/Edit Feature dialog. Right-click on a feature in the list and select Copy Text to copy the feature information to the computer clipboard in a tab-delimited format. Right-click on a feature in the list and select Open Link to access a variety of links to online databases with information about the feature. Note that links are available for only certain types of imported molecules.

Selecting a Sequence

Nucleotide and amino acid sequences are displayed in the Sequence Pane of the Molecule Viewer. In the Viewer, you can select part or all of a sequence, copy it, flag it as a feature, and otherwise analyze it.

Selecting Part or All of a Sequence

There are a number of ways to select part or all of a sequence. In the Molecule Viewer with the molecule displayed: Drag your cursor in the Sequence Pane or Graphics Pane. The selected part of the sequence will appear highlighted in both panes. Click on a defined feature, ORF, or restriction site in the Graphics or Text Pane, or double-click on a defined feature in the Feature List. The sequence of that feature will appear selected in the Sequence Pane. From the View menu or main toolbar, select Set Selection. In the Set Selection dialog, define the selection area and click on OK. The defined area will appear selected in the Graphics and Sequence Panes. Right-click in the Sequence Pane and select Select All to select the entire sequence.

Displaying Only the Selected Part of a Sequence

You can filter the display to show only the selected portion of the sequence. With the selection made, go to the View menu and select View Selection or click on the View Selection button on the main toolbar. To return to a full view of the molecule, go to the View menu and select View Entire Molecule or click on the View Entire Molecule button on the main toolbar.

Finding a Sequence

To find a molecule sequence within a larger sequence, right-click in the Sequence Pane in the Molecule Viewer and select Find Sequence. In the, dialog, type or paste the sequence you want to find, specify the search direction (Up or Down), and click on Find Next. Click on Find Next again to find the next occurrence of the sequence within the larger sequence. Click on Close to close the dialog.

Inserting and Deleting Sequences DNA and Protein Molecules

You can insert a new DNA or protein sequence into an existing DNA or protein molecule in the Molecule Viewer. Note that this command will only insert a new sequence at the insertion point; it will not overwrite any part of the existing sequence. With the molecule displayed, locate the point in the sequence where you want to insert the new sequence. Click on that point in the Sequence Pane. From the Edit menu or main toolbar, select Insert Sequence. The Insert Sequence dialog will open. In the dialog, note the insertion point listed below the field. Type or paste the new sequence into the field and click on OK. Note: Use only standard code letters when entering the sequence. Nonstandard characters will be marked with a ? in the Insert Sequence dialog and you will be prompted to remove them before adding the new sequence. If you are adding the sequence within a defined feature, the Feature Map is Updated dialog will open, listing the features in the molecule that will be affected by the insertion. In this dialog you can remove any or all of the defined features that will be changed. Note that this will not alter the change that you are making to the sequence; it will only remove the defined feature(s) affected by the change. Click on OK to make the changes. The sequence will be added to the molecule. If you flagged a feature for deletion in the Feature Map is Updated dialog, that feature will be removed.

To delete part of a sequence in the Molecule Viewer: With the molecule displayed, drag the cursor in the sequence or Graphics Pane to select the part of the sequence that you want to delete. From the View menu or main toolbar, select Delete Sequence. Note: You cannot delete the entire sequence in the Molecule Viewer. If you are deleting the sequence within a defined feature, the Feature Map is Updated dialog will open, listing the features in the molecule that will be affected by the deletion. In this dialog you can remove any or all of the defined features that will be changed. Note that this will not alter the change that you are making to the sequence; it will only remove the defined feature(s) affected by the change. Click on OK to make the changes. The sequence will be deleted from the molecule. If you flagged a feature for deletion in the Feature Map is Updated dialog, that feature will be removed.

For primers, the user can type, paste, and delete sequences directly in the Sequence field of the Edit Primer Properties dialog.

Copying a Sequence

You can copy a selected sequence to the computer clipboard. In the Sequence Pane of the Molecule Viewer: Select the sequence. Right-click on the selected sequence in the sequence pane and select Copy. The sequence will be copied to the computer clipboard. You can then paste the copied sequence into your application of choice.

Marking a Sequence

You can mark regions of interest in a DNA or protein sequence with shading for easy comparison and reference. You can also mark multiple regions (e.g., the exons of a gene of interest) and label them as a single multi-segmented feature. In the Sequence Pane or Graphics Pane of the Molecule Viewer, select the region you want to mark, or click on the feature, ORF, or other defined element that you want to mark. Click on the Mark Selection button on the main toolbar, or select the command from the View menu or context menu (if you right-click in the Graphics Pane). The selected region will appear shaded-in the Sequence and Graphics Panes. Repeat the steps above to mark multiple regions in the sequence. You can then label them as a feature.

To unmark the sequence region: Select the marked region in the Sequence or Graphic Pane; Click on the Unmark Selection button on the main toolbar, or select the command from the View menu or context menu (if you right-click in the Graphics Pane); and Click on Unmark All to remove all the marks in the sequence.

Sequence Translation

You can use Vector Designer to translate the nucleotide sequence in a DNA molecule into amino acids. Note that only the Standard Genetic Code is available for translation. In the Molecule Viewer with a nucleotide sequence displayed: Select the part of the sequence that you want to translate. To select the entire sequence, right-click in the Sequence Pane and select Select AH. To translate the direct strand, click on the Translate Direct button on the main toolbar, or select the command from View>Translation menu. To translate the complementary strand, click on the Translate Complementary button on the main toolbar, or select the command from View>Translation menu. The translation will appear in the Sequence Pane as amino acid codes above the nucleotide sequence. To toggle between single-letter and three-letter amino acid codes, click on the 1 Letter/3 Letter Code button from the main toolbar or select the command from the View>Translation menu. To clear the translation from the display, click on the Clear Translations button on the main toolbar or select the command from the View>Translation menu.

Designing Primers and PCR Products Designing Primers

You can use VectorDesigner to design primers for a target sequence, or you can search for existing primers that are compatible with the sequence. The resulting PCR products can then be used in a variety of applications, including TOPO® Cloning, Gateway® Cloning, and standard PCR analysis or molecule construction. If you want to search for existing primers, the primers must be saved in the Primers folder of the database as separate primer files. The primer design settings are located in the PCR Analysis dialog of the Molecule Viewer.

In the dialog, you specify the parameters for designing or selecting the primers. Then VectorDesigner identifies one or more primer designs. You can then: Save the primer designs with the molecule or as separate files. Order the primers direct from Invitrogen. Save the PCR product generated by the primers as a separate molecule for further analysis. Evaluate the PCR product in a cloning or molecule construction strategy.

To identify primers for a molecule sequence: In the Molecule Viewer, select the region of the molecule for which you want to design primers. Alternatively, if you are searching for existing primers that are compatible with the molecule, you do not have to select any region (available for TOPO® Cloning and molecule construction applications only). Go to the Cloning menu, select the appropriate subfolder for your application—TOPO Cloning, Gateway Cloning, or Molecule Construction. Select Design Primers to Amplify Selection to design primers for the selected sequence, or Find Amplicon in Sequence Using Existing Primers to evaluate existing primers for use with the molecule or selected sequence (available on the TOPO Cloning and Molecule Construction submenus only). The PCR Analysis dialog will open. The default values and available options will differ slightly depending on the application you selected (these differences are noted in the steps below). Under the Primer Definition and Construction tab, the From and To fields define the region that will be analyzed for primer designs. You can change the numbers in these fields. Next, enter the primer design parameters, or select the folders containing the saved primers that you want to evaluate for compatibility with the molecule sequence.

The following fields are only available if you selected Design Primers to Amplify Selection: To include primer design regions before and after the target sequence, enter a number of bases in the Before and After fields. Maximum # of Outputs: Enter the maximum number of primer pair designs to generate. Note that VectorDesigner may generate fewer designs if no more can be found. Tm: Enter the limits in degrees Celsius for primer melting temperature (Tm) (temperature at which 50% of primer is a duplex) in the Minimum and Maximum fields. Designs with Tm's outside this range will be excluded. % GC: Enter the maximum and minimum percent GC content for the primers in the fields. Designs with a percent GC content outside this range will be excluded. (The percent GC of any extensions are ignored.) Length: Enter the maximum and minimum length (in bases) of each primer in the fields. Designs that fall outside this range will be excluded. Nucleotide sequences such as RENs attached to a primer's 5′ end are included when calculating primer length. Exclude Primers with Ambiguous Nucleotides: If your sequence includes ambiguous bases (i.e., code letters other than A,G,C,T), select this checkbox to exclude regions containing these bases from the primer design search.

The following fields are only available if you selected Find Amplicon in Sequence Using Existing Primers: Click on the Direct button to select the folder containing the direct primer sequences that you want to evaluate, and click on Complementary to select the folder containing the complementary primer sequences to evaluate. The Browse to Primer Folder dialog will open when you click on each button. Select the folder and click on OK. The primers must be saved in the Primers folder or subfolders as separate primer files. Enter a percentage similarity in the Similarity>=Threshold field. Each primer sequence must be at least this similar to the molecule sequence to be selected by the designer. Select the checkbox next to Last Nucleotides Must Have 100% Similarity to specify a number of nucleotides at the 3′ end of each primer that must be 100% similar to the target sequence. Enter a number of nucleotides in the field. Next, select the conditions of the PCR reaction you are performing. If you are unsure of these values, use the default values: Salt cone: The salt concentration of the PCR reaction, in mMol. If you are unsure, use the default value of 50.0. Probe cone: The final concentration of the template in the reaction, in pMol. If you are unsure, use the default value of 250.0. dG temp: The temperature of the free energy value of the reaction, in degrees Celsius. If you are unsure, use the default value of 25.0.

Under Cloning Termini, select the type of PCR product you are generating. The available options will vary depending on your cloning application. Click on an application below for more information on how the primer and/or PCR product will be modified based on your selection: TOPO® Cloning PCR Products; Gateway® Cloning PCR Products; Molecule Construction PCR Products.

For cloning applications, under Cloning strand, select the strand whose sequence will be expressed: Direct or Complementary. Note that this will affect the primer strand to which Directional TOPO®, Gateway®, and other primer additions are added.

Next, select any sequence additions to each primer. This is optional. Primer additions (such as RENs) can be used to add sequences to the final PCR product for downstream applications such as restriction-ligation and protein expression. Click on the Browse button next to the Direct and/or Complementary fields. The Choose Direct/Complementary Strand Addition dialog will open. Select the strand additions in the dialog and click on OK. The additions will be listed in the appropriate field. Additions to the primer sequence will not be used in calculations of primer Tm, % GC, etc. If you change the Cloning Strand (step 5 above) after selecting the primer additions, the additions will switch to the other strand.

Click on the Pairing, Structure and Uniqueness tab to access additional primer specifications. Max. Tm Difference: Specify the maximum difference in melting temperature between sense and antisense primers in degrees Celsius. Max. % GC Difference: Specify the maximum percentage difference in GC content between sense and antisense primers. Note the differences in GC content between the two primer regions of the sequence when specifying this difference; a difference that is too small may result in no primers being found. Primer-Primer Complementarity: Permitted with dG>=: Select this checkbox and enter the minimum permitted value for free energy of a primer-primer duplex. Primer pairs which have a free energy value>/=to this number will be accepted. Primer-Primer Complementarity: 3′ End Permitted with dG>=: Select this checkbox and enter the minimum permitted value for free energy of complementarity between the 3′-end of the primers (the final 5 bases of each primer will be evaluated). Primer pairs which have a 3′-end complementarity free energy value>/=to this number will be accepted. Exclude Primers With: In the Repeat field, enter the maximum number of base-pair repeats allowed in each primer. In the Palindrome field, enter the maximum permitted length of palindromes in each primer sequence. In the Hairpin Loops field, enter the minimum permitted value for free energy of hairpin loops within each primer. Primer Uniqueness: Select this checkbox to reject primers above a certain percentage similarity to secondary sites within either the entire sequence or within the amplicon. Enter an percentage similarity in the field, and select

Within Entire Sequence or Within Amplicon Only.

Click on OK to design the primers. You will be prompted to send the PCR product for the first (highest ranked) primer pair directly to the appropriate molecule construction workspace as an insert. If you click on No, all the primer pairs generated will be added to the PCR Primers folder in the Text Pane of the Molecule Viewer.

Primer Designs and PCR Products

After you have designed primers from a molecule sequence using the tools in the Molecule Viewer, the primer designs and their PCR products will be listed in the PCR Primers folder of the Text Pane.

Viewing Primer Designs in the Text Pane

In the Text Pane, information about each primer design is included in the PCR Primers folder. Note: Only the designs for most recent target sequence are saved in this folder. If you design primers for a different target sequence, the new designs will replace any old ones. To preserve the primer designs for a particular target sequence, save them as features as described below.

In the PCR Primers folder, the PCR product for each primer pair has its own subfolder: Double-click on the subfolder to select the amplicon region in the graphics and Sequence Panes; Click on the +next to the PCR product folder name view the information for the primer pair; Double-click on each individual primer sequence in the PCR product folder to highlight that sequence in the graphics and Sequence Panes.

Ordering Primers from Invitrogen

Click on the Order from Invitrogen link next to each primer in the Text Pane to order the primer from Invitrogen. You will be prompted to enter a primer name, and the primer sequence will automatically be loaded into Invitrogen's online ordering system. You can specify the details of your order (purity, synthesis scale, etc.) on the Web site.

Adding a PCR Product to a Workspace

To load a PCR product in the TOPO® Cloning, Gateway® Cloning, or Molecule Construction workspace as an insert: In the PCR Primers folder in the Text Pane, right-click on the Product folder for the PCR product and select Add PCR Product to <application>Workspace (Note that specific application workspace listed will depend on which type of PCR analysis was used to generate the product); and the workspace will be displayed in the main VectorDesigner window, and the PCR product will be listed in the Insert field.

Saving the PCR Product as a New Molecule

To open the PCR product as a separate molecule: Right-click on the PCR product folder in the PCR Primers folder and select Open PCR Product in New Molecule Viewer. A new Molecule Viewer will open displaying the amplicon sequence as a linear DNA molecule, with the primers marked as features. Note that the new molecule is not automatically saved in the database; use the Save command in the Viewer to save the new molecule.

Saving Individual Primer Designs as New Molecules

To save the primer designs as individual primers in the database: Right-click on the primer sequence in the Text Pane (i.e., the actual sequence of the specific direct or complementary primer) and select Save Primer into DB. The Save As dialog box will open, prompting you to specify the primer name. Primers may be saved in the Primers folder or subfolders. To open the new primer file, go to the Database Browser window and double-click on the primer in the Primers folder. The Edit Primer Properties dialog will open.

Adding a PCR Product to the Feature Map

To add one more more PCR products to the Feature Map: In the PCR Primers folder in the Text Pane, right-click on a Product folder and select Annotate Analysis Item. In the Add/Edit Feature dialog; fill out the information and click on OK to add the PCR product to the feature map. To undo this command, right-click in the Text Pane and select Undo Annotate Analysis. Adding Primer Designs to the Feature Map

To add all primer designs to the Feature Map: In the Text Pane, right-click on the PCR Primers folder and select Annotate Analysis. The Annotate Analysis dialog will open; select the feature type and enter a feature name and description, and click on OK. Note that you can only fill out a single name all the primer designs; the individual primers will be given the name plus a numerical extension (<primer name>.sub.—1, <primer name>.sub.—2, etc.).

To add one or more primer pairs to the Feature Map: In the PCR Primers folder in the Text Pane, right-click on the Product folder for a primer pair, or hold down the Control key and click on multiple Product folders to select them and right-click on the selection. Select Annotate Analysis from the context menu. The Annotate Analysis dialog will open; select the feature type and enter a feature name and description, and click on OK. Note that you can only fill out a single name all the primer designs; the individual primers will be given the name plus a numerical extension (<primer name>1, <primer name>.sub.—2, etc.).

To add an individual primer sequence to the Feature Map: In the PCR Primers folder in the Text Pane, open the Product folder for the design you want and right-click on the primer sequence (i.e., the actual sequence of the specific direct or complementary primer). Select Annotate Analysis from the context menu. The Annotate Analysis dialog will open; fill out the information and click on OK. The primer sequence will be added. To undo these commands, right-click in the Text Pane and select Undo Annotate Analysis.

Deleting Primer Designs

To delete a PCR primer design from the molecule file: In the PCR Primers folder in the Text Pane, right-click on the Product folder and select Remove Site. The information for the primer designs and PCR product will be removed. (Note that the actual molecule sequence will not be affected.) To remove all primer designs from the molecule, right-click on the PCR Primers folder in the Text Pane and select Remove Analysis.

Marking/Highlighting Primer Designs

To mark a single PCR product in the Sequence and Graphics Panes with shading: In the PCR Primers folder in the Text Pane, right-click on the Product folder and select Mark Site.

To mark multiple PCR products in the Sequence and Graphics Panes with shading: In the PCR Primers folder in the Text Pane, hold down the Control key and click the Product folders to select-them, then right-click on the selection and select Mark Selected Items.

To mark a single primer sequence in the Sequence and Graphics Panes with shading: In the PCR Primers folder in the Text Pane, open the Product folder for the design, right-click on the specific primer sequence, and select Mark Site. (Note that you must right-click on the actual primer sequence, not the primer name.)

To mark multiple primer sequences in the Sequence and Graphics Panes with shading: In the PCR Primers folder in the Text Pane, open the Product folder(s) containing the primer designs, hold down the Control key and click on the primer sequences to select them, and then right-click on the selection and select Mark Selected Items. (Note that you must select the actual primer sequences, not the primer names.) To undo a marked region, select the PCR product and select View>Unmark Selection.

ORFs and Restriction Mapping Open Reading Frames

You can identify open reading frames (ORFs) in DNA molecules using the ORF Search tool in the Molecule Viewer. ORFs identified by the tool are shown in the Graphics, Sequence, and Text Panes, as described below.

Identifying ORFs

Using the ORF Search tool, you can set the minimum ORF size, the start and stop codons to search for, and other parameters, and VectorDesigner will generate a list of defined ORFs. To perform the ORF search: In the Molecule Viewer displaying a DNA molecule, click on the ORF Search button or go to the Tools menu and select ORF Search. In the ORF Search dialog, specify the Minimum ORF Size (in codons) and select the Nested ORFs checkbox if you want to search for nested ORFS (ORFs that have the same stop codon but different start codons). In Start Codons and Stop Codons fields, enter one or more start and stop codons to search for when identifying ORFs. Separate each codon by a space. To reset the fields, click on Reset to Default. Select Include Stop Codon in ORF if you want the stop codon to be considered part of the ORF. Otherwise, the stop codon will not be included in each ORF defined in the sequence. Click on OK to search for the ORFs.

The ORFs will be marked on the sequence in the Graphics and Sequence Panes, and a folder called Open Reading Frames will be created in the Text Pane. If you perform the ORF search again, the existing search results will be overwritten.

Viewing and Selecting ORFs

Each pane in the Molecule Viewer has different tools for viewing and selecting ORFs. Graphics Pane: In the Graphics Pane, ORFs are marked by thin directional arrows aligned with the sequence. Hold your cursor over an ORF arrow to display a popup information box for that ORF. Click on an arrow to highlight the ORF in the Sequence Pane. Right-click on an ORF and select Find in Tree to select the ORF in the Text Pane.

Sequence Pane: In the Sequence Pane, ORFs are marked by black bars above the sequence. Click on an ORF arrow in the Graphics Pane or an ORF name in the Text Pane to highlight the sequence in the Sequence Pane.

Text Pane: In the Text Pane, information about identified ORFs is included in a folder called Open Reading Frames. In this folder, each ORF is listed by its position in the sequence. The notation (D1, D2, D3, or C1, C2, C3) refers to the strand containing the ORF and its reading frame in the molecule sequence. For example, in a direct strand sequence beginning ATGTGTACTCCTTA . . . (SEQ ID NO:9), an ORF beginning with ATG would have the notation D1 and an ORF beginning with GTG would have the notation D3. Double-click on an ORF name in the folder to highlight the ORF in the Graphics and Sequence Panes. Click on the +next to each ORF name to view the start codon, stop codon, region of the sequence, and length of each ORF.

Adding ORFs to the Feature Map

You can add ORFs to the Feature Map in one of two ways: In the Text Pane, right-click on an ORF in the Open Reading Frames folder and select Annotate Analysis. The Annotate Analysis dialog will open; fill out the information and click on OK to add the ORF to the feature map. Note that this dialog will only enable you to add the ORF sequence as defined by the ORF Search tool. To undo this command, right-click in the Text Pane and select Undo Annotate Analysis. If you want to alter the start and/or endpoint of the ORF before defining it as a feature, right-click on the ORF in the Open Reading Frames folder and select Annotate Analysis Item. This will open the Add/Edit Feature dialog, in which you can change the start/endpoint of the feature. To undo this command, right-click in the Text Pane and select Undo Annotate Analysis.

Deleting ORFs

You can delete an ORF definition and information without removing the ORF sequence from the molecule. In the Text Pane, right-click on an ORF and select Remove Site. The ORF information will be removed from the panes, but the sequence will remain unchanged. To remove all ORF definitions from the molecule, right-click on the Open Reading Frames folder in the Text Pane and select Remove Analysis. To undo an ORF deletion, right-click in any pane in the Molecule Viewer and select Undo. To remove the sequence of an ORF, see Inserting and Deleting Sequences.

Marking/Highlighting ORFs

You can mark the ORF sequence in the Sequence and Graphics Panes with shading. In the Text Pane, right-click on the ORF and select Mark Site. In the Graphics Pane, right-click on the ORF arrow and select Mark Selection. Or, with the ORF selected in the Sequence Pane, go to the View menu and select Mark Selection. To undo a marked ORF, select the ORF and select View>Unmark Selection. Restriction Analysis

Vector Designer can identify the restriction enzyme cut sites in a DNA molecule using a built-in database of restriction enzymes. You can use the cut sites to generate restriction fragments for molecule construction.

Restriction Map Search

To perform restriction analysis: In the Molecule Viewer displaying a DNA molecule, click on the Restriction Map Search button (RMap) or go the Tools menu and select Restriction Map Search. In the Restriction Map Search dialog, select the category of enzymes that you want to use from the Use Enzymes list: Frequently Used Enzymes have been identified by Invitrogen. Click here for a list. 7+Cutters, 6 Cutters, 5 Cutters, etc. refer to the number of base pairs in the recognition site of each enzyme. Enzymes in the 5′ Overhang category result in fragments with a 5′ overhang; enzymes in the 3′ Overhang category result in fragments with a 3′ overhang. If you select Customized, click on the Customize button to select the particular enzymes you want to use. The Enzymes List dialog will open.

Next, enter a number in the Display Enzymes with <=Recognition Sites field. The Designer will analyze the sequence and use only those enzymes with less than or equal to that number of cut sites. Alternatively, select Unlimited to not filter the enzyme list by number of cut sites. When you have made your selections, click on OK.

Viewing and Selecting Restriction Sites

Each pane in the Molecule Viewer has different tools for viewing and selecting restriction sites. Graphics Pane: In the Graphics Pane, restriction sites are marked by blue-green lines from the site to the name of the restriction enzyme. Hold your cursor over the restriction enzyme name to display a popup information box for that site. Click on a restriction site to highlight the site in the Sequence Pane. Right-click on a restriction site and select Find in Tree to select the site in the Text Pane. See Restriction Fragments for instructions on selecting fragments in the Graphics Pane.

Sequence Pane: In the Sequence Pane, restriction sites are marked by blue bars above the sequence and the name of the enzyme above the bar. Click on the blue bar above the sequence to display a line through the sequence showing the exact cut site and overhang created by the enzyme. See Restriction Fragments for instructions on selecting fragments in the Sequence Pane.

Text Pane: In the Text Pane, information about identified restriction sites is included in a folder called Restriction Map. In this folder, each restriction site is listed by enzyme name. Double-click on a restriction site in the folder to highlight the site in the Graphics and Sequence Panes. Click on the +next to each enzyme name to view the complete name of the organism and the locations in the sequence where it cuts. Click on the Order from Invitrogen link to order the restriction endonuclease from Invitrogen. You will be linked to Invitrogen's online catalog page for the enzyme.

Adding Restriction Sites to the Feature Map

You can add restriction sites to the Feature Map. In the Text Pane, right-click on a restriction site in the Restriction Map folder and select Annotate Analysis. The Annotate Analysis dialog will open; fill out the information and click on OK to add the restriction site. To undo this command, right-click in the Text Pane and select Undo Annotate Analysis. To remove all restriction site definitions from the molecule, right-click on the Restriction Map folder in the Text Pane and select Remove Analysis.

Restriction Fragments Selecting a Restriction Fragment

You can select the region between two restriction enzyme cut sites in the Graphics or Sequence Pane to generate a restriction fragment. See Restriction Analysis for information on generating a list of cut sites. Before proceeding, you may want to limit the display to just the enzymes you are interested in using the Link Mode feature.

In the Graphics Pane with the restriction enzyme cut sites displayed, click on a restriction enzyme name, hold down the Shift key, and click on a second enzyme name. The region between the two cut sites will appear selected in the Sequence Pane.

In the Sequence Pane with the restriction enzyme cut sites displayed, click on the blue bar above a restriction site, hold down the Shift key, and click on a second blue bar. The region between the two cut sites will appear selected. Now you can copy the selected fragment, define it as a feature, or add it to the Molecule Construction workspace as an insert or a vector.

Adding a Fragment to the Molecule Construction Workspace

To add the feature to the Molecule Construction workspace as an insert or a vector: With the fragment selected, go to the Cloning>Molecule Construction menu and select Add Restriction Fragment to Workspace as an Insert or Add Restriction Fragment to Workspace as a Vector. The Molecule Construction workspace will be displayed in the main VectorDesigner window, and the fragment will be listed in the appropriate field (Insert or Vector).

Cloning Tools Molecule Construction

VectorDesigner provides automated tools for in silico construction of DNA molecules (e.g., expression clones) from existing sequences based on conventional cloning methodologies (e.g., restriction-ligation, TA cloning). VectorDesigner also provides tools for in silico molecule construction using Gateway® Cloning and TOPO® Cloning technologies.

Using these tools, you first design and select the sequences/molecules that you want to use to create the new molecule and add them to the Molecule Construction workspace. When you click on Clone, VectorDesigner will automatically select the optimal sites for recombination and generate and display the new design. The tools for in silico molecule construction are located in the Molecule Construction workspace in the main VectorDesigner window. Click on the Molecule Construction tab to view the workspace.

To construct molecules, you must first design and/or select an insert sequence and a vector sequence, as described below. The insert and vector sequences must have compatible ends (e.g., blunt ends or compatible overhangs). VectorDesigner can be used to construct a DNA molecule from one insert and one vector at a time. Vector NTI® software provides a suite of additional tools and options for constructing molecules.

Selecting Inserts

Inserts must be linear DNA sequences, and must have compatible ends with the vector you select. Examples include the following: Restriction fragments—see Restriction Analysis and Restriction Fragments; PCR products—see Designing Primers and Primer Designs and PCR Products; Linear DNA molecules (blunt-ended or with T-A extensions)

Selecting Inserts in the Molecule Construction Workspace

If the insert has been saved as a molecule in the VectorDesigner database, you can select it in the Molecule Construction workspace. Note that the insert must be saved in the DNA/RNAs folder or a subfolder. Click on the Browse in Insert button in the workspace. The window will expand, displaying navigation tools at the bottom. Using the folder tree in the left-hand part of the window, navigate to the folder containing your insert. Click on the insert name in the right-hand part of the window. The insert will be added to the Insert field in the workspace. (Note that you may need to scroll up in the window to view the Insert field.)

Selecting Inserts in the Molecule Viewer

The Molecule Viewer includes a number of tools for generating inserts and transferring them to the Molecule Construction workspace. See Restriction Fragments for instructions on selecting a restriction fragment in the Molecule Viewer and adding it to the Molecule Construction workspace as an insert. See Primer Designs and PCR Products, for instructions on selecting a PCR product in the Molecule Viewer and adding it to the Molecule Construction workspace as an insert.

When you design primers for a molecule sequence using the tools on the Cloning>Molecule Construction menu, you will be prompted to send the PCR product from the primary design directly to the Molecule Construction workspace. (See Designing Primers.) If you select No, the product will be added to the PCR Primers folder in the Text Pane and you can add it to the workspace from there. (See Primer Designs and PCR Products). You can transfer the entire molecule to the workspace as an insert. In the Molecule Viewer, go to the Cloning>Molecule Construction menu and select Add Entire Molecule to Workspace as Insert. Note that the molecule must be linear for this command to be available. When you use any of the methods above, the Molecule Construction workspace window will be displayed and the selected sequence will be listed in the Insert field.

Selecting Vectors

Vectors must be linear DNA sequences, and must have compatible ends with the insert you select. Examples include the following: Restriction fragments—see Restriction Analysis and Restriction Fragments; Linear DNA molecules (e.g., linearized vectors; blunt-ended or with T-A extensions)

Selecting Vectors in the Molecule Construction Workspace

If the vector has been saved as a molecule in the VectorDesigner database, you can select it in the Molecule Construction workspace. Click on the Browse in Vector button in the workspace. The window will expand, displaying navigation tools at the bottom. Using the folder tree in the left-hand part of the window, navigate to the folder containing your vector. Click on the vector name in the right-hand part of the window. The vector will be added to the Vector field in the workspace. (Note that you may need to scroll up in the window to view the Insert field.)

Selecting Vectors in the Molecule Viewer

The Molecule Viewer includes tools for generating restriction fragments that can used as vectors. You can also transfer the entire molecule to the workspace as a vector. See Restriction Fragments for instructions on selecting a restriction fragment in the Molecule Viewer and adding it to the Molecule Construction workspace as a vector. You can transfer the entire molecule to the workspace as a vector. In the Molecule Viewer, go to the Cloning>Molecule Construction menu and select Add Entire Molecule to Workspace as Vector. Note that the molecule must be linear for this command to be available. When you use either of these methods, the Molecule Construction workspace window will be displayed and the selected sequence will be listed in the Vector field.

Incompatible Termini

If you have added inserts and/or vectors with incompatible termini to the workspace, an alert message will appear in the left-hand pane of the Molecule Construction workspace. You will be prompted to: Select different inserts/vectors; Modify the inserts/vectors using restriction enzymes that will result in compatible termini; or Fill/trim any incompatible overhangs.

To modify an insert or vector, open it in the Molecule Viewer and use the editing tools in the Viewer to make the changes. Then re-add it to the Molecule Construction workspace. To fill or trim incompatible overhangs, use the pulldown boxes in the Insert and Vector fields in the Molecule Construction workspace to select the appropriate options (None, Fill, or Trim).

Creating the New Molecule

When you have added a compatible insert to the Insert field and a compatible vector to the Vector field, the Clone button in the Molecule Construction workspace will become active. Click on Clone to create the new molecule. The molecule will open in a new Molecule Viewer window. The insert may clone into the vector in both orientations, depending on the compatibility of the terminals. In this case, two new molecules will open. Use the Save command in the Molecule Viewer to save the new molecule.

Information about the New Molecule

Any features from the constituent molecules will be preserved in the new molecule, except for features that may be eliminated or truncated in the reaction. In addition to the standard information provided in the Molecule Viewer, the following information is provided for constructed molecules: In the Text Pane, the Design Description outlines the steps for the appropriate cloning reaction. In the Text Pane, the Component Fragments folder provides a description of each molecule fragment used to construct the molecule. Under each fragment, click on Open in Molecule Viewer to open the fragment in a new Viewer window (note that the fragment in the new Viewer window will not be saved).

Analysis of the New Molecule

You can now analyze the new molecule using analysis tools such as the open reading frame and sequence translation tools in VectorDesigner to verify that the DNA sequence is inserted and will be expressed as intended.

Gateway Cloning Overview of Gateway® Cloning

Gateway® Technology is based on the bactenophage lambda site-specific recombination system (atth.times.attR<=>attB.times.attP), which involves DNA recombination sequences {att sites) and proteins that bring together the target sites, cleave them, and covalently attach the DNA. Gateway® Technology uses lambda recombination to facilitate the transfer of heterologous DNA sequences (flanked by modified att sites) between vectors. Two recombination reactions constitute the basis of the Gateway® Technology: (1) BP Reaction: Facilitates recombination of an attB substrate (attB-PCR product or a linearized attB expression clone) with an att? substrate (donor vector) to create an a//L-containing entry clone. This reaction is catalyzed by BP Clonase™ II enzyme mix; and (2) LR Reaction: Facilitates recombination of an attL substrate (entry clone) with an attR substrate (destination vector) to create an aftB-containing expression clone (see diagram below). This reaction is catalyzed by LR Clonase™ II enzyme mix.

More information about Gateway® Technology: Gateway® Technology can be found in the Gateway® Technology manual, which is available on the World Wide Web at invitrogen.com.

Gateway® Cloning

VectorDesigner provides automated tools for in silico construction of Gateway® entry clones and Gateway® expression clones from existing sequences and vectors. Using VectorDesigner, you can construct a: Gateway® entry clone using an atiB substrate (attB-PCR product or attB-expression clone) and a donor vector (BP reaction); and/or Gateway® expression clone using an entry clone (attL substrate) and destination vector (LR reaction). In VectorDesigner, you first design and select the substrates and vectors that you want to use to create the new entry clone or expression clone and add them to the Gateway® Cloning workspace. When you click on Clone, VectorDesigner will automatically recombine the sequences and generate and display the new molecule. The tools for in silico Gateway® Cloning are located in the Gateway® Cloning workspace in the main VectorDesigner window. Click on the Gateway® Cloning tab to view the workspace.

To construct molecules, you must first design and/or select an insert and a vector: The insert in VectorDesigner is an attB substrate (attB-FCR product or attB-expression clone) if you are generating a Gateway® entry clone (BP reaction) or an entry clone if you are generating a Gateway® expression clone (LR reaction). The vector in VectorDesigner is a Gateway® donor vector if you are generating a Gateway® entry clone (BP reaction) or a Gateway® destination vector if you are generating a Gateway® expression clone (LR reaction). Files of Gateway® vectors are included in the Invitrogen Vectors>Gateway Vectors folder in VectorDesigner.

Selecting Inserts

The type of insert you select will depend on whether you want to perform a BP reaction to generate a Gateway® entry clone or an LR reaction to generate a Gateway® expression clone.

To generate a Gateway® entry clone (BP reaction), inserts can be: attB PCR products—see Designing Primers and Primer Designs and PCR Products for generating and selecting Gateway®-adapted PCR products containing attB sites; any DNA molecule containing attB sites; a Gateway® expression clone.

To generate a Gateway® expression clone (LR reaction), the insert must be a Gateway® entry clone. You can generate an entry clone using the following methods: Perform a BP reaction using an attB substrate and a donor vector; Use TOPO® Cloning or conventional cloning methods to insert your sequence of interest into a pENTR/TOPO or pENTR vector from Invitrogen. Molecule files of top-selling pENTR/TOPO vectors are provided in the Invitrogen Vectors>TOPO Vectors>Directional folder, and files of top-selling pENTR vectors are provided in the Invitrogen Vectors>Gateway Vectors>pENTR Vectors folder in VectorDesigner.

Selecting Inserts in the Gateway® Cloning Workspace

If the insert has been saved as a molecule in the VectorDesigner database, you can select it in the Gateway® Cloning workspace. Note that the insert must be saved in the DNA/RNAs folder or a subfolder. Click on the Browse in Insert button in the workspace. The window will expand, displaying navigation tools at the bottom. Using the folder tree in the left-hand part of the window, navigate to the folder containing your insert. Click on the insert name in the right-hand part of the window. The insert will be added to the Insert field in the workspace. (Note that you may need to scroll up in the window to view the Insert field.)

Selecting Inserts in the Molecule Viewer

The Molecule Viewer includes tools for designing Gateway®-adapted PCR products and transferring them to the Gateway® Cloning workspace. See Designing Primers. See Primer Designs and PCR Products for instructions on selecting a PCR product in the Molecule Viewer and adding it to the Gateway® Cloning workspace as an insert. When you design primers for a molecule sequence using the tools on the Cloning>Gateway Cloning menu, you will be prompted to send the resulting attB PCR product directly to the Gateway® Cloning workspace. You can transfer an entire molecule to the workspace as an insert. In the Molecule Viewer, go to the Cloning>Gateway Cloning menu and select Add Molecule to Workspace as Insert. When you use any of the methods above, the Gateway® Cloning workspace window will be displayed and the selected sequence will be listed in the Insert field.

Selecting Vectors

The type of vector you select will depend on whether you want to perform a BP reaction to generate a Gateway® entry clone or an LR reaction to generate a Gateway® expression clone: To generate a Gateway® entry clone (BP reaction), you must select a Gateways donor vector. Molecule files of top-selling donor vectors are provided in the Invitrogen Vectors>Gateway Vectors>pDONR Vectors folder in VectorDesigner. Sequences of additional donor vectors can be located by searching the Invitrogen Vectors Web database. To generate a Gateway® expression clone (LR reaction), you must select a Gateway® destination vector. Molecule files of top-selling destination vectors are provided in the Invitrogen Vectors>Gateway Vectors>pDEST Vectors folder in VectorDesigner. Sequences of additional destination vectors can be located by searching the Invitrogen Vectors Web database.

Selecting Vectors in the Gateway® Cloning Workspace

If the Gateway® vector is in the VectorDesigner database, you can select it in the Gateway® Cloning workspace: Click on the Browse in Vector button in the workspace. The window will expand, displaying navigation tools at the bottom. Using the folder tree in the left-hand part of the window, navigate to the folder containing your vector. Click on the vector name in the right-hand part of the window. The vector will be added to the Vector field in the workspace. (Note that you may need to scroll up in the window to view the Insert field.)

Selecting Vectors in the Molecule Viewer

From the Molecule Viewer, you can transfer the Gateway® vector to the workspace. Go to the Cloning>Gateway Cloning menu and select Add Molecule to Workspace as Vector. The Gateway® Cloning workspace window will be displayed and the selected sequence will be listed in the Vector field.

Creating the New Molecule

After you have added a compatible insert to the Insert field and a compatible vector to the Vector field, the Clone button in the Molecule Construction workspace will become active. If you select incompatible inserts and/or vectors, an alert message will appear in the left-hand pane of the Molecule Construction workspace, and you will be prompted to select different inserts/vectors.

Click on Clone to create the new molecule. The molecule will open in a new Molecule Viewer window. Use the Save command in the Molecule Viewer to save the new molecule. Information about the New Molecule

Any features from the constituent molecules will be preserved in the new molecule, except for features that are eliminated and added in the recombination reaction (e.g., the atth sites in an entry clone and attR sites in a destination vector will be eliminated and replaced by attB sites in the expression clone).

In addition to the standard information provided in the Molecule Viewer, the following information is provided for constructed molecules: In the Text Pane, the Design Description outlines the steps for the appropriate cloning reaction. In the Text Pane, the Component Fragments folder provides a description of each molecule fragment used to construct the molecule. Under each fragment, click on Open in Molecule Viewer to open the fragment in a new Viewer window (note that the fragment in the new Viewer window will not be saved).

Analysis of the New Molecule

You can analyze entry clones and expression clones using the open reading frame and sequence translation analysis tools in VectorDesigner to verify that the sequence has the correct reading frame and translation.

TOPO® Cloning

TOPO® technology uses the unique properties of vaccinia DNA topoisomerase I to mediate rapid, joining of PCR products into plasmid vectors. No ligase, post-PCR procedures, or PCR primers containing specific sequences are required. For more information, visit the TOPO® Cloning Web site on the World Wide Web at invitrogen.com.

Zero Blunt® TOPO® Cloning

Each Zero Blunt® TOPO® vector has Topoisomerase I covalently bound to both vector terminals. This allows blunt-end PCR products to ligate efficiently with the vector.

TOPO TA Cloning®

Tag DNA polymerase has a nontemplate-dependent terminal transferase activity that adds a single deoxyadenosine (A) to the 3′ ends of PCR products. Each TOPO® TA vector has overhanging 3′ deoxythymidine (T) residues and Topoisomerase I covalently bound to the vector terminals. This allows PCR inserts generated with Taq polymerase to ligate efficiently with the vector.

Directional TOPO® Cloning

In this system, PCR products are directionally cloned by adding four bases to the forward primer (CACC). The TOPO®-charged overhang in the cloning vector (GTGG) invades the 5′ end of the PCR product, anneals to the added bases, and stabilizes the PCR product in the correct orientation. Inserts can be cloned in the correct orientation with efficiencies equal to or greater than 90%.

TOPO® Cloning

VectorDesigner provides automated tools for in silico construction of expression clones from DNA sequences using TOPO® cloning technology. You can construct clones using TOPO® TA Cloning, Directional TOPO® Cloning, and Blunt TOPO® Cloning methods.

In VectorDesigner, you first design and select the sequences (typically PCR products) and TOPO® vectors that you want to use to create the new expression clone and add them to the TOPO® Cloning workspace. When you click on Clone, VectorDesigner will automatically recombine the sequences and generate and display the new molecule.

The tools for in silico TOPO® Cloning are located in the TOPO® Cloning workspace in the main VectorDesigner window. Click on the TOPO® Cloning tab to view the workspace.

To construct molecules, you must first design and/or select an insert and a vector: The insert should be a DNA sequence—typically a PCR product in TOPO® applications—configured for the type of TOPO® Cloning you want to perform (e.g., TA, Directional, Blunt). The vector should be an appropriate TOPO® vector. Files of TOPO® vectors are included in the Invitrogen Vectors>TOPO Vectors folder in VectorDesigner.

Selecting Inserts

Inserts must be linear DNA sequences. They can be: PCR products—see Designing Primers and Primer Designs and PCR Products for generating and selecting TOPO®-adapted PCR products; Linear DNA molecules—If you select a molecule with Blunt ends, use a Zero Blunt® TOPO® Vector; with 3′ A overhangs, use a TOPO® TA Vector; or with a CACC sequence at one end, use a Directional TOPO® Vector or Zero Blunt® TOPO® Vector.

Selecting Inserts in the TOPO® Cloning Workspace

If the insert has been saved as a molecule in the VectorDesigner database, you can select it in the TOPO® Cloning workspace. Note that the insert must be saved in the DNA/RNAs folder or a subfolder. Click on the Browse in Insert button in the workspace. The window will expand, displaying navigation tools at the bottom. Using the folder tree in the left-hand part of the window, navigate to the folder containing your insert. Click on the insert name in the right-hand part of the window. The insert will be added to the Insert field in the workspace. (Note that you may need to scroll up in the window to view the Insert field.)

Selecting Inserts in the Molecule Viewer

The Molecule Viewer includes tools for designing TOPO®-adapted PCR products and transferring them to the TOPO® Cloning workspace. See Designing Primers. See Primer Designs and PCR Products for instructions on selecting a PCR product in the Molecule Viewer and adding it to the TOPO® Cloning workspace as an insert.

When you design primers for a molecule sequence using the tools on the Cloning>TOPO Cloning menu, you will be prompted to send the resulting PCR product directly to the TOPO® Cloning workspace. You can transfer an entire molecule to the workspace as an insert. In the Molecule Viewer, go to the Cloning>TOPO Cloning menu and select Add Molecule to Workspace as Insert. Note that the molecule must be linear for this command to be available. When you use any of the methods above, the TOPO® Cloning workspace window will be displayed and the selected sequence will be listed in the Insert field.

Selecting Vectors

Vectors must be linear TOPO® vectors, and must have compatible ends with the insert you select. Molecule files of top-selling TOPO® vectors are provided in the Invitrogen Vectors>TOPO Vectors folder in VectorDesigner.

Selecting Vectors in the TOPO® Cloning Workspace

If the TOPO® vector is in the VectorDesigner database, you can select it in the TOPO® Cloning workspace. Click on the Browse in Vector button in the workspace. The window will expand, displaying navigation tools at the bottom. Using the folder tree in the left-hand part of the window, navigate to the folder containing your vector. Click on the vector name in the right-hand part of the window. The vector will be added to the Vector field in the workspace. (Note that you may need to scroll up in the window to view the Insert field.)

Selecting Vectors in the Molecule Viewer

From the Molecule Viewer, you can transfer the TOPO® vector to the workspace. Go to the Cloning>TOPO Cloning menu and select Add Molecule to Workspace as Vector. The TOPO® Cloning workspace window will be displayed and the selected sequence will be listed in the Vector field.

Creating the New Molecule

After you have added a compatible insert to the Insert field and a compatible vector to the Vector field, the Clone button in the Molecule Construction workspace will become active. If you select inserts and/or vectors with incompatible termini, an alert message will appear in the left-hand pane of the Molecule Construction workspace, and you will be prompted to select different inserts/vectors. Click on Clone to create the new expression clone. The molecule will open in a new Molecule Viewer window. Use the Save command in the Molecule Viewer to save the new molecule. Information about the New Molecule Any features from the constituent molecules will be preserved in the new molecule, except for features that may be eliminated in the recombination reaction (e.g., a TA overhang feature).

In addition to the standard information provided in the Molecule Viewer, the following information is provided for constructed molecules: In the Text Pane, the Design Description outlines the steps for the appropriate cloning reaction. In the Text Pane, the Component Fragments folder provides a description of each molecule fragment used to construct the molecule. Under each fragment, click on Open in Molecule Viewer to open the fragment in a new Viewer window (note that the fragment in the new Viewer window will not be saved).

Analysis of the New Molecule

You can now analyze the expression clone using the open reading frame and sequence translation analysis tools in VectorDesigner to verify that the DNA sequence is inserted and will be expressed as intended.

CloneRanger™

You can search Invitrogen's online clone collection for a specific DNA target sequence using the online Web tool CloneRanger™. VectorDesigner can link to CloneRanger™ and automatically enter a selected target sequence into the search field.

To use CloneRanger™, in the Molecule Viewer dialog: Select the part of the molecule sequence that you want to search for, or make no selection if you want to search for the entire molecule sequence. Click on the CloneRanger button (CloneRanger) on the main toolbar, or select the command from the Tools menu. The CloneRanger™ Web site will open, and a BLAST search for the sequence will be automatically initiated. When the search is complete, the BLAST search results page will be displayed. At this point, you can: Use the tools in CloneRanger™ to select and order the desired clone; select the desired clone and click on Send to VectorDesigner to import the clone sequence back into VectorDesigner. See Importing Clones for more information.

Importing Clones from CloneRanger™

If you have identified one or more clones containing your sequence of interest in Invitrogen's CloneRanger™ Web tool, you can click on Send to VectorDesigner in the CloneRanger™ results page to import the clone sequence(s) into VectorDesigner for analysis.

After you click on Send to VectorDesigner in CloneRanger™, the Import Clones window will open in VectorDesigner. In the window, the Clone ID, Sequence, and Collection for each clone will be displayed in the right-hand pane. In the left-hand folder tree, select the folder or subfolder in which to save the clone sequence(s). Clone sequences can be saved as DNA molecules in the DNA/RNAs main user folder or subfolders. To create a new folder, select the Create a New Folder checkbox and enter the folder name in the field. Select the appropriate option under If Object Already Exists—Rename, Overwrite, or Do Not Import. If you select Rename, and the object name already exists in the database, VectorDesigner will automatically rename the new molecule with a numerical extension (1, 2, 3, etc.). When you have made your selections, click on Import. The Import Results page will confirm the results of the import. Click on Return to Database Browser to go to the Database Browser window. At this point you can navigate to the folder in which you saved the clone(s) and open each clone in a Molecule Viewer window. Clones are imported as linear DNA molecules.

OligoPerfect™ Designer

You can design primers for molecule construction and other applications using tools within VectorDesigner (see Designing Primers), or you can send a target DNA sequence from VectorDesigner to the online Web tool OligoPerfect™ Designer to design and order primers. OligoPerfect™ Designer has its own primer design algorithms and procedures. See the OligoPerfect™ Web page and online Help for detailed information and instructions.

To input a target sequence into OligoPerfect™, in the Molecule Viewer dialog: Select the part of the molecule sequence for which you want to design primers, or make no selection if you want to design primers for the entire molecule sequence. Click on the OligoPerfect button (OligoPerfect) on the main toolbar, or select the command from the Tools menu. The OligoPerfect™ Web site will open, and the sequence you selected will be entered in the Target Sequence field. Your login name and the name of the target sequence will also be automatically entered. The OligoPerfect™ Designer will guide you through the primer design process.

In the primer design results page, you can: Select and order the desired primer designs. Select the desired primer designs and click on Send to VectorDesigner to import the primer sequence(s) back into VectorDesigner. See Importing Primers for more information.

Importing Primers from OligoPerfect™

If you have identified primer designs for your sequence of interest using Invitrogen's OligoPerfect™ Designer, you can click on Send to VectorDesigner in the OligoPerfect™ results page to import the primer sequence into VectorDesigner for analysis.

After you click on Send to VectorDesigner in OligoPerfect™, the Import Primers window will open in VectorDesigner. In the window, the primer name, sequence, and other information from OligoPerfect™ will be displayed in the right-hand pane. In the left-hand folder tree, select the database folder or subfolder in which to save the primer sequence(s). Primers can be saved in the Primers main user folder or subfolders. To create a new folder, select the Create a New Folder checkbox and enter the folder name in the field. Select the appropriate option under If Object Already Exists—Rename, Overwrite, or Do Not Import. If you select Rename, and the object name already exists in the database, VectorDesigner will automatically rename the new molecule with a numerical extension (1, 2, 3, etc.). When you have made your selections, click on Import. The Import Results page will confirm the results of the import. Click on Return to Database Browser to go to the Database Browser window. At this point you can navigate to the folder in which you saved the primers and open them in the Edit Primer Properties dialog.

Performing a BLAST Search

BLAST (Basic Local Alignment Search Tool) searches compare the similarity of a particular DNA or protein sequence to verified gene and protein sequences in multiple public databases. For detailed information on BLAST search types, settings, parameters, search databases, etc., see the BLAST search information page at NCBI.

Using VectorDesigner, you can automatically perform a BLAST search of NCBI databases for all or part of a nucleotide or protein molecule sequence. In the Molecule Viewer window: Select the part of the sequence-that you want to search for, or make no selection if you want to search for the entire molecule sequence. Click on the BLAST Search button (blast) on the main toolbar, or select the command from the Tools menu. The BLAST Search dialog will open. In the dialog, under Sequence Range, select Whole Sequence to search for the whole sequence, or Selection Only to search for a portion of the sequence you have selected. Under Sequence Strand, select Direct to search for the direct strand sequence, or Complementary to search for the complementary strand sequence. Under BLAST Page, select the type of database you want to search. See the NCBI BLAST search page for more information on the different search types. For protein sequences, you can search Proteins or Translations databases. For nucleotide sequences, you can search Translations, Nucleotides, or MegaBLAST databases. When you have made your selections, click on OK. The search window for the selected NCBI database will open, and the sequence will appear pasted in the search field. Select any additional search parameters in this window and perform the search.

Analysis Pane

The Analysis Pane displays graphical plots of a variety of a DNA and protein sequence analyses. You can display multiple plots at a time in the Analysis Pane. The available analyses depend on the molecule type (DNA/RNA or protein). The Analysis Pane and the Graphics Pane are displayed in the same pane in the Molecule Viewer. The Graphics Pane is displayed by default. To display the Analysis Pane, click on the Analysis Pane button below the Graphics Pane. To return to a view of the Graphics Pane, click on the Graphics Pane button

Graph Format

The graphs in the Analysis Pane display different physiochemical properties of the sequence. Many of properties are based on parameters like charge that exert effects over distance. Other properties represented in the plot depend on the way adjacent bases/amino acids fold in 3-dimensional space, which is a function of the sequence itself.

The vertical (Y) axis in the graph shows the values of the analysis results; the horizontal (X) axis displays either numerical positions in the sequence or residues. At any point along the sequence, the Y value is derived not just from the specific residue at that point but also from adjacent residues. Each analysis algorithm uses an optimum window of adjacent residues to calculate the value for a point. You can adjust this window size in the Plot Properties dialog (see below).

Plots Setup

Use the Plots Setup dialog to select and arrange the analysis graphs to display in the pane. To open the dialog, click on the Plots Setup button below the Analysis Pane or select the command from the right-click menu. In the Plots Setup dialog, the available analyses are listed in the top window and the selected graphs are listed in the bottom window. Analysis graphs are displayed in panels. You can add one or more analyses to a panel, and display multiple panels in the Analysis Pane.

To add analyses to panels: Click on an analysis name in the Available Analyses window to select it. To select multiple graphics, use Control+Click and Shift+Click key combinations. Click on the Copy Analyses button next to the top window. In the bottom window, click on a panel name in the folder tree or create a new panel by clicking on the Create New Panel button. The panel will be selected in the tree. Click on Paste Analyses to Panel to add the analysis or analyses to the panel. Note that if you paste multiple analyses to the same panel, they will be displayed in the same graph in the Analysis Pane.

To remove a panel: Click on the panel in the bottom window. Click on Remove Panel (ELJ). All the analyses in the panel will be removed as well.

To copy an analysis between panels: Select the analysis to copy in the bottom window. Click on the Copy Analyses button next to the bottom window. Select the panel you want to copy the analysis to, and click on Paste Analyses to Panel.

To delete an analysis from a panel: Click on the analysis to select it. Click on Remove Analysis. To reorder panels in the Analysis Pane: Click on a panel in the bottom window. Use the arrow buttons next to the bottom window to reorder the panels. When you have arranged the analyses and panels in the dialog, click on OK to display them in the Analysis Pane.

Displaying Analyses in the Analysis Pane

The Analysis Pane window includes various viewing tools: To select a region of the sequence in both the Analysis Pane and the Sequence Pane, drag your cursor over the sequence in either pane. Double-click on a feature in the Text Pane to select that region of the sequence in the Analysis Pane. To zoom in on the graphs, click on the Zoom In button. To zoom out, click on the Zoom Out button. To magnify a region of the graphs, drag your cursor to select the region, then click on the Zoom Selection to Window button. To fit the graphs lengthwise to the current window, click on Fit to Window button. To fit the graphs vertically to the current window, right-click in the pane and select Fit to Size. To make the panels all the same size within the window, right-click in the pane and select Distribute Panels. To hide or show the axes in the graphs, click on the Hide/Show Axes button. To change the display of each plot in the Analysis Pane, see Plot Properties, below.

Plot Properties

The Plot Properties dialog controls how each plot is displayed in the graph. To open the dialog, right-click on an graph in the Analysis Pane and select Plot Properties. The dialog is divided into three tabs. When you have made your selections, click on OK.

Diagram Tab

Click on the Graph Color button to open a dialog in which you can select a plot color and/or adjust the Red-Green-Blue (RGB) values of the color. Select the Draw Type from the dropdown list. Min-Max-Average displays the calculated minimum, maximum, and average values over each analysis region within the sequence as levels of shading along the line of the graph. Under Preprocess Type, select Linear Interpolation to provide a linear interpolation of the graph line, or No Preprocessing to display the line without interpolation.

Params Tab

Window Size is the size of the processing “window” used to scan the sequence for analysis. Enter a number of bases/amino acids in the Window Size field (see example below). Step Size is the number of bases/amino acids in a sequence that constitute an analysis point in the plot. Enter number of bases/amino acids in the Step Size field. For example, if you select a % GC Content analysis with a window size of 21 and a step size of 1, the GC content percentage will be calculated for a 21-base region centered on each base in the sequence (10 bases on either side of the base). A step size of 5 would calculate the percentage for a 21-base region centered on each 5-base region in the sequence.

The Info tab provides information on the type of analysis in the plot, including any references to external literature.

Links to Resources and Ordering: Links to Additional Resources

VectorDesigner includes built-in links to Web tools, Web sites, download pages, and product ordering pages.

Links to Web Tools and Software Downloads

From the Software>Desktop Products menu, select: Information on Desktop Software to link to a Web page with information on Invitrogen's suite of bioinformatics software, including VectorNTI Advance™ for molecule construction, analysis, and databasing; Vector Xpression™ for microarray analysis and databasing; and Vector PathBlazer™ for biological pathways analysis. Download VectorNTI Advance for PC to link to a download page for VectorNTI Advance™ for the Microsoft Windows® operating system. Download VectorNTI Suite for Mac OS X to link to a download page for VectorNTI Suite™ for the Macintosh® OS X operating system. Download Vector Xpression 3.0 to link to a download page for Vector Xpression™ 3.0 software for Microsoft Windows®. Download Vector PathBlazer to link to a download page for Vector PathBlazer™ software for Microsoft Windows®.

From the Software>Web Tools menu, select: RNAi Designer to design custom RNAi molecules, including Stealth™ RNAi oligos, for gene knockdown experiments; Peptide Designer to design custom peptides from a protein target sequence; LUX Designer to design custom LUX™ Primer sets from a DNA target sequence for real-time quantitative PCR and RT-PCR applications. Additional Web tools are listed under the Tools menu and include the following: BLAST Search; OligoPerfect Designer; CloneRanger.

Links to Molecule Information

Certain types of imported molecules and example molecules from Invitrogen include links to additional information: Text Pane: The Links folder in the Text Page of the Molecule Viewer provides a list of links to additional online resources for the molecule. The Feature Map folder may also contain Links folders in the individual Feature folders with links to information about each feature. The Imported Features Not Shown on Map folder may also contains Links folders for individual features. Double-click on a link to open it. Feature List: Right-click on a feature in the list and select Open Link to access a list of links to online databases with information about the feature. Select a link from the list to open it. A link can launch a new browser window or an email application. Note that you cannot create new links using VectorDesigner.

Links to Invitrogen Products

You can order primers, vectors, restriction enzymes, and related products from Invitrogen using links in VectorDesigner.

For example, the user can order primer designs from the Molecule Viewer, or you can order saved primers from the Database Browser. If you have primer designs in the Molecule Viewer, go to the PCR Primers folder in the Text Pane, open the Product folder containing the designs, and click on the Order from Invitrogen link next to each primer name. You will be prompted to use the existing primer name or enter a new one (this will not change the primer name in the Molecule Viewer), and the primer sequence will automatically be loaded into Invitrogen's ordering system. You can specify the details of your order (purity, synthesis scale, etc.) on the Web site.

If you have saved primers in the VectorDesigner database, go to the Primers folder in the Database Browser, select the checkbox next to each primer that you want to order, and click on the Order button. Each primer sequence will automatically be loaded into Invitrogen's online ordering system. You can specify the details of each primer order (purity, synthesis scale, etc.) on the Web site.

Vectors

You can order Invitrogen vectors and related products from VectorDesigner. VectorDesigner also provides ordering links for molecules constructed from Invitrogen vectors. In the Database Browser, an Add to Cart button will be available in the Order column for each Invitrogen vector or vector constructed from an Invitrogen vector. Click on the button to open an Invitrogen catalog page with information about products related to the vector. In the Molecule Viewer, an Invitrogen Products link will be available in the Text Pane for each Invitrogen vector or vector constructed from an Invitrogen vector. Click on the link to open an Invitrogen catalog page with information about products related to the vector.

Restriction Enzymes

Restriction enzymes sold by Invitrogen will be flagged by a symbol in the Restriction Map folder of the Text Pane. Click on the Order from Invitrogen link next to the enzyme name to open an Invitrogen catalog page with information about that enzyme.

Registration

The user may be prompted to fill out the information in the Registration form and create a User Name and Password to use VectorDesigner. The User Name and Password will give you secure access to all the molecules in the VectorDesigner database. The molecules in your private user folders will only be accessible using your User Name and Password.

Browser and Operating System Requirements

VectorDesigner is supported on various operating systems, Internet browsers, and Java systems:

Java Applet and Security Warning

VectorDesigner uses a Java applet to display viewers and dialog boxes. In order for the Java applet to run, it may require access to files and other resources on your computer. Depending on the permissions settings for your computer or your network system, you may receive a Security Warning when the Java applet initializes.

Security

All molecule sequences, user information, and other data are encrypted during transmission and transmitted via a secure socket layer (SSL). They are stored in encrypted form on our secure servers behind multi-tiered firewalls. Sequences in the private user folders are accessible only if you log in with the correct user name and password.

Privacy

For detailed information about Invitrogen's privacy policy, click on the Privacy Policy link at the bottom of any page in the VectorDesigner.

Dialog Boxes and Notes Add/Edit Feature

Use this dialog to define the various features in a molecule, including promoter regions, open reading frames, binding sites, epitopes, or any other region of interest. In the dialog, the Feature Type field lists the available feature types in the database for the molecule. Select a feature type from the list. If you cannot find the precise type you are looking, select Misc. Feature. Note that you cannot add new feature types in VectorDesigner. Enter a name for the feature in the Feature Name field. Select the format to use for defining the sequence region: Use Start.End Format or Use Start . . . Length Format. If you selected or marked the feature region in the sequence before opening the dialog, the start and length/endpoint of the feature will be automatically entered in the dialog. To change the region, enter the start and length/endpoint in the fields. For features with multiple components (i.e., internal start and endpoints), select Multi-component and enter each start and length/endpoint in the field. Use the following format: <start1> . . . <length/endpoint1>, <start2 . . . length/endpoint2>, etc.

Click on Reset to Selection to undo any changes you may have made to a preselected sequence region. Click on Reset to Mark to undo any changes you may have made to a marked sequence region. Select the Complementary checkbox if the feature is located on the complementary molecule strand. Note: VectorDesigner uses the currently accepted convention for calculating the coordinates of complementary features. All coordinates are given as if on the direct strand, from left to right in the sequence. Enter a description for the feature in the Description field. When you have made your selections, click OK to add the feature.

Annotate Analysis dialog

Use this dialog to define an open reading frame, restriction fragment, or primer as a feature. In the dialog: Select the feature type from the Feature Type dropdown list; enter the feature name in the Feature Name field; enter a description in the Description field; click on OK. The feature will be added to the feature map. For primers and ORFs, if you want to alter the start and/or endpoint of the sequence before defining it as a feature, right-click on the primer or ORF and select Annotate Analysis Item. This will open the Add/Edit Feature dialog, in which you can change the start/endpoint of the feature.

BLAST Search

Use this dialog to perform a BLAST search of NCBI databases for all or part of a nucleotide or protein molecule sequence. In the dialog: Under Sequence Range, select Whole Sequence to search for the whole sequence, or Selection Only to search for a portion of the sequence you have selected. Under Sequence Strand, select Direct to search for the direct strand sequence, or Complementary to search for the complementary strand sequence. Under BLAST Page, select the type of database you want to search. See the NCBI BLAST search page for more information on the different search types. When you have made your selections, click on OK. The search window for the selected NCBI database will open, and the sequence will appear pasted in the search field. Select any additional search parameters in this window and perform the search.

Browse to Primer Folder

Use this dialog to locate the database folder containing the desired primer sequences. Highlight the folder in the directory tree and click on OK to select the folder. Choose Direct/Complementary Strand Addition

Use this dialog box to add any additional nucleotides or specific sequences to the 5′ end of the direct or complementary primer. Access this dialog by clicking on the Browse button next to the Direct and/or Complementary fields in the PCR Analysis dialog. In the dialog, you can select from any or all of the following options: Type the nucleotides you want to add directly into the field. Double-click on one or more defined sequences in the table below the field. If you double-click on more than one defined sequence, the defined sequences will be added to the field above 5′ to 3′ in the order in which you select them. You can then edit the complete sequence in the field. To add a restriction endonuclease cut site at the 5′ end of the sequence addition, select the Add One REN Site 5′ to the Additions Above checkbox, and select the restriction enzyme from the list below. Depending on the length of the cut site sequence, a pop-up box may prompt you to add nucleotides to the site to improve efficiency of the REN cleavage. Note that you can only add a single restriction site to the 5′ end of the primer using this method. When you have made your selections, click on OK. The sequence additions will be displayed in the PCR Analysis dialog.

Create New Folder

Use this dialog to create new subfolders within the three main user folders in the database. Enter the new folder name in the Name field and a folder description in the Description field. Click on Save to create the folder.

Molecule

Use this dialog to create a new molecule based on the molecule currently displayed in the Molecule Viewer. You can create a new molecule from a selected area of the existing molecule, such as a restriction fragment, or from the whole molecule. From DNA or RNA molecules, you can create DNA/RNA molecules that are the reverse complement of the existing molecule or you can create protein molecules from a translation of the sequence.

In the dialog: Enter a name for the new molecule in the Name field, and a description (if any) in the Description field. Next, specify which part of the existing molecule to use as the basis for the new molecule. If you selected or marked a region of the existing molecule before you opened the dialog, the Selection or Mark options will be available and selected. Otherwise, select Molecule to select the whole molecule or Specified Range to enter the sequence range in the From and To fields. DNA/RNA molecules only: Select the Reverse Complement checkbox to create a molecule from the complementary sequence. Select Translate to create a protein molecule from a translation of the sequence. When you have made your selections, click on OK. The new molecule will be created and displayed in a new Molecule Viewer window. The new molecule will not be saved. To add the molecule to the database, you must save it.

Edit Primer Properties

The Edit Primer Properties window displays the sequence, name, and description of each primer that has been saved as a separate molecule in the VectorDesigner database. Note that primer designs generated using the tools in the Molecule Viewer are saved with the DNA molecule file (see Primer Designs and PCR Products for more information). Primers saved as separate primer files are stored in the Primers folder in the VectorDesigner database. To open a primer file, click on the primer name in the Primers folder in the Database Browser. The Edit Primer Properties window includes Name, Description, and Sequence fields. You can edit the text in any of these fields.

To order the primer sequence from Invitrogen, click on the Order button in the window. The primer sequence will automatically be loaded into Invitrogen's online ordering system, where—you can specify the details of your order (purity, synthesis scale, etc.). To save any changes you make to the name, description, or sequence, select Rename or Overwrite to specify whether you want to rename the saved file or overwrite the existing file. Then click on the Save button. If you select Rename, the primer will automatically be saved with the existing name plus a numerical extension (1, 2, 3, etc.).

Enzymes List Dialog

The Enzymes List dialog enables you to create a custom list of restriction enzymes to use in restriction mapping. In the dialog, the Customized List lists enzymes that have been selected for use, while the All Enzymes list shows the remaining unselected enzymes in the database. The enzymes are listed alphabetically.

To add or remove enzymes from the Customized List. Click on an enzyme in one of the lists to select it. Use Shift-Click and Control-Click key commands to select multiple enzymes in the list. Click on Add to move the selected enzymes from the All Enzymes list to the Customized List. Click on Remove to remove the selected enzymes from the Customized List. Alternatively, click on Add All to move all the enzymes to the Customized List, or Remove All to remove them from the list. Click on OK to accept your changes.

Export to File Dialog

Use the Export to File dialog to export the data for the molecule to a file (text format) or to a separate browser window (HTML format): In the dialog, select either Show in Browser or Save Single Object to File. Select the export format (GenBank, FASTA, etc.) and click on OK. If you selected Save Single Object as File, you will be prompted to save the file or open it in a application window. The data will be exported as an ASCII text file. If you selected Show in Browser, the exported file will be displayed in HTML format a separate browser window.

Export to GIF Dialog

Use the Export to GIF dialog to export the molecule image as it is displayed in the Molecule Viewer as a GIF image. Note: This command will export only the current view of the molecule. If the displayed information (sequence, graphics, text, etc.) is cut off at the margins of the panes in the Molecule Viewer, the data will appear cut off in the resulting image. Be sure to configure your Molecule Viewer panes as desired-for the resulting image. With your molecule displayed in the Viewer, go to the Molecule menu and select Export to GIF. In the Export to GIF dialog, select Whole Viewer to export an image of the entire Molecule Viewer window, or select the specific pane that you want to export. Select Draw Border to include a border line around the image. If you are exporting the Graphics Pane only, select Graphics Only if you do not want to include the toolbar at the bottom of the pane. When you click on OK, you will be prompted to save the GIF file or open it in an application window.

Map is Updated

If you make changes to a molecule sequence in the Molecule Viewer, and those changes affect defined features in the molecule, the Feature Map is Updated dialog will open. In this dialog you can remove any or all of the defined features that will be changed. Note that this will not alter the change that you are making to the sequence; it will only remove the defined feature(s) affected by the change.

In the dialog, the affected features are listed. Select a feature in the list and click on Delete to flag it for deletion. To delete all the features in the list, click on Delete All. If you change your mind, select the feature flagged for deletion and click on Keep, or click on Keep All to keep all features. Click on OK to make the sequence change. If you flagged a feature for deletion in the dialog, that feature will be removed.

Find Sequence

Use this dialog to find a sequence within a larger sequence. In the dialog, type or paste the sequence you want to find, specify the search direction (Up or Down), and click on Find Next. Click on Find Next again to find the next occurrence of the sequence within the larger sequence. Click on Close to close the dialog.

Frequently Used Enzymes

AccI, AM, Apal, Aval, BamHI, Bglll, Clal, Ddel, Dpnl, Dral, EcoRI, EcoRV, Haelll, Hhal, Hindi, Hindlll, Hinfl, Hpal, Hpall, Kpnl, Mbol, Mlul, MscI, Msel, Ncol, Ndel, Nhel, NotI, Nrul, Nsil, PinAI, PstI, Pvul, PvuII, Rsal, Sail, Seal, Smal, Spel, SphI, Sspl, SstI, Sstll, StuI, TaqI, Xbal, Xhol

Gateway® Cloning PCR Products

In the PCR Analysis: Gateway Cloning dialog, VectorDesigner will add attB extensions to the direct and complementary primers to generate the af/B-PCR product required for BP recombination into a Gateway® entry clone. Note that which extensions are added to the direct and complementary primers will depend on your Cloning Strand selection. Consult the Gateway® Technology manual for more information about designing primers for Gateway® cloning.

Gateway® cloning will automatically add a 5′ sequence to the forward primer consisting of four guanine (G) residues at the 5′ end followed by a 25-bp attB1 site. It will also add a 5′ sequence to the reverse primer consisting of four G residues at the 5′ end followed by a 25-bp attB2 site. See Important Note About Reading Frames for details on preserving the reading frame in af/B-PCR products. TABLE-US-00001 (SEQ ID NO:10)

attB1 Forward primer:
(SEQ ID NO: 11)
5′-GGGG-ACA-AGT-TTG-TAC-AAA-AAA-GCA-GGC-T--
(template-specific sequence)-3′
atiB1 Reverse primer:
5′-GGGG-AC-CAC-TTT-GTA-CAA-GAA-AGC-TGG-GT--
(template-specific sequence)-3′

Note about Reading Frames

For cloning applications, if you want to fuse your PCR product in frame with an N- or C-terminal peptide tag in the vector, you may need to add bases to the PCR primers to maintain a continuous reading frame between the tag and the insert. To add bases to the primers, use the Choose Direct/Complementary Strand Addition dialog box.

Gateway Cloning Examples: In Gateway® cloning, to fuse your a<<B-PCR product in frame with an N-terminal tag, you must add 2 bases immediately after the attBl addition (i.e., at the 3′ end of the addition). These two nucleotides cannot be AA, AG, or GA, because these additions will create a translation termination codon. To fuse your attB-PCR product in frame with an C-terminal tag, you must add 1 base immediately after the attB2 addition (i.e., at the 3′ end of the addition), and you must eliminate any stop codons between the a//B2 site and your gene of interest. If you do not want to fuse the PCR product in frame with a C-terminal tag, your gene of interest or the primer must contain a stop codon. To add a stop codon to the primer, use the Choose Direct/Complementary Strand Addition dialog box.

Insert Sequence

Use this dialog to insert a new sequence into an existing sequence in the Molecule Viewer. First, be careful to click at the point in the existing sequence where you want to insert the new sequence. In the dialog, note the insertion point listed below the field. Type or paste the new sequence into the dialog and click on OK. Note: Use only standard code letters when entering the sequence. Nonstandard characters will be marked with a ? in the Insert Sequence dialog and you will be prompted to remove them before adding the new sequence. If you are adding the sequence within a defined feature, the Feature Map is Updated dialog will open, listing the features in the molecule that will be affected by the insertion. In this dialog you can remove any or all of the defined features that will be changed. Note that this will not alter the change that you are making to the sequence; it will only remove the defined feature(s) affected by the change. Click on OK to make the changes.

MegaBLAST uses a “gTeedy algorithm” (Webb Miller et al., J Comput Biol February-April; 2000 7(1-2):203-14) for nucleotide sequence alignment searches and concatenates many queries to save time scanning the database. It is optimized for aligning sequences that differ slightly and is up to 10 times faster than more common sequence similarity programs. It can be used to quickly compare two large sets of sequences against each other. MegaBLAST permits searching with batches of ESTs or with large cDNA or genomic sequences.

Molecule Construction PCR Products

In the PCR Analysis: Molecule Construction dialog, under Cloning Termini, if you select: Blunt: No extensions or overhangs will be automatically added; TA: 3′ A extensions will be automatically added to both ends of the PCR product, for TA cloning into an appropriate linearized expression vector with T overhangs. Note that no extensions will be added to the primers. Rather, VectorDesigner will account for the nontemplate-dependent terminal transferase activity of Taq DNA polymerase that adds a single deoxyadenosine (A) to the ends of the PCR products.

ORF Search

Use this dialog to identify open reading frames (ORFs) in a DNA molecule. Using the tool, you set the minimum ORF size, the start and stop codons to search for, and other parameters, and VectorDesigner will generate a list of defined ORFs and highlight them in the sequence. In the ORF Search dialog: Specify the Minimum ORF Size (in codons) and select the Nested ORFs checkbox if you want to search for nested ORFS (ORFs that have the same stop codon but different start codons). In Start Codons and Stop Codons fields, enter one or more start and stop codons to search for when identifying ORFs. Separate each codon by a space. To reset the fields, click on Reset to Default. Select Include Stop Codon in ORF if you want the stop codon to be considered part of the ORF. Otherwise, the stop codon will not be included in each ORF defined in the sequence. Click on OK to search for the ORFs. The ORFs will be marked on the sequence in the Graphics Pane and a folder called Open Reading Frames will be created in the Text Pane.

PCR Analysis

Use this dialog to design PCR primers from a target sequence for cloning applications (including TOPO® Cloning and Gateway® Cloning) or PCR analysis of a DNA molecule fragment.

In the dialog, the default values and available options will different slightly depending on the application you selected (these differences are noted below). Under the Primer Definition and Construction tab, the From and To fields define the region that will be analyzed for primer designs. You can change the numbers in these fields.

Next, enter the primer design parameters, or select the folders containing the saved primers that you want to evaluate for compatibility with the molecule sequence. The following fields are only available if you selected Design Primers to Amplify Selection when you opened the dialog: To include primer design regions before and after the target sequence, enter a number of bases in the Before and After fields. Maximum # of Outputs: Enter the maximum number of primer pair designs to generate. Note that VectorDesigner may generate fewer designs if no more can be found. Tm: Enter the limits in degrees Celsius for primer melting temperature (Tm) (temperature at which 50% of primer is a duplex) in the Minimum and Maximum fields. Designs with Tin's outside this range will be excluded. % GC: Enter the maximum and minimum percent GC content for the primers in the fields. Designs with a percent GC content outside this range will be excluded. Length: Enter the maximum and minimum length (in bases) of each primer in the fields. Designs that fall outside this range will be excluded. Nucleotide sequences such as RENs attached to a primer's 5′ end are included when calculating primer length. Exclude Primers with Ambiguous Nucleotides: If your sequence includes ambiguous bases (i.e., code letters other than A,G,C,T), select this checkbox to exclude regions containing these bases from the primer design search.

The following fields are only available if you selected Find Amplicon in Sequence Using Existing Primers when you opened the dialog: Click on the Direct button to select the folder containing the direct primers that you want to evaluate, and click on Complementary to select the complementary primers to evaluate. The Browse to Primer Folder dialog will open when you click on each button. Select the folder and click on OK. Enter a percentage similarity in the Similarity>=Threshold field. Each primer sequence must be at least this similar to the molecule sequence to be selected by the designer. Select the checkbox next to LastNucleotides Must Have 100% Similarity to specify a number of nucleotides at the 3′ end of each primer that must be 100% similar to the target sequence. Enter a number of nucleotides in the field.

Next, select the conditions of the PCR reaction you are performing. If you are unsure of these values, use the default values: Salt cone: The salt concentration of the PCR reaction, in mMol. If you are unsure, use the default value of 50.0. Probe cone: The final concentration of each primer in the reaction, in pMol. If you are unsure, use the default value of 250.0. dG temp: The temperature of the free energy value of the reaction, in degrees Celsius. If you are unsure, use the default value of 25.0.

Under Cloning Termi, select the type of PCR product you are generating. The available options will vary depending on your cloning application. Click on an application below for more information on how the primer and/or PCR product will be modified based on your selection: e.g., TOPO® Cloning PCR Products; Gateway® Cloning PCR Products; Molecule Construction PCR Products.

For cloning applications, under Cloning strand, select the strand whose sequence will be expressed: Direct or Complementary. Note that this will affect the primer strand to which Directional TOPO®, Gateway®, and other primer additions are added.

Next, select additions to each primer. Click on the Browse button next to the Direct and/or Complementary fields. The Choose Direct/Complementary Strand Addition dialog will open. Select the strand additions in the dialog and click on OK. The additions will be listed in the appropriate field. Additions to the primer sequence will not be used in calculations of primer Tm, % GC, etc. If you change the Cloning Strand (step above) after selecting the primer additions, the additions will switch to the other strand.

Click on the Pairing, Structure and Uniqueness tab to access additional primer specifications. Max. Tm Difference: Specify the maximum difference in melting temperature between sense and antisense primers in degrees Celsius. Note the differences in GC content between the two primer regions of the sequence when specifying this difference; a difference that is too small may result in no primers being found. Max. % GC Difference: Specify the maximum percentage difference in GC content between sense and antisense primers. Note the differences in GC content between the two primer regions of the sequence when specifying this difference; a difference that is too small may result in no primers being found. Primer-Primer Complementarity: Permitted with dG>=: Select this checkbox and enter the minimum permitted value for free energy of a primer-primer duplex. Primer pairs which have a free energy value>/=to this number will be accepted. Primer-Primer Complementarity: 3′ End Permitted with dG>______=Select this checkbox and enter the minimum permitted value for free energy of complementarity between the 3′-end of the primers (the final 5 bases of each primer will be evaluated). Primer pairs which have a 3′-end complementarity free energy value>/=to this number will be accepted. Exclude Primers With: In the Repeat field, enter the maximum number of base-pair repeats allowed in each primer. In the Palindrome field, enter the maximum permitted length of palindromes in each primer sequence. In the Hairpin Loops field, enter the minimum permitted value for free energy of hairpin loops within each primer. Primer Uniqueness: Select this checkbox to reject primers above a certain percentage similarity to secondary sites within either the entire sequence or within the amplicon. Enter an percentage similarity in the field, and select Within Entire Sequence or Within Amplicon Only.

Click on OK to design the primers. You will be prompted to send the PCR product for the first (highest ranked) primer pair directly to the appropriate molecule construction workspace as an insert. If you click on No, all the primer pairs generated will be added to the PCR Primers folder in the Text Pane of the Molecule Viewer.

Plot Properties

The Plot Properties dialog controls how each plot is displayed in the Analysis Pane. The dialog is divided into three tabs. When you have made your selections, click on OK. Diagram Tab. Click on the Graph Color button (mm) to open a dialog in which you can select a plot color and/or adjust the Red-Green-Blue (RGB) values of the color. Select the Draw Type from the dropdown list. Min-Max-Average displays the calculated minimum, maximum, and average values over each analysis region within the sequence as levels of shading along the line of the graph. Under Preprocess Type, select Linear Interpolation to provide a linear interpolation of the graph line, or No Preprocessing to display the line without interpolation.

Params Tab

Window Size is the size of the processing “window” used to scan the sequence for analysis. Enter a number of bases/amino acids in the Window Size field (see example below). Step Size is the number of bases/amino acids in a sequence that constitute an analysis point in the plot. Enter number of bases/amino acids in the Step Size field (see example below).

For example, if you select a % GC Content analysis with a window size of 21 and a step size of 1, the GC content percentage will be calculated for a 21-base region centered on each base in the sequence (10 bases on either side of the base). A step size of 5 would calculate the percentage for a 21-base region centered on each 5-base region in the sequence.

The Info tab provides information on the type of analysis in the plot, including any references to external literature.

Plots Setup

Use the Plots Setup dialog to select and arrange the analysis graphs to display in the Analysis Pane. In the Plots Setup dialog, the available analyses are listed in the top window and the selected graphs are listed in the bottom window. Analysis graphs are displayed in panels. You can add one or more analyses to a panel, and display multiple panels in the Analysis Pane.

To add analyses to panels: Click on an analysis name in the Available Analyses window to select it. To select multiple graphics, use Control+Click and Shift+Click key combinations. Click on the Copy Analyses button next to the top window. In the bottom window, click on a panel name in the folder tree or create a new panel by clicking on the Create New Panel button. The panel will be selected in the tree. Click on Paste Analyses to Panel to add the analysis or analyses to the panel. Note that if you paste multiple analyses to the same panel, they will be displayed in the same graph in the Analysis Pane.

To remove a panel: Click on the panel in the bottom window. Click on Remove Panel. All the analyses in the panel will be removed as well.

To copy an analysis between panels: Select the analysis to copy in the bottom window. Click on the Copy Analyses button next to the bottom window. Select the panel you want to copy the analysis to, and click on Paste Analyses to Panel B

To delete an analysis from a panel: Click on the analysis to select it. Click on Remove Analysis.

To reorder panels in the Analysis Pane: Click on a panel in the bottom window. Use the arrow buttons next to the bottom window to reorder the panels. When you have arranged the analyses and panels in the dialog, click on OK to display them in the Analysis Pane.

Restriction Map Search

Use this dialog to identify the restriction enzyme cut sites in a DNA molecule using a built-in database of restriction enzymes. In the dialog: Select the category of enzymes that you want to use from the Use Enzymes list: Frequently Used Enzymes have been identified by Invitrogen. Click here for a list. 7+Cutters, 6 Cutters, 5 Cutters, etc. refer to the number of base pairs in the recognition site of each enzyme. Enzymes in the 5′ Overhang category result in fragments with a 5′ overhang; enzymes in the 3′ Overhang category result in fragments with a 3′ overhang. If you select Customized, click on the Customize button to select the particular enzymes you want to use. The Enzymes List dialog will open. Next, enter a number in the Display Enzymes with <=Recognition Sites field. The Designer will analyze the sequence and use only those enzymes with less than or equal to that number of cut sites. Alternatively, select Unlimited to not filter the enzyme list by number of cut sites. 4. When you have made your selections, click on OK.

Save As

In the Save As dialog: Click in the folder tree to select the folder or subfolder where you want to save the molecule. Note that the molecule type determines which main user folder you can save it in (e.g., DNA/RNA molecules can only be saved in the DNA/RNAs folder or subfolders; primers can only be saved in the Primers folder or subfolders). To create a new subfolder within the main folder, click on Create New Folder and enter the information in the Create New Folder dialog. Enter a name for the molecule and click on OK to save it to the database. The new molecule will be listed in the Database Browser.

Sequence Properties

Use this dialog to change how the sequence is displayed in the pane. The dialog contains following display options:

Sequence Representation Styles

Multiline Fixed: Display a fixed number bases/amino acids per line on multiple lines, regardless of window size. (Dependent on Symbols in Group and Groups in Line settings.). Multiline Variable: Display a variable number of bases/amino acids per line on multiple lines, depending on window size. Single Line: Display a single line of bases/amino acids, regardless of window size. Show Direct Strand Only: DNA molecules only—Select this checkbox to show only the direct DNA strand in the pane. Symbols in Group: Enter the number of bases/amino acids to display in a group for ease of reading; dependent on Insert Gaps Between Groups to view the groups in the display. Groups in Line: Enter the number of groups to display on a line if the Multiline Fixed setting is selected. Insert Gaps Between Groups: Select this checkbox to insert a space between groups in the sequence.

Feature Representation Style

Show Direct Features: For protein molecules, select this checkbox to mark defined features in the sequence with colored bars above the sequence. For DNA molecules, this marks defined features on the direct strand with colored bars above the sequence. Show Complementary Features: For DNA molecules only, select this checkbox to mark defined features on the complementary strand with colored bars below the sequence. Feature Height: Enter a relative height scale (1-5) for feature bars as displayed in the Sequence Pane.

Selection

Use this dialog to select part of the sequence defined by the start and end bases/amino acids. Enter the number of the starting base/amino acid in the Start field and the ending base/amino acid in the End field and click on OK. The defined area will appear selected in the Graphics and Sequence Panes.

TOPO® Cloning PCR Products

In the PCR Analysis: TOPO Cloning dialog, under Cloning Termini, if you select: Blunt: No extensions or overhangs will be automatically added. PCR products generated using these primers are suitable for Zero Blunt® TOPO® PCR Cloning; TA: 3′ A overhangs will be added to both ends of the resulting PCR product. These PCR products are suitable for TOPO® TA Cloning. Note that no extensions will be added to the primers themselves. Rather, VectorDesigner will account for the nontemplate-dependent terminal transferase activity of Taq DNA polymerase that adds a single deoxyadenosine (A) to the ends of the PCR products. If the user selects Directional, a CACC sequence will be added to the 5′ end of the direct or complementary strand primer, depending on your Cloning Strand selection. PCR products generated using these primers are suitable for Directional TOPO® Cloning.

Types Filter

Use this dialog to filter the types of features highlighted in the Sequence Pane. In the dialog, deselect the checkboxes next to the filters that you do not want to view in the Sequence Pane, and click on OK to make the changes.

Various embodiments of the present invention have been described above. It should be understood that these embodiments have been presented by way of example only, and not limitation. It will be understood by those skilled in the relevant art that various changes in form and detail of the embodiments described above may be made without departing from the spirit and scope of the present invention as defined in the claims. Thus, the breadth and scope of the present invention should not be limited by any of the above-described exemplary embodiments, but should be defined only in accordance with the following claims and their equivalents.

1-53. (canceled)

54. A method of provide information about products or services to a customer, the method comprising:
(a) providing a web page which provides access to the products or services information, and
(b) allowing the customer to access the web page,
wherein the web page contains at least one title and two or more primary subtitles,
wherein the primary subtitles may be selected to display information related to the subject matter of the selected primary subtitles, and
wherein at least one of the primary subtitles may be selected to display one or more secondary subtitles.

55. The method of claim 54, wherein the products or services information describe products or services related to biotechnology.

56. The method of claim 55, wherein the biotechnology products or services are products or services in a field selected from the group consisting of:
(a) genomics,
(b) proteomics,
(c) RNA interference, and
(d) drug discovery.

57. The method of claim 54, wherein selection of a subtitle results in the customer being presented with information for designing and/or purchasing of products or services.

58. The method of claim 57, wherein the products or services are in the field of RNA interference.

59. The method of claim 58, wherein at least one of the products is a double-stranded nucleic acid molecule.

60. The method of claim 58, wherein the double-stranded nucleic acid molecule is RNA.

61. The method of claim 60, wherein the double-stranded RNA molecule is from about 20 to about 30 nucleotides in length.

62. The method of claim 60, wherein the services relate to the screening of double-stranded RNA molecules to identify molecules which knock down gene expression by RNA inference.


SEQUENCE LISTING (12 sequences)

SEQ ID NO: 1 - DNA, 15 bp, Artificial sequence
  Synthetic construct
gcttttttatactaa

SEQ ID NO: 2 - DNA, 21 bp, Artificial sequence
  Synthetic construct
caacttttttatacaaagttg

SEQ ID NO: 3 - DNA, 25 bp, Artificial sequence
  Synthetic construct
agcctgcttttttgtacaaacttgt

SEQ ID NO: 4 - DNA, 233 bp, Artificial sequence
  Synthetic construct
tacaggtcactaataccatctaagtagttgattcatagtgactggatatgttgtgttttacagtattatgtagtctgttttttatgcaaaatctaatttaatatattgatatttatatcattttacgtttctcgttcagcttttttgtacaaagttggcattataaaaaagcattgctcatcaatttgttgcaacgaacaggtcactatcagtcaaaataaaatcattatttg

SEQ ID NO: 5 - DNA, 100 bp, Artificial sequence
  Synthetic construct
caaataatgattttattttgactgatagtgacctgttcgttgcaacaaattgataagcaatgcttttttataatgccaactttgtacaaaaaagcaggct

SEQ ID NO: 6 - DNA, 125 bp, Artificial sequence
  Synthetic construct
acaagtttgtacaaaaaagctgaacgagaaacgtaaaatgatataaatatcaatatattaaattagattttgcataaaaaacagactacataatactgtaaaacacaacatatccagtcactatg

SEQ ID NO: 7 - protein, 4 aa, Artificial sequence
  Synthetic construct
IEGR

SEQ ID NO: 8 - protein, 4 aa, Artificial sequence
  Synthetic construct
LVPR

SEQ ID NO: 9 - DNA, 14 bp, Artificial sequence
  Synthetic construct
atgtgtactcctta

SEQ ID NO: 10 - DNA, 29 bp, Artificial sequence
  Primer
ggggacaagtttgtacaaaaaagcaggct

SEQ ID NO: 11 - DNA, 29 bp, Artificial sequence
  Synthetic construct
ggggaccactttgtacaagaaagctgggt

SEQ ID NO: 12 - DNA, 27 bp, Artificial sequence
  Synthetic construct
actgactaatataatatacatcatcta